(19) United States
(12) Patent Application Publication
(10) Pub. No.: US 2026/0228587 A1
(43) Pub. Date: Aug. 6, 2026

(54) RECONFIGURABLE ARCHITECTURE FOR PARALLEL QUANTUM OPERATIONS IN NEUTRAL ATOM ARRAYS

(71) Applicants: PRESIDENT AND FELLOWS OF HARVARD COLLEGE, Cambridge, MA (US); MASSACHUSETTS INSTITUTE OF TECHNOLOGY, Cambridge, MA (US); QuEra Computing Incorporated, Boston, MA (US)

(72) Inventors: Dolev Bluvstein, Cambridge, MA (US); Giulia Semeghini, Cambridge, MA (US); Sepehr Ebadi, Cambridge, MA (US); Tout Wang, Cambridge, MA (US); Mikhail D. Lukin, Cambridge, MA (US); Markus Greiner, Cambridge, MA (US); Vladan Vuletc, Cambridge, MA (US); Simon J. Evered, Cambridge, MA (US); Tom Manovitz, Cambridge, MA (US); Hengyun Zhou, Cambridge, MA (US); Madelyn Cain, Cambridge, MA (US); Nishad Maskara, Cambridge, MA (US); Iris Cong, Cambridge, MA (US); Marcin Kalinowski, Cambridge, MA (US); Pedro Sales Rodriguez, Boston, MA (US); Thomas Karolyshyn, Boston, MA (US)

(73) Assignees: PRESIDENT AND FELLOWS OF HARVARD COLLEGE, Cambridge, MA (US); MASSACHUSETTS INSTITUTE OF TECHNOLOGY, Cambridge, MA (US); QuEra Computing Incorporated, Boston, MA (US)

(21) Appl. No.: 19/152,888

(22) PCT Filed: Jan. 31, 2024
(86) PCT No.: PCT/US2024/013829

§ 371 Date: Jul. 31, 2025

Related U.S. Application Data
(60) Provisional application No. 63/482,702, filed on Feb. 1, 2023.
(60) Provisional application No. 63/604,545, filed on Nov. 30, 2023.

(51) Int. Cl. G06N 10/40; G06N 10/20; G06N 10/70

(52) U.S. Cl. CPC G06N 10/40; G06N 10/20; G06N 10/70

(57) ABSTRACT

Quantum processors are provided. A first plurality of neutral atoms is provided in an active zone, each in a respective optical trap of a first array. A first logical qubit is encoded into the first plurality of neutral atoms by first and second lasers. The first plurality of neutral atoms is illuminated while in the active zone by at least the first or second laser, thereby applying a gate to the first logical qubit. The first plurality of neutral atoms is adiabatically moved from the active zone to a readout zone, each to a respective optical trap of a second array. The first plurality of neutral atoms is illuminated while in the readout zone by a third laser. An image of the first plurality of neutral atoms is captures while in the readout zone, thereby determining the state of the first logical qubit.

### CROSS-REFERENCE TO RELATED APPLICATIONS

This application claims the benefit of U.S. Provisional Application Nos. 63/482,702, filed Feb. 1, 2023, and 63/604,545, filed Nov. 30, 2023, each of which is hereby incorporated by reference in its entirety.

### STATEMENT REGARDING FEDERALLY SPONSORED RESEARCH OR DEVELOPMENT

This invention was made with government support under 1745303, 1734011, 2012023 awarded by National Science Foundation, and under W911NF2010021 and W911NF2010082 awarded by U.S. Army Research Office, and under N00014-15-1-2846 and N00014-15-1-2761 awarded by U.S. Office of Naval Research, and under DE-SC0021013 awarded by U.S. Department of Energy. The government has certain rights in the invention.

### BACKGROUND

Embodiments of the present disclosure relate to quantum computation, and more specifically, to dynamically reconfigurable architectures for parallel quantum operations in neutral atom arrays.

### BRIEF SUMMARY

According to embodiments of the present disclosure, a quantum processor is provided, comprising: a first array of optical traps disposed in an active zone; a second array of optical traps disposed in a readout zone; a first laser configured to illuminate the active zone and to drive a transition to a Rydberg state; a second laser configured to illuminate the active zone and to drive a transition between hyperfine states; a third laser configured to illuminate the readout zone; a fourth laser configured to adiabatically move neutral atoms between the optical traps of the active zone and the readout zone; and a camera configured to capture an image of the readout zone. The quantum processor is configured to: provide a first plurality of neutral atoms in the active zone, each in a respective optical trap of the first array; encode a first logical qubit into the first plurality of neutral atoms by the first and second lasers; illuminate the first plurality of neutral atoms while in the active zone by at least the first or second laser, thereby applying a gate to the first logical qubit; adiabatically move the first plurality of neutral atoms from the active zone to the readout zone, each to a respective optical trap of the second array; illuminate the first plurality of neutral atoms while in the readout zone by the third laser; and capture an image of the first plurality of neutral atoms while in the readout zone, thereby determining the state of the first logical qubit.

In some embodiments, the quantum processor further comprises: a third array of optical traps disposed in a storage zone, wherein the fourth laser is further configured to adiabatically move neutral atoms between the optical traps of the active zone and the storage zone. The quantum processor is further configured to: adiabatically move the first plurality of neutral atoms from the active zone to the storage zone by the fourth laser after said encoding, each to a respective optical trap of the third array; and adiabatically move the first plurality of neutral atoms from the storage zone to the active zone by the fourth laser prior to applying the gate, each to a respective optical trap of the first array.

In some embodiments, the quantum processor is further configured to: provide a second plurality of neutral atoms in the active zone; encode a second logical qubit into the second plurality of neutral atoms by the first and second lasers; and prior to applying the gate, place the first and second pluralities of neutral atoms in the active zone such that each neutral atom of the first plurality of neutral atoms is within a blockade radius of exactly one corresponding neutral atom of the second plurality of neutral atoms. The illumination of the first plurality of neutral atoms while in the active zone additionally illuminates the second plurality of neutral atoms, thereby applying the gate to the first and second logical qubits.

According to embodiments of the present disclosure, a method of performing a quantum computation is provided. A first array of optical traps is disposed in an active zone of the quantum processor. A second array of optical traps is disposed in a readout zone of the quantum processor. A first plurality of neutral atoms is provided in the active zone, each in a respective optical trap of the first array. A first logical qubit is encoded into the first plurality of neutral atoms by first and second lasers, the first laser configured to illuminate the active zone and to drive a transition to a Rydberg state, and the second laser configured to illuminate the active zone and to drive a transition between hyperfine states. The first plurality of neutral atoms is illuminated while in the active zone by at least the first or second laser, thereby applying a gate to the first logical qubit. The first plurality of neutral atoms is adiabatically moved from the active zone to the readout zone, each to a respective optical trap of the second array. The first plurality of neutral atoms is illuminated while in the readout zone by the third laser. An image is captured of the first plurality of neutral atoms while in the readout zone, thereby determining the state of the first logical qubit.

In some embodiments, the first plurality of neutral atoms is adiabatically moved from the active zone to a storage zone of the quantum processor by the fourth laser after said encoding, each to a respective optical trap of the third array. The first plurality of neutral atoms is adiabatically moved from the storage zone to the active zone by the fourth laser prior to applying the gate, each to a respective optical trap of the first array.

In some embodiments, a second plurality of neutral atoms is provided in the active zone. A second logical qubit is encoded into the second plurality of neutral atoms by the first and second lasers. Prior to applying the gate, the first and second pluralities of neutral atoms are placed in the active zone such that each neutral atom of the first plurality of neutral atoms is within a blockade radius of exactly one corresponding neutral atom of the second plurality of neutral atoms. The illumination of the first plurality of neutral atoms while in the active zone additionally illuminates the second plurality of neutral atoms, thereby applying the gate to the first and second logical qubits.

In various embodiments, the gate is a transversal CNOT gate. In various embodiments, applying the gate comprises applying a single pulse of the first laser.

In various embodiments, adiabatically moving the first plurality of neutral atoms from the active zone to the storage zone, from the storage zone to the active zone, and from the active zone to the readout zone, each comprises applying a Raman pulse during said moving. In various embodiments, the Raman pulse is applied at a midpoint of said moving. In various embodiments, adiabatically moving the first plurality of neutral atoms from the active zone to the storage zone, from the storage zone to the active zone, and from the active zone to the readout zone, each have a constant jerk.

In various embodiments, the first, second, and/or third arrays of optical traps are two-dimensional arrays.

In various embodiments, a beam of light is directed from the fourth laser to at least one acousto-optic deflector (AOD), and adiabatically moving neutral atoms comprises varying a drive frequency of the at least one AOD.

In various embodiments, the first, second, and/or third arrays of optical traps is generated by directing a beam of light to a spatial light modulator (SLM).

In various embodiments, the first plurality of neutral atoms are moved simultaneously.

In various embodiments, the third array has a higher density than the first array.

In various embodiments, encoding the first logical qubit comprises applying a CSS code. In various embodiments, the CSS code is selected from: a surface code, a color code, a Steane code, and a hypergraph product LDPC code.

### BRIEF DESCRIPTION OF THE SEVERAL VIEWS OF THE DRAWINGS

FIG. 1 is a schematic view of a quantum information architecture according to embodiments of the present disclosure.

FIG. 2 is a level diagram showing key ⁸⁷Rb atomic levels according to embodiments of the present disclosure.

FIG. 3 is a schematic view of the implementation of the toric code according to embodiments of the present disclosure.

FIG. 4 is a schematic view of a quantum processing unit (QPU) according to embodiments of the present disclosure.

FIG. 5 is a schematic view of logical qubits, illustrating efficient control according to embodiments of the present disclosure.

FIG. 6 is a schematic view of logical qubits, illustrating the application of a transversal CNOT gate according to embodiments of the present disclosure.

FIG. 7 is a schematic view of a portion of a processor core according to embodiments of the present disclosure.

FIG. 8 is a schematic view of a portion of a processor core suitable for use in implementing a repetition code according to embodiments of the present disclosure.

FIG. 9 is a schematic view of a portion of a processor core suitable for use in implementing a surface code according to embodiments of the present disclosure.

FIG. 10 is a schematic view of a method of active, feedforward QEC according to embodiments of the present disclosure.

FIG. 11 is a schematic view of an apparatus for quantum computation according to embodiments of the present disclosure.

FIGS. 12A-C illustrate a programmable logical processor based on reconfigurable atom arrays according to embodiments of the present disclosure.

FIGS. 13A-E illustrate transversal entangling gates between two surface codes according to embodiments of the present disclosure.

FIGS. 14A-E illustrate fault-tolerant logical algorithms according to embodiments of the present disclosure.

FIGS. 15A-E illustrate scaling and mid-circuit feedforward in a zoned logical processor according to embodiments of the present disclosure.

FIGS. 16A-F illustrate complex logical circuits using 3D codes according to embodiments of the present disclosure.

FIGS. 17A-D illustrate logical two-copy measurement according to embodiments of the present disclosure.

FIGS. 18A-D illustrate a neutral atom quantum computer architecture according to embodiments of the present disclosure.

FIGS. 19A-D illustrate single-qubit Raman addressing according to embodiments of the present disclosure.

FIGS. 20A-H illustrate midcircuit readout and feedforward according to embodiments of the present disclosure.

FIGS. 21A-F illustrate additional surface code data according to embodiments of the present disclosure.

FIGS. 22A-C illustrate surface code preparation and decoding data according to embodiments of the present disclosure.

FIGS. 23A-C illustrate [[8,3,2]] and hypercube encoding according to embodiments of the present disclosure.

FIGS. 24A-C illustrate additional [[8,3,2]] circuit sampling data according to embodiments of the present disclosure.

FIGS. 25A-C illustrate theoretical exploration of hypercube IQP circuits according to embodiments of the present disclosure.

FIGS. 26A-F illustrate additional Bell basis measurement results according to embodiments of the present disclosure.

### DETAILED DESCRIPTION

Large-scale quantum computers have the potential to solve problems that are intractable for classical processors. While exciting progress has been made on developing small- and medium-scale quantum processors and applying them to study physical phenomena in complex quantum systems in a regime that is difficult to simulate classically, it is unclear if and how truly large scale quantum processors can be constructed and applied to solving general purpose, computationally hard problems, whose value exceeds the cost of construction. For example, current estimates for the resources required to realize one of the most prominent high value applications, Shor's factoring algorithm, require around five thousand logical qubits, and a few billion non-Clifford gates with error probability below 10⁻¹² to break 2048-bit RSA encryption. Alternatively, using conventional error correction methods, 20 million superconducting qubits with realistic gate error rates (0.1%) could be used, which exceeds the scale of currently available, well-controlled systems by nearly six orders of magnitude.

This necessitates the development of novel, unconventional approaches to utility-scale quantum computation, likely involving a synergistic combination of new hardware architectures that significantly reduce the costs of error correction and computation, new resource-efficient approaches to algorithm development co-designed with the hardware, as well as large scale engineering efforts to construct practical systems. Furthermore, any such large-scale development will also require extensive effort to verify and validate.

To address these and other shortcomings of alternative approaches, the present disclosure provides systems and methods for controlling millions of physical qubits using efficient, parallel fault-tolerant quantum operations. These systems are applicable for resource-efficient implementation of practical algorithms geared towards utility-scale quantum computing.

A quantum bit (qubit) is the fundamental building block for a quantum computer. By analogy to classical bits which are used to store information in traditional computers (each bit is 0 or 1), qubits can occupy two distinct states labeled |0 [symbol] and |1 [symbol] , or any quantum superposition of the two states. In various applications, multiple qubits are entangled in order to build multi-qubit quantum gates.

Bits and qubits are each encoded in the state of real physical systems. For example, a classical bit (0 or 1) may be encoded in whether a capacitor is charged or discharged, or whether a switch is ‘on’ or ‘off’.

The term qudit (quantum digit) denotes the unit of quantum information that can be realized in suitable d-level quantum systems. A collection of qubits that can be measured to N states can implement an N-level qudit.

Quantum bits are encoded in quantum systems with two (or more) distinct quantum states. There are many physical realizations that may be employed. One example is based on individual particles such as atoms, ions, or molecules which are isolated in vacuum. These isolated atoms, ions, and molecules have many distinct quantum states that correspond to different orientations of electron spins, nuclear spins, electron orbits, and molecular rotations/vibrations.

In principle, a qubit may be encoded in any pair of quantum states of the atom/ion/molecule. In practice, a key parameter of qubits is described by their quantum coherence properties. Coherence measures the lifetime of the qubit before its information is lost. It has a close analogy with classical bits: if you prepare a classical bit in the 0 state, then after some time it may randomly be flipped to 1 due to environmental noise. Quantum mechanically, the same error may occur: |0 [symbol] may randomly flip to |1 [symbol] after some characteristic timescale. However, qubits may suffer from additional errors: for example, a superposition state (|0 [symbol] +|1 [symbol] )/√2 may randomly flip to (|0 [symbol] -|1 [symbol] )/√2. In real quantum computers, the qubits must be encoded in quantum states which have long coherence properties.

Quantum computers generally can contain many qubits, each encoded in its own atom/molecule/ion/etc. Beyond simply containing the qubits, the quantum computer should be able to (1) initialize the qubits, (2) manipulate the state of the qubits in a controlled way, and (3) read out the final states of the qubits. When it comes to manipulation of the qubits, this is usually broken down into two types: one type of qubit manipulation is a so-called single-qubit gate, which means an operation that is applied individually to a qubit. This may, for example, flip the state of the qubit from |0 [symbol] to |1 [symbol] , or it may take |0 [symbol] to a superposition state (|0 [symbol] +|1 [symbol] )/√2. The second necessary type of qubit manipulation is a multi-qubit gate, which acts collectively on two or more qubits, including those that are entangled. A multi-qubit gate is realized through some form of interaction between the qubits. The various quantum computing platforms (having various physical encodings of qubits) rely on different physical mechanisms both for single-qubit gates as well as multi-qubit gates according to the physical system that is storing the qubit.

In various embodiments of a quantum computer, a qubit is encoded in two near-ground-state energy levels of an atom, ion, or molecule. An example of this is a hyperfine qubit. Such a qubit is encoded in two electronic ground states that differ by the relative orientation of the nuclear spin with respect to the outer electron spin. Pairs of such states can be chosen so that they are particularly robust/insensitive to environmental perturbations, leading to long coherence times. These states are split in energy by the hyperfine interaction energy of the atom/ion/molecule, which is the interaction energy between the nuclear spin and the electron spin. The robustness of the qubit can be understood as the energy splitting between the two states being particularly stable. For this reason, such states are called clock states because the stable energy splitting can form an excellent frequency-reference and as such forms the basis for atomic clocks. Typical hyperfine splitting between these qubit states is in the 1-13 GHz frequency range.

To perform single-qubit gates on such a hyperfine qubit, it is possible to apply coherent microwave radiation at the exact frequency of the energy splitting between states. However, there are two drawbacks to this approach. First, microwaves cannot be applied to just one qubit without affecting adjacent qubits. This is because qubits are encoded in particles that are typically just a few microns apart from one another, and microwaves cannot be focused to such a small scale due to their large wavelength. Second, the microwave intensity is fairly limited and as such the maximum speed of single-qubit gates is correspondingly limited.

An alternative approach is based on stimulated Raman transitions. In this case, a laser field is applied to the atoms/ions/molecules. The laser field is nearly (but not exactly) resonant with an optical transition from one of the ground states to an optically excited state. The laser contains multiple frequency components separated in frequency by exactly the amount equal to the hyperfine splitting of the qubit. The atom/ion/molecule can absorb a photon from one frequency component and coherently emit into a different frequency component, and in doing so it changes its state. This approach benefits from the capability of focusing the laser field onto individual particles or subsets of particles in the quantum computer. The laser field can also be applied with high intensity, allowing much faster gate operations.

Neutral atom quantum computers encode qubits in individual neutral atoms. The neutral atoms are trapped in a vacuum chamber and levitated by trapping lasers. Most commonly, the trapping lasers are individual optical tweezers, which are individual tightly focused laser beams that trap an individual atom at the focus. Alternatively, individual atoms may be trapped in an optical lattice, which is formed from standing waves of laser light which produce a periodic structure of nodes/antinodes.

A typical approach for encoding a qubit in neutral atoms is the hyperfine qubit approach, in which two ground states split by several GHz form the qubit. Multi-qubit gates in neutral atom quantum computers are realized using a third atomic state, which is a highly-excited Rydberg state. When one atom is excited to a Rydberg state, neighboring atoms are prevented from being excited to the Rydberg state. This conditional behavior forms the basis for multi-qubit gates, such as a controlled-NOT gate. The Rydberg state is used temporarily to mediate the multi-qubit gate, and then the atoms are returned back from the Rydberg state to the ground state levels to preserve their coherence.

Trapped ion quantum computers use atomic species that are ionized, meaning they have a net charge. In most cases, many ions are trapped in one large trapping potential formed by electrodes in a vacuum chamber. The ions are pulled to the minimum of the trapping potential, but inter-ion Coulomb repulsion causes them to form a crystal structure centered in the middle of the trapping potential. Most commonly, the ions arrange into a linear chain. Other ways to trap ions are also possible, such as using optical tweezers, or trapping ions individually with local electric fields with a more complex on-chip electrode structure.

Qubits are encoded in trapped ions in multiple ways. One common approach is to use ground-state hyperfine levels, as described for neutral atoms. In trapped ions with hyperfine-qubit encoding, as with neutral atoms, single-qubit gates may use microwave radiation or stimulated Raman transitions.

Unlike in neutral atoms, trapped ion hyperfine qubits rely heavily on stimulated Raman transitions for performing multi-qubit gates. Stimulated Raman transitions may be used to control both the hyperfine state of the ion but also to change the motional state of the ion (i.e., add momentum). This can be understood as absorbing a photon moving in one direction and emitting a photon in a different direction, such that the difference in photon momentum is absorbed by the ion. Since many ions are often trapped in one collective trapping potential and are mutually repelling one another, changing the motional state of one ion affects other ions in the system, and this mechanism forms the basis for multi-qubit gates.

According to various embodiments of a quantum computer, individual particles (atoms/ions/molecules) can first be trapped in an array and arranged into particular configurations. Next, one or more particles are prepared in a desired quantum state. Quantum circuits can then be implemented by a sequence of qubit operations acting on individual qubits (single-qubit gates) or on groups of two or more qubits (multi-qubit gates). Finally, the state of the particles can be read out in order to observe the result of the quantum circuit. The readout can be accomplished using an observation system that typically includes an electron-multiplied CCD (EMCCD) camera image to detect particles' loaded positions, and a second camera image to read out the particles' final states by, for example, detecting fluorescence emitted by the particles in their final states.

Quantum information platforms rely on interactions between qubits, either for performing quantum gates or for performing analog many-body simulations. Qubits often interact in a local way, however, which limits the connectivity of the circuit or the analog simulation and constrains the possible computations. While some platforms can communicate in a nonlocal way through the use of a shared bus (e.g., trapped ions), these shared-bus approaches are limited to small systems and thus still require a way to dynamically move qubits around in order to truly scale up the platform.

Neutral atom arrays can be dynamically reconfigured while preserving quantum coherence and entanglement between qubits, by storing quantum information in hyperfine states and shuttling atoms in optical tweezers. This approach offers a scalable way to realize a quantum information system with large numbers of qubits and arbitrary programmability—where any qubit can perform an entangling gate with any other qubit in the array. Using high-fidelity two-qubit Rydberg gates, various quantum information circuits are described herein that leverage the programmability and nonlocal connectivity achievable with these approaches. An example of high fidelity Rydberg gates is described in Levine, et al., Parallel Implementation of High-Fidelity Multiqubit Gates with Neutral Atoms, Phys. Rev. Lett., vol. 123, issue 17, https://link.aps.org/doi/10.1103/PhysRevLett.123.170503, which is hereby incorporated by reference.

As set out in more detail below, the methods provided herein enable a variety of computational scenarios. In some scenarios, a plurality of neutral atom are moved in parallel between multiple regions in space. For example, a source of illumination may be directed to a first region, and atoms are moved in and out of that region between the application of pulses by the source of illumination. Similarly, a camera may be directed to an imaging region, and atoms are moved in and out of that imaging region for imaging. Similarly, atoms may be moved in and out of the blockade radius of other atoms, thereby allowing the application of gates to the different groups of atoms at different stages of an algorithm or layers of a quantum circuit.

It will be appreciated that various stabilizer codes entail the readout of ancilla qubits, and the present disclosure allows the physical relocation of ancilla qubits to an imaging region separate from the data qubits. In this way, readout of ancilla qubits may be provided without destruction of the data qubits.

More generally, an array of atoms may be moved between multiple arrangements to facilitate both digital gates between different selections of atoms and analog evolution of the array as a whole. As used herein, an arrangement of an array of atoms or a plurality of atoms refers to the positioning of those atoms relative to each other. It will be appreciated that certain arrangements provide connectivity between qubits that enable particular gates or analog evolution according to a particular Hamiltonian. One advantage of the methods provided herein is that atoms may be moved into proximity of atoms that were not adjacent within an array. A non-adjacent atom is one that is not within a unit cell in a regular lattice or that is not a nearest neighbor in an irregular array. For example, in a rectangular lattice, each atom has eight atoms that are within a unit cell thereof, and thus has eight adjacent atoms (disregarding edges).

As defined further below, atoms are moved adiabatically in order to preserve entanglement. As used herein, the term adiabatic movement refers to movement that avoids a transition of the subject atom within its trap. For example, where the first time-derivative of the acceleration of the subject atom is not greater than a predetermined value, the movement is considered adiabatic. Typically, adiabatic movement occurs when jerk<(size of atom)×(trap frequency)³. In physics, jerk or jolt is the term given to the rate at which an object's acceleration changes with respect to time.

In addition to adiabatic movement, in some embodiments dynamical decoupling is applied during the movement. As set out further below, a π-pulse during movement cancels out dephasing induced by the trap differential light shift. A π-pulse is a pulse that rotates the state of the qubit by π radians on the Bloch sphere. The trap differential light shift changes when the atom is moving (depending on its acceleration) because it will move in the trap, and so sample a different portion of the light intensity and hence have a different differential light shift.

Generally speaking, the more pulses applied, the more decoupling from fluctuations. For example, fluctuations may come from laser intensity fluctuations at different displacement positions of the atom, or different magnetic fields in space.

In embodiments where acceleration and deceleration are symmetric, both change the differential light shift in the same way. Accordingly, in such embodiments it is advantageous to apply a π-pulse at the midpoint of the motion. In this way, the changes in differential light shift induced by acceleration and deceleration cancel each other out.

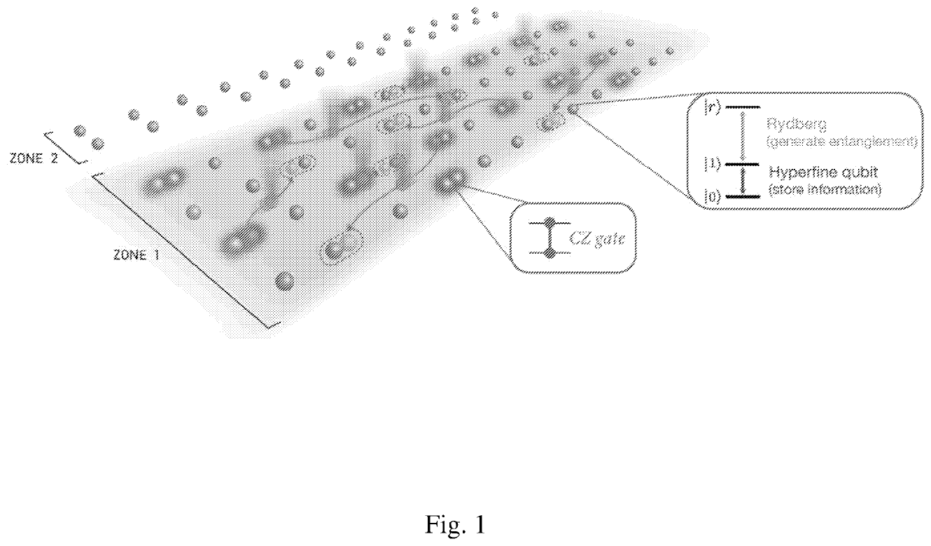

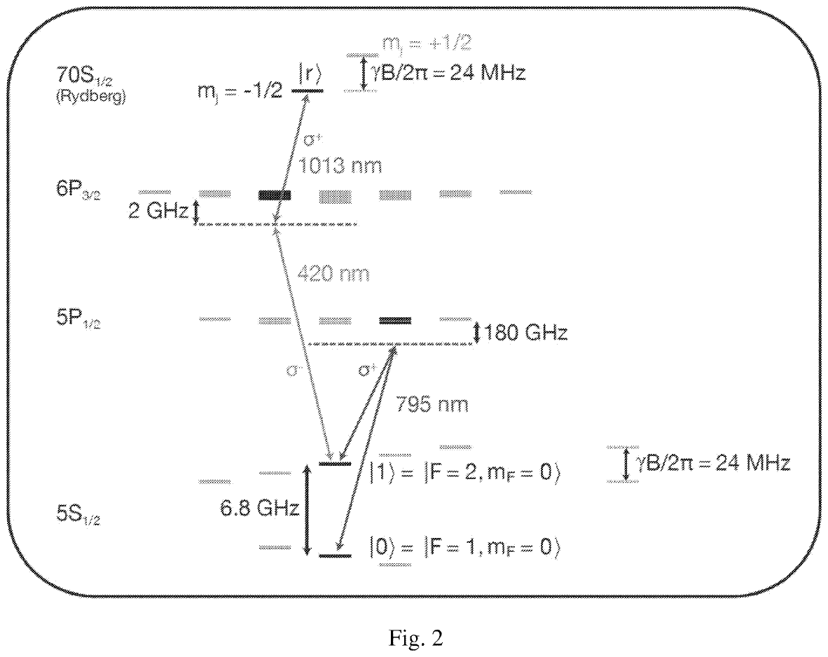

Referring to FIG. 1, a quantum information architecture enabled by coherent transport of neutral atoms is illustrated. Qubits are transported to perform entangling gates with distant qubits, enabling programmable and nonlocal connectivity. Atom shuttling is performed using optical tweezers, with high parallelism in two dimensions and between multiple zones allowing selective manipulations. The inset shows the atomic levels used: the |0 [symbol] , |1 [symbol] qubit states refer to the m_{F}=0 clock states of ⁸⁷Rb, and |r [symbol] is a Rydberg state used for generating entanglement between qubits, which are further described with regard to FIG. 2.

FIG. 2 is a level diagram showing key ⁸⁷Rb atomic levels used. The Rydberg excitation scheme from |1 [symbol] to |r [symbol] is composed of a two-photon transition driven by a 420-nm laser and a 1013-nm laser. A DC magnetic field of B=8.5G is applied throughout this work.

As noted above, quantum information systems derive their power from controllable interactions that generate quantum entanglement. However, the natural, local character of interactions limits the connectivity of quantum circuits and simulations. Nonlocal connectivity can be engineered via a global shared quantum data bus, but these approaches are limited in either control or size.

According to various embodiments of the present disclosure, this long-standing challenge is addressed through dynamically reconfigurable arrays of entangled neutral atoms, shuttled by optical tweezers in two spatial dimensions. Hyperfine states are used for storing and transporting quantum information in between quantum operations, and excitation into Rydberg states is used for generating entanglement. Highly parallel operations are enabled via selective qubit operations in distinct zones that qubits are dynamically shuttled between. Taken together, these ingredients enable a powerful quantum information architecture, which is employed to realize applications including entangled state generation, creation of topological surface and toric code states, and hybrid analog-digital quantum simulations.

Within this architecture, programming a specific quantum circuit entails control over only a few optical degrees of freedom. Arbitrary tweezer positions in space are controlled by a computer-generated hologram, hundreds of atoms are dynamically reconfigured in parallel by two waveforms in a 2D acousto-optic deflector (AOD), and qubit operations are realized by pulsing optical beams. This flexible optical control enables sophisticated quantum circuits with only a few classical controls. This architecture enables an inherently scalable approach: larger codes require no increase in the number of classical controls.

Various quantum circuits are realizable with this approach, including quantum error correction (QEC) codes such as the surface and Steane codes, with fidelities in this disclosure already comparable to state-of-the-art experiments in other platforms. Moreover, the parallelized, nonlocal connectivity is used to create the toric code state on a torus.

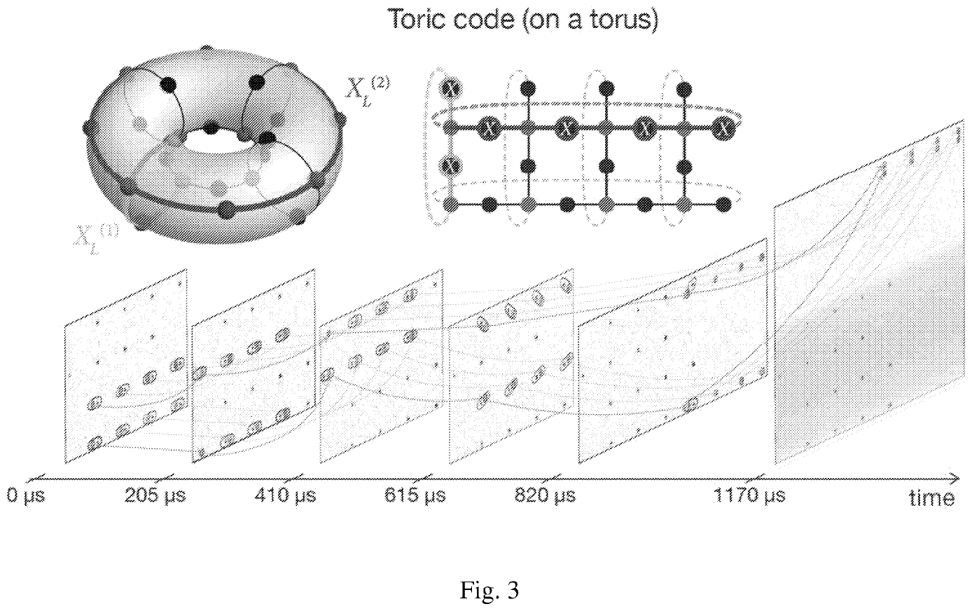

FIG. 3 illustrates implementation of the toric code state encoding two protected qubits obtained using mobile ancilla qubit arrays. The top illustrates a graph state realizing the two logical-qubit product state

$${{\vert + 〉}_{L}^{1} \vert + 〉}_{L}^{2}$$

of the toric code upon projective measurement of the ancilla qubits in the X-basis. The bottom includes images showing the movement steps implemented in creating and measuring the toric code state. Shading in the final image represents a local rotation on the data qubit zone.

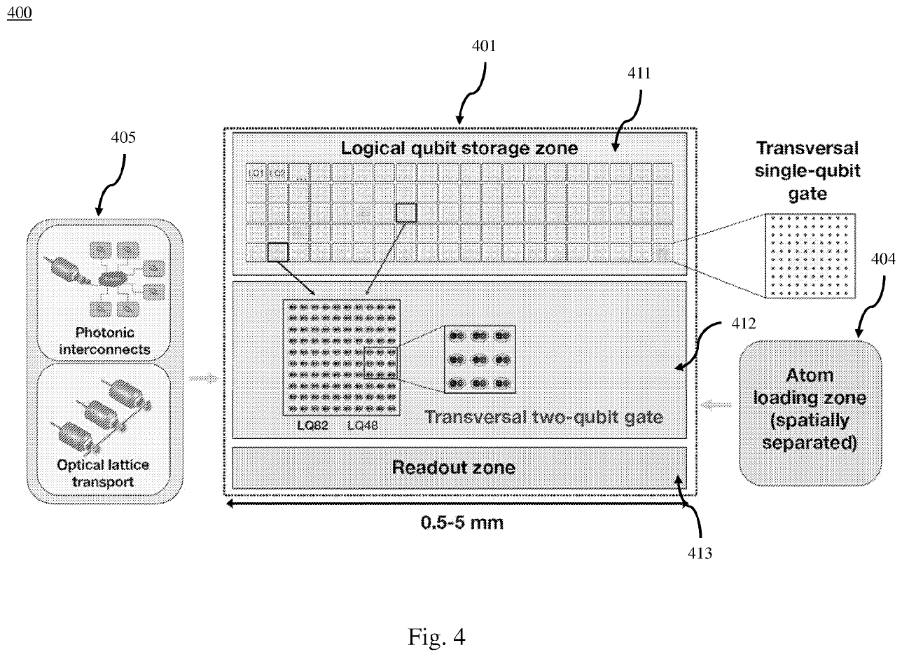

Referring to FIG. 4, a quantum processing unit (QPU) according to the present disclosure is illustrated. This design is centered around efficient classical control over many logical qubits in parallel using optical beams. Single-qubit logical gates can be realized transversally, for example, by illuminating all physical qubits within the same logical qubit block by an optical beam. Two-qubit logical gates can also be realized transversally, by interlacing two logical arrays of qubits and applying a global optical pulse for entangling each twin of the pair.

Neutral atom systems have the potential for utility scale computing: for example, millions of identical neutral atom qubits may be trapped in mm-scale regions of space. The key challenge is the classical control required to assemble these qubits into a large-scale quantum processor. Full programmability of single physical qubits generally requires highly complicated classical control techniques in order to operate on millions of qubits. In contrast, the architectures provided herein allow for full programmability of single logical qubits while only requiring a few classical controls per logical qubit. This enables reaching utility-scale by encoding logical qubits into blocks that can be efficiently controlled in parallel. Using advanced optical microscopy systems (such as those utilized for modern industrial-scale lithography) with high numerical aperture and large field of view exceeding several millimeters, and appropriately scaled trapping laser power, direct trapping and manipulation of over a million qubits is possible. Further scaling is possible by creating 10-100 such processing units, each under its own microscope objective, and then connecting these units together utilizing photonic links and/or optical lattice transport. This allows for sufficient space, resolution, and power density for enacting high-fidelity control over 10M qubits and beyond.

QPU 400 is segmented into several key zones: a storage zone 411, entangling zone 412, readout zone 413, atom loading zone 404, and remote entangling zone 405. Storage zone 411, entangling zone 412, and readout zone 413 form processor core 401, which in some embodiments contains 10⁴ to 10⁶ qubits in a footprint of 0.5-5 mm. Fresh atoms are continuously reloaded from distant atom loading zone 404, and a distant remote entangling zone 405 (using optical interconnects and/or lattice transport) delivers remote Bell pair entanglement resources.

In storage zone 411, idle logical qubits are stored for long times, utilizing the long qubit coherence times and high fidelity single-qubit gates, such that an error-correction cycle is only required before a logical two-qubit gate. For coherence times of 10-100 second, and assuming performance 10× below threshold, then roughly 1% single-qubit dephasing errors can be tolerated before a round of d cycles of error correction. This corresponds to approximately 0.1-1 second of allowed storage time before the requirement for correction. Due to the all-to-all connectivity provided by the presently described architectures, idled logical qubits can simply be kept in the storage zone, safe from additional errors. Logical qubits are thus stored in dense blocks, shuttled out when they are needed in the algorithm, and only error-corrected before a two-qubit gate, greatly reducing the error correction overhead. In various exemplary devices, atoms are stored at densities of approximately 1/(2 μm)² in the dense storage zone, and densities of approximately 1/(10 μm)² in the active zone.

The active logical qubits are manipulated in active zone 412. By utilizing qubit transport, all combinations of two-qubit gates can be performed in a fixed region of space. This significantly reduces the classical control complexity. For example, all two-qubit gates can be performed using a single, global optical beam, which is dramatically simpler than calibrating each individual qubit. This exceptional degree of parallelism for logical qubit control is a significant advantage of the present architecture relative to alternatives such as those involving individual control of atomic qubits.

Readout zone 413 allows selectively reading out a subset of qubits mid-circuit without disturbing the other qubits. This readout happens in parallel with a global beam and a camera, again requiring only one set of classical controls.

Outside of the core processor 401, atoms are constantly reloaded from loading zone 404 and transported into the core processor for running arbitrarily long circuits. Remote Bell pairs with other processing units are generated using optical links and/or optical lattice transport 405, and are shuttled into the core processor 401 for creating remote logical entanglement. This allows interconnection of 10-100 single processing units into one error-corrected, utility-scale quantum computer.

The architecture provided above allows for mid-circuit readout. In particular, this architecture may be paired with fast imaging in the readout zone and a classical control loop. In addition, various methods may be used to suppress crosstalk errors and detect/correct for loss. Arbitrarily long circuit depths may be achieved with continuous reloading of atoms and further crosstalk suppression.

To connect multiple units, many high-fidelity, long-distance Bell pairs may be generated in parallel, using lattice transport and/or photonic links.

It will be appreciated that the present architecture is suitable for logical state preservation by repetitive mid-circuit measurement and correction. In addition, a surface code logical qubit may be implemented, for example by moving ancillas from a storage zone reservoir, entangling with data qubits for syndrome extraction, and moving to the readout zone. This allows fast mid-circuit readout and feedback while preserving coherence on data qubits. In various embodiments, the data qubits are protected by placing the imaging zone ~50 microns away, thereby suppressing crosstalk from the readout beam and scattered light by the ancilla atoms.

In various embodiments, a fast classical control loop uses ancilla measurements to determine errors on the data qubits, and to detect and correct qubit loss. Lost qubits may then be replaced with reservoir atoms. In order to reach surface code distances several times larger than the largest codes created in alternative systems, local detuning patterns may be utilized for space-efficient use of the entangling zone.

The presently described architectures may also be used to perform algorithms with logical qubits. The zoned approach combined with efficient optical control over many logical qubits in parallel allows construction of large-scale processors. In an exemplary use case, ~10 logical qubits are encoded in the active zone and moved to the storage zone. After encoding all logical qubits, the algorithm is run with appropriate logical single-qubit and logical two-qubit gates. The flexible, local single-qubit control required for logical single-qubit gates is implemented with Raman light from a 2D AOD illuminating the grid of a single code block. Logical two-qubit gates are realized transversally in the entangling zone. Mid-circuit readout is used for the non-Clifford gate-teleportation sequence, followed by fast feedback for logical single-qubit rotation.

It will be appreciated that while certain operating parameter are provided below by way of example, increased fidelity in two-qubit gate errors may be achieved through various further optimizations. For example, increasing Rydberg laser power and detuning will reduce laser scattering errors and also suppress other errors by increasing gate speed. Cooling atoms to the motional ground state (thereby suppressing Doppler dephasing errors), and utilizing 10× higher laser power, theoretically results in >99.8% gate fidelities. Further improvements can be made with continued increases in laser power, but alternative routes such as single-photon excitation to Rydberg P states or alkaline-earth-based systems, are also available. Processor speed can be increased to a ~10 microsecond logical qubit cycle time by increasing collection efficiency or utilizing cavity-based or ensemble-based readout schemes, or by increasing movement speed with deeper optical tweezers.

To reach arbitrarily deep circuits, atoms may be continuously reloaded. Accordingly, some embodiments employ loading into a distant magneto-optical trap (MOT) and transporting atoms in an optical lattice conveyor belt.

In various embodiments, cross-talk during readout is suppressed by moving the ancilla atoms away from the data qubits.

Further scaling of the quantum processors can be achieved by connecting more than one microscope objective, either through atom transport or optical communication links. In various embodiments, the first approach utilizes the novel capabilities of atom rearrangement, combined with the use of optical lattice conveyor belts to coherently transport qubits between multiple active optical control regions and distribute entanglement. In various embodiments, the second approach utilizes photon-mediated entanglement between distinct atom array nodes with >10⁴ qubits. High entanglement rates can be achieved through parallel nanophotonic or bulk optical cavities, and the large sizes of atom arrays can provide further parallelism. This approach also enables modular construction of quantum processor units, flexibly rewired and linked together.

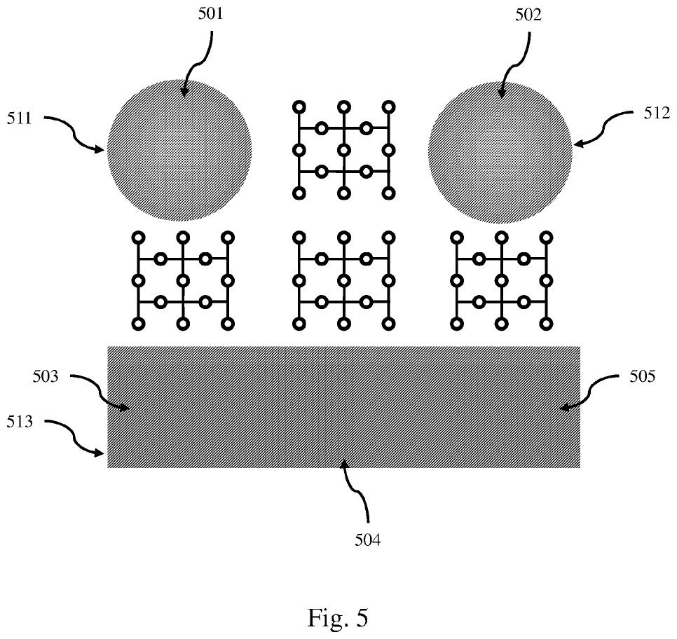

Referring to FIG. 5, a schematic view is provided of logical qubits, illustrating efficient control of single logical qubits by parallelized optical control of the physical qubit blocks that constitute the logical qubits. Logical qubits 501, 502, 503, 504 are each made up of 13 atomic qubits (shown as circles). It will be appreciated that the number and arrangement of qubits is purely exemplary. A variety of qubit blocks are known in the art and are suitable for use as described herein. For example, the 2D surface code and the 2D color code are particularly suitable due to their high thresholds and simplistic 2D structure. However, a variety of other codes are available that include the transversal CNOT, such as the 3D color code and 3D toric code. In various embodiments, a single laser beam is configured to illuminate a given logical qubit when positioned in an active zone of a processor (e.g., active zone 412). This is illustrated by beam 511 illuminating logical qubit 501. In some embodiments, a single laser beam is configured to illuminate a plurality of logical qubits when positioned in an active zone of a processor (e.g., active zone 412). This is illustrated by beam 513 illuminating logical qubits 503, 504, 505.

This structure allows for the application of transversal logical gates. To apply a transversal logical gate on one logical qubit, the corresponding physical qubit gate is performed on each physical qubit in the block making up the logical qubit.

For example, to do a transversal single-qubit gate, the same single-qubit rotation is applied to each physical qubit in the block by illuminating that entire spatial block (e.g., 501) with one beam that covers all physical qubits (e.g., 511). In various embodiments, this is realized by creating a grid of Raman beams using a crossed AOD device in order to illuminate a grid of one surface code. This single-qubit example is shown with beams 511, 512, where surface code blocks 501, 502 (the connected grid of 13 atoms) are illuminated with beams that come out of a microscope objective and into the plane of the atoms. In this example, two logical blocks 511, 512 are illuminated in parallel. This is advantageous in various use cases, but one code block may also be illuminated at a time.

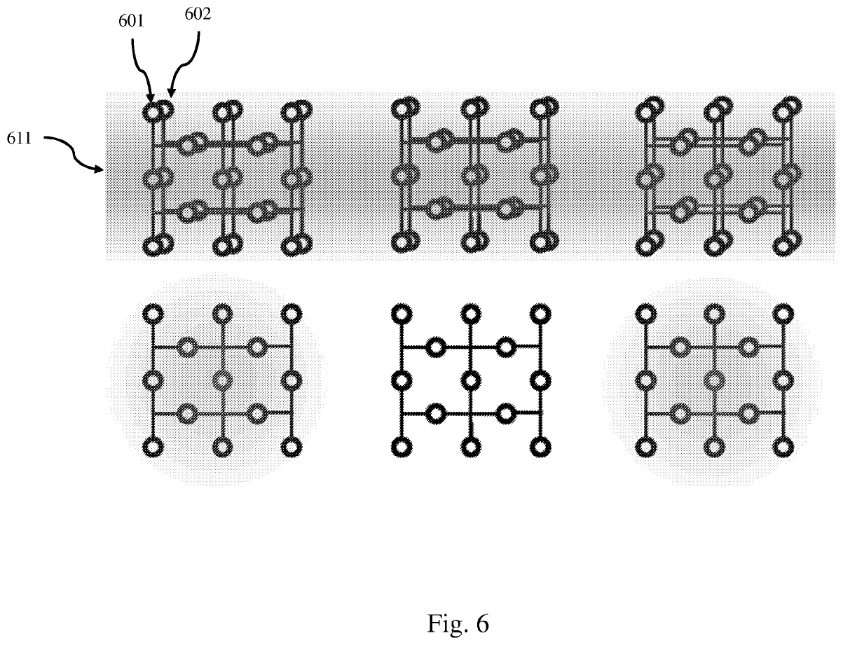

This structure allows for the application of transversal logical multi-qubit gates between two or more logical qubits. A transversal logical multi-qubit gate is a logical gate wherein each atomic (i.e., physical) qubit of one logical qubit is coupled to only one atomic qubit of another logical qubit, and therefore errors do not spread to other atomic qubits by propagation. Referring to FIG. 6, a schematic view is provided of logical qubits, illustrating the application of a transversal controlled-NOT (CNOT) gate. As in FIG. 5, each of a plurality of logical qubits is made up of 13 atomic qubits (shown as circles). To perform a transversal CNOT on two logical qubits (e.g., 601, 602) a physical qubit CNOT is performed on each pair of the two logical blocks. The architectures provided herein enable moving groups of atoms in parallel in order to efficiently perform logical transversal CNOTs between any two logical qubit blocks.

In particular, a logical qubit block is picked up with a crossed AOD, moved to interlace with another logical qubit within the same 2D plane, which is stored in a different set of optical tweezers (e.g., a backbone SLM grid). When interlaced, each atomic qubit of one logical qubit is within a blockade radius of exactly one corresponding atomic qubit of the other logical qubit. A single pulse of a global Rydberg laser is applied (e.g., beam 611). This realizes a transversal CNOT between the two logical qubits in a single, parallel step. Transversal CNOTs may be performed in parallel on multiple logical qubits at the same time, as is shown in FIG. 6.

Transversal CNOTs are allowed, fault tolerant operations, between any two Calderbank-Shor-Steane (CSS) codes, which is a broad class of codes encompassing surface codes, color codes (e.g., Steane code), hypergraph product low density parity check (LDPC) codes, etc. The key intuition is that a CNOT propagates X on a first qubit to X on a second qubit, and Z on the first qubit to Z on the second qubit. For a CSS code, the logical qubit operators are products of X and Z, and the logical CNOT is formed of products of physical qubit CNOTs. Accordingly, logical X on the first logical qubit will propagate to being logical X on the second logical qubit, and logical Z on the first logical qubit will propagate to logical Z on the second logical qubit. This follows the rules of a CNOT on the logical qubit level. Accordingly, this implements a transversal logical CNOT.

More particularly, a controlled-NOT can be performed bitwise on any CSS code. Consider the operations on M⊗I and I⊗M. In the first case, if M is an X generator, it becomes MOM. Since both the first and second blocks have the same stabilizer, this is an element of S×S. If M is a Z generator, M⊗I becomes M⊗I again. Similarly, if M is an X generator, I⊗M becomes I⊗M, and if M is a Z generator, I⊗M becomes M⊗M, which is again in S×S. For an arbitrary CSS code, the X̅ᵢ operators are formed from the product of all Xs, and the Z̅ᵢ operators are formed from the product of all Zs. Therefore:

$$\overline{{X}_{i}} ⊗ I \to \overline{{X}_{i}} ⊗ \overline{{X}_{i}} \qquad Equation 1$$

$$\overline{{Z}_{i}} ⊗ I \to \overline{{Z}_{i}} ⊗ I$$

$$I ⊗ \overline{{X}_{i}} \to I ⊗ \overline{{X}_{i}}$$

$$I ⊗ \overline{{Z}_{i}} \to \overline{{Z}_{i}} ⊗ \overline{{Z}_{i}} .$$

Thus, the bitwise CNOT produces an encoded CNOT for every encoded qubit in the block.

Without a transversal CNOT, entangling operations between logical qubits often have to be done with braiding or lattice surgery. These are significantly less efficient than the transversal CNOT. For example, both braiding and lattice surgery require doing d rounds of stabilizer measurement in order for them to be actually fault-tolerant, whereas no rounds of stabilizer measurement are required to make the transversal CNOT fault-tolerant—its fault-tolerance is already guaranteed by the fact that that the CNOT is transversal. Transversal gates are inherently fault-tolerant, because, as described above, no error can spread from one qubit in the block to another qubit in the same block. Braiding and lattice surgery thus are much more resource intensive in requiring multiple rounds of stabilizer measurement, being slower and also being lower in their threshold.

The threshold of a 2Q gate when doing a transversal CNOT is given by the threshold for perfect syndrome extraction and such should be roughly 10% (surface code), whereas the 2Q gate threshold for doing repeated syndrome extraction is roughly 1% (surface code). The ability to perform this transversal CNOT efficiently by only using a few classical controls, in a way that is independent of code size, is key to simplifying the classical controls required for building a large-scale quantum computer.

The atom movement and parallel optical control of logical qubit blocks greatly simplifies the controls required for realizing logical quantum computation. In various embodiments, logical qubits are multiplexed into grids, and each logical qubit block behaves much like one large atom. To perform a single-qubit rotation on a logical qubit block, it is illuminated with one beam. To perform a CNOT between two logical qubit blocks, they are moved together and pulsed with one Rydberg beam. With this highly efficient parallelized control, logical qubit algorithms can be performed on logical qubits.

In exemplary embodiments, a two-qubit CZ gate is implemented by two global Rydberg pulses, with each pulse at detuning Δ and length τ, and with a phase jump ξ between the two pulses. The pulse parameters are chosen such that qubit pairs, adjacent and under the Rydberg blockade constraint, will return from the Rydberg state back to the hyperfine qubit manifold with a phase depending on the state of the other qubit.

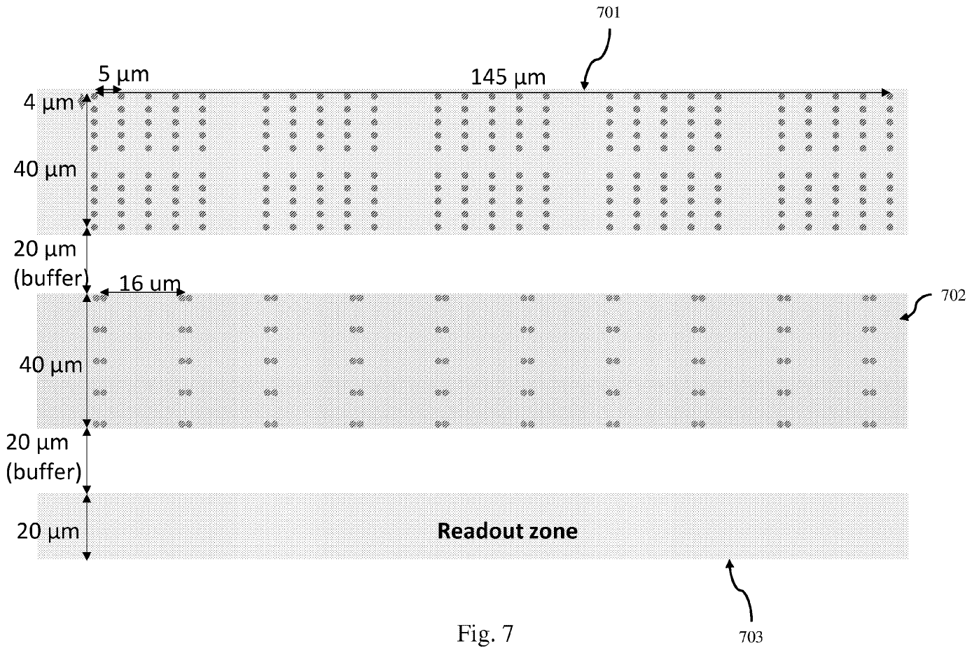

Referring to FIG. 7, a schematic view of a portion of a processor core, such as processor core 401, is provided with exemplary measurements and qubit arrangements. In this example, storage zone portion 701 measures 145×40 μm, active zone portion 702 measures 145×40 μm, and readout zone portion 703 measures 145×20 μm. Storage zone portion 701 is separated from active zone portion 702 by a 20 μm buffer. Active zone portion 702 is separated from readout zone portion 703 by a 20 μm buffer.

In this example, active zone portion 702 has 50 positions, separated by 16 μm in one dimension and 10 μm in the other dimension. Each dot represents an atomic qubit, and so, in this example, qubits are located proximate to each other when interlaced to perform a bitwise operation. Storage zone portion 701 has 250 positions, separated by 5 μm in one dimension and 4 μm in the other dimension. Accordingly, storage zone portion 701 has a higher density than active zone portion 702.

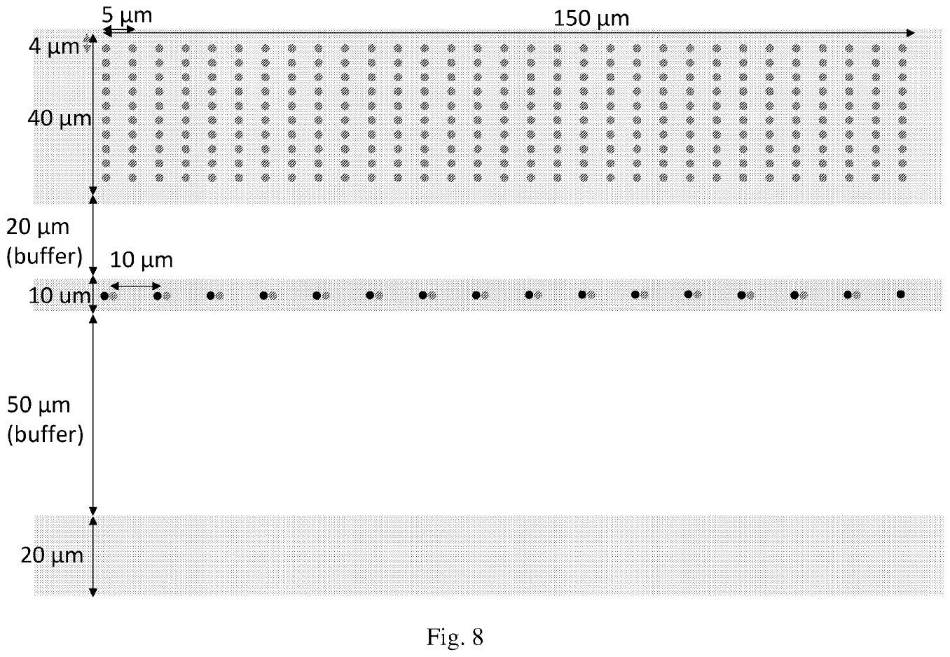

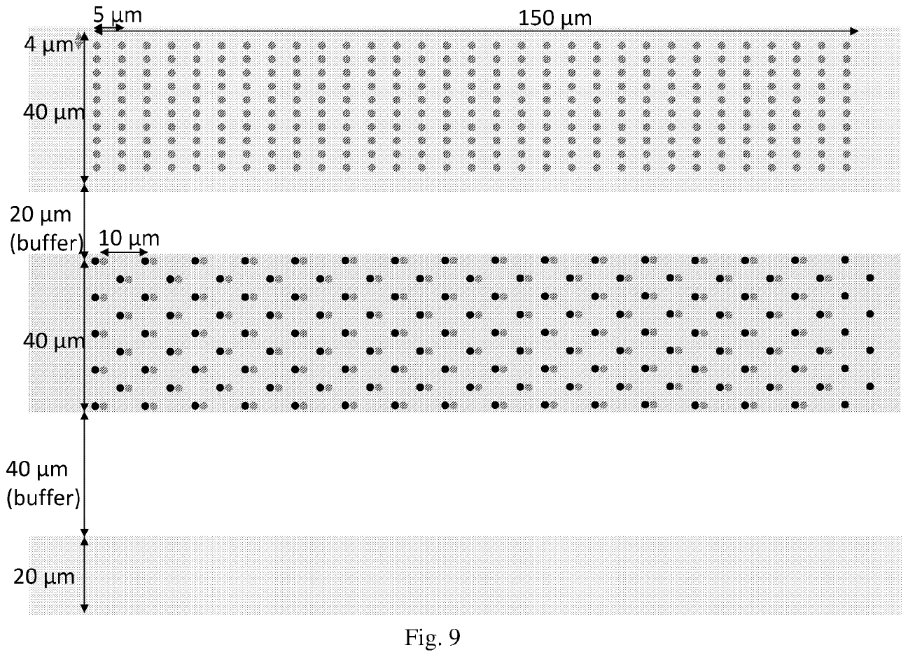

Alternative arrangements are provided in FIGS. 8-9. For example, the arrangement in FIG. 8 is suitable for use in implementing a repetition code. In another example, the arrangement in FIG. 9 is suitable for use in implementing a surface code.

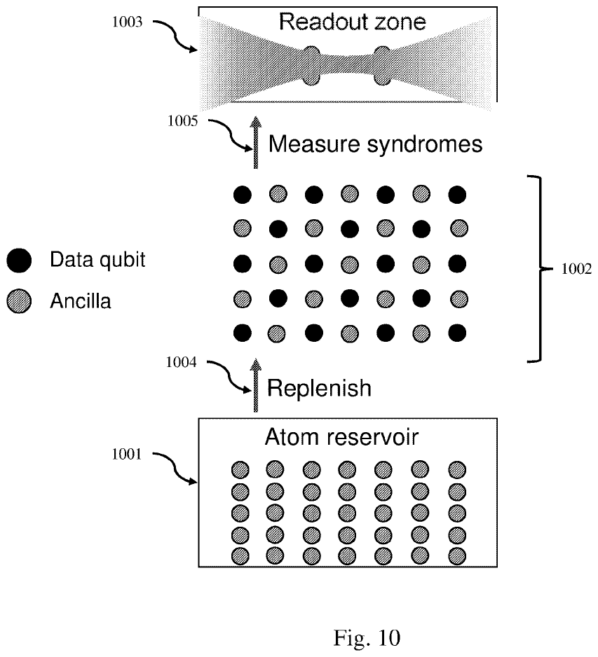

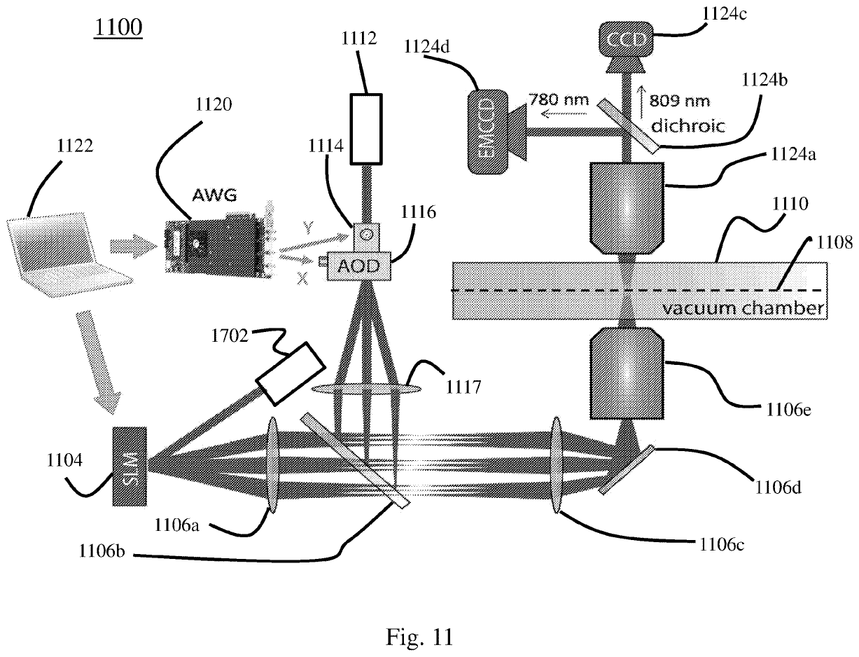

Referring to FIG. 10, a schematic view of a method of active, feedforward QEC is provided. In this example, a portion of a quantum processor (such as depicted in FIG. 4) is depicted, including a reservoir 1001 (such as loading zone 404), an active zone 1002 (such as active zone 412), and a readout zone 1003 (such as readout zone 411). Ancilla qubits are continually replenished 1004 from reservoir 1001 to replace ancilla qubits that are moved 1005 from active zone 1002 to readout zone 1003 to be measured. Using the zoned architecture provided herein enables a complete QEC round within 1 ms.

### Dynamic Reconfiguration in 2D Tweezer Arrays

Exemplary experiments utilize the apparatus described below. Inside the vacuum cell, ⁸⁷Rb atoms are loaded from a magneto-optical trap into a backbone array of programmable optical tweezers generated by a spatial light modulator (SLM). Atoms are rearranged in parallel into defect-free target positions in this SLM backbone by additional optical tweezers generated from a crossed 2D acousto-optic deflector (AOD). Following the rearrangement procedure, selected atoms are transferred from the static SLM traps back into the mobile AOD traps, and then these mobile atoms are moved to their starting positions in the quantum circuit. During this entire process, the atoms are cooled with polarization gradient cooling. Before running the quantum circuit, a camera image of the atoms in their initial starting positions is taken. Following the circuit, a final camera image is taken to detect qubit states |0 [symbol] (atom presence) and |1 [symbol] (atom loss, following resonant pushout). All data are postselected on finding perfect rearrangement of the AOD and SLM atoms before running the circuit. In some embodiments, each atom remains in a single static or single mobile trap throughout the duration of the quantum circuit.

The crossed AOD system is composed of two independently controlled AODs (AA Opto Electronic DTSX-400) for x and y control of the beam positions. Both AODs are driven by independent arbitrary waveforms which are generated by a dual-channel arbitrary waveform generator (AWG) (M4i.6631-x8 by Spectrum Instrumentation) and then amplified through independent MW amplifiers (Minicircuits ZHL-5W-1). The time-domain arbitrary waveforms are composed of multiple frequency tones corresponding to the x and y positions of columns and rows, which are independently changed as a function of time for steering around the AOD-trapped atoms dynamically; the full x and y waveforms are calculated by adding together the time-domain profile of all frequency components with a given amplitude and phase for each component. For running quantum circuits, the positions of the AOD atoms at each gate location are programmed and then the AOD frequencies are smoothly interpolated (with a cubic profile) as a function of time between gate positions. The cubic profile enacts a constant jerk onto the atoms, which allows movement of roughly 5-10× faster (without heating and loss) than if moving at a constant velocity (linear profile). In the movement protocol, stretches, compressions, and translations of the AOD trap array are applied: i.e., the AOD rows and columns never cross each other in order to avoid atom loss and heating associated with two frequency components crossing each other.

The AOD tweezer intensity is homogenized throughout the whole atom trajectory in order to minimize dephasing induced by a time-varying magnitude of differential light shifts. To this end, a reference camera is used in the image plane to gauge the intensity of each AOD tweezer at each gate location and homogenize by varying the amplitude of each frequency component; during motion between two locations the amplitude of each individual frequency component is interpolated.

The SLM tweezer light (830 nm) and the AOD tweezer light (828 nm) are generated by two separate, free-running Ti:sapphire lasers (M Squared, 18-W pump). Projected through a 0.5 NA objective, the SLM tweezers have a waist of roughly ~900 nm (~1000 nm for AODs). When loading the atoms, the trap depths are ~2π×16 MHz, with radial trap frequencies of ~2π×80 kHz, and when running quantum circuits the trap depths are ~2π×4 MHz, with radial trap frequencies of ~2π×40 kHz.

### Raman Laser System

Fast, high-fidelity single-qubit manipulations are critical ingredients of the quantum circuits demonstrated in this work. To this end, a high-power 795-nm Raman laser system is used for driving global single-qubit rotations between m_{F}=0 clock states. This Raman laser system is based on dispersive optics. 795-nm light (Toptica TA pro, 1.8W) is phase-modulated by an electro-optic modulator (Qubig), which is driven by microwaves at 3.4 GHz (Stanford Research Systems SRS SG384) that are doubled to 6.8 GHz and amplified. The laser phase modulation is converted to amplitude modulation for driving Raman transitions through use of a Chirped Bragg Grating (Optigrate). IQ control of the SG384 is used for frequency and phase control of the microwaves, which are imprinted onto the laser amplitude modulation and thus enable direct frequency and phase control over the hyperfine qubit drive.

The Raman laser illuminates the atom plane from the side in a circularly polarized elliptical beam with waists of 40 μm and 560 μm on the thin axis and the tall axis, respectively, with a total average optical power of 150 mW on the atoms. The large vertical extent ensures <1% inhomogeneity across the atoms, and shot-to-shot fluctuations in the laser intensity are also <1%. The Raman laser is operated at a blue-detuned intermediate-state detuning of 180 GHz, resulting in two-photon Rabi frequencies of 1 MHz and an estimated scattering error per TC pulse of 7×10⁻⁵ (i.e. 1 scattering event per 15000 Tr pulses).

### Qubit Coherence and Dynamical Decoupling

In the 830-nm traps, hyperfine qubit coherence is characterized by

$${T}_{2}^{*} = 4 ms$$

(not plotted here), T₂=1.5 s (XY16 with 128 total π pulses), and T₁=4 s (including atom loss). The experiments described herein are performed in a DC magnetic field of 8.5 Gauss. Coherence can be further improved by using further-detuned optical tweezers (with trap depth held constant, the tweezer differential lightshifts decrease as 1/Δ and 1/T₁ decreases as 1/Δ³) and shielding against magnetic field fluctuations. For practical QEC operation, atom loss can be detected in a hardware-efficient manner and the atom then can be replaced from a reservoir, which could in principle be continuously reloaded by a MOT for reaching arbitrarily deep circuits.

The transport sequences are accompanied by dynamical decoupling sequences. The number of pulses used is a tradeoff between preserving qubit coherence while minimizing pulse errors. In various embodiments, there is an interchange between two types of dynamical decoupling sequences: XY8/XY16 sequences, composed of phase-alternated individual π-pulses which are self-correcting for amplitude and detuning errors, and CPMG-type dynamical decoupling sequences composed of robust BB1 pulses. The CPMG-BB1 sequence is more robust to amplitude errors but incurs more scattering error. The sequence may be empirically optimized for any given experiment by choosing between these different sequences and a variable number of decoupling 1 pulses, optimizing on either single-qubit coherence (including the movement) or the final signal. Typically, decoupling sequences are composed of a total of 12-18 m pulses.

### Movement Effects on Atom Heating and Loss

The following discusses the effects of movement on atom loss and heating in the harmonic oscillator potential given by the tweezer trap. Motion of the trap potential is equivalent to the non-inertial frame of reference where the harmonic oscillator potential is stationary, but the atom experiences a fictitious force given by F(t)=−m a(t), where m is the mass of the particle and a(t) is the acceleration of the trap as a function of time. The average vibrational quantum number increase ΔN is given by

$$Δ N = \frac{{\vert \tilde{a} ( {ω}_{0} ) \vert}^{2}}{{( 2 {x}_{zpf} {ω}_{0} )}^{2}} \qquad Equation 2$$

where ã(ω₀) is the Fourier transform of a(t) evaluated at the trap frequency ω₀, and the zero point size of the particle x_{zpf}≡ [symbol] . ΔN is the same for all initial levels of the oscillator. Experimentally, an acceleration profile a(t)=jt is applied to the atom, from time −T/2 to +T/2 to move a distance D with constant jerk j. Calculating |ã(ω)|², simplifying using ω₀T>>1, and assuming a small range of trap frequencies to average the oscillatory terms, results in

$$Δ N = \frac{1}{2} {( \frac{\frac{6 D}{{x}_{zpf}}}{{ω}_{0}^{2} {T}^{2}} )}^{2} \qquad Equation 3$$

Several relevant insights can be gleaned from this formula. First, this expression indicates the ability to move large distances D with comparably small increases in time T. Furthermore, to maintain a constant ΔN, the movement time

$$T ∝ {ω}_{0}^{- 3 / 4} .$$

Moreover, to perform a large number of moves k for a deep circuit, ΔN∝k/T⁴ can be estimated, suggesting that the number of moves can be increased from, e.g., 5 to 80 by slowing each move from 200 μs to 400 μs. Move speed could be further improved with different a(t) profiles, but inevitably with finite resources such as trap depth, quantum speed limits will eventually prevent arbitrarily fast motion of qubits across the array.

Equation 3 is now compared to experimental observations. Atom loss is observed with movement of 55 μm in 200 μs under a constant negative jerk. This speed limit is consistent with the above estimates: using ω₀=2π×40 kHz and x_{zpf}=38 nm, it is predicted that ΔN≈6 for this move, corresponding to the onset of tangible heating at this move speed. More quantitatively, a Poisson distribution is assumed with mean N and variance N and integrate the population above some critical Nₘₐₓ upon which the atom will leave the trap. From this analysis, atom retention is given by

$$\frac{1}{2} ( 1 + erf [ \frac{{N}_{max} - N}{\sqrt{2 N}} ] ) .$$

Additional heating and loss during the circuit can also be caused by repeated short drops for performing two-qubit gates, where the tweezers are briefly turned off to avoid anti-trapping of the Rydberg state and light shifts of the ground-Rydberg transition. However, drop-recapture measurements suggest the 500-ns drops used experimentally have a negligible effect until hundreds of drops per atom (corresponding to hundreds of CZ gates). Atom loss and heating as a function of number of drops are well-described by a diffusion model, which would then predict that reducing atom temperature by a factor of 2× (reducing thermal velocity by \sqrt{2}×) and reducing drop time t_{drop} by 2×, together would increase the number of possible CZ gates per atom to thousands.

### Two-Qubit CZ Gates Implementation

Two-qubit gates and calibrations may be implemented using the techniques provided herein. Specifically, the two-qubit CZ gate is implemented by two global Rydberg pulses, with each pulse at detuning Δ and length τ, and with a phase jump ξ between the two pulses. The pulse parameters are chosen such that qubit pairs, adjacent and under the Rydberg blockade constraint, will return from the Rydberg state back to the hyperfine qubit manifold with a phase depending on the state of the other qubit. The numerical values for these pulse parameters are:

$$Δ = - 0.3 \; 77371 Ω$$

$$ξ = - 0.621089 \times ( 2 π )$$

$$τ = 0. 683201 / [ Ω / ( 2 π ) ]$$

Exemplary experiments are operated with a two-photon Rydberg Rabi frequency of Ω/2π=3.6 MHz, giving a theoretical τ=190 ns and a theoretical Δ/(2π)=−1.36 MHz. The negative detuning sign is chosen to help minimize excitation into the mⱼ=+½ Rydberg state which is detuned by about 24 MHz under the field of 8.5 G (and experiences a 3×lower coupling to the Rydberg laser than the desired mⱼ=−½ state due to reduced Clebsch-Gordan coefficients). In this work strong blockade between adjacent qubits is provided, with Rydberg-Rydberg interactions V₀/2π ranging from 200 MHz to 1 GHz.

### Managing Spurious Phases During CZ Gates

The two-qubit gate induces both an intrinsic single-qubit phase, as well as spurious phases which are primarily induced by the differential light shift from the 420-nm laser. Under certain configurations, the 420-nm-induced differential light shift on the hyperfine qubit can be exceedingly large (>8 MHz), yielding phase accumulations on the hyperfine qubit of ≈6π. Small, percent-level variations of the 420-nm intensity can thus lead to significant qubit dephasing.

This 420-induced-phase issue may be addressed by performing an echo sequence: after the CZ gate, the 1013-nm Rydberg laser is turned off, a Raman π pulse is applied, and then the 420-nm laser is pulsed again to cancel the phase induced by the 420 light during the CZ gate. This method echoes out the 420-induced phase, but comes at a cost of a factor of two increase in the 420-induced scattering error, which is the dominant source of error in two-qubit CZ gates.

Echo between CZ gates. To address these various issues, a Raman π pulse is performed between each CZ gate to echo out spurious gate-induced phases on the hyperfine qubit. This approach has several advantages. The 420-induced phase is now cancelled by pairs of CZ gates, without explicitly applying additional 420-nm pulses to echo each individual CZ gate, thereby reducing the scattering error of the CZ gate in this work by a factor of approximately two. This echo technique, having reduced the scattering error incurred during each gate, roughly compensates the increased scattering rate incurred by spreading optical power over more space in 2D, thereby giving comparable gate fidelites to the two-qubit CZ gate fidelities of ≥97.4(2)%. Further, the echo between CZ gates also cancels the intrinsic single-qubit phase of the CZ gate, removing errors in the calibration of this parameter, as well as canceling any other gate-induced spurious single-qubit phases such as a ≈0.01 rad phase induced by pulsing the traps off for 500 ns for the two-qubit gate. In instances where the number of CZ gates is odd, the echo for the final CZ gate is performed.

Sign of intermediate-state detuning. To further suppress the effect of the spurious, 420-induced phase, the 420-nm laser is operated to be red-detuned (by 2 GHz) from the 6P_{3/2} transition. For red detunings, the light shift on the |0 [symbol] state and the |1 [symbol] state are of the same sign, minimizing the differential light shift, while for blue detunings<6.8 GHz, the light shift on the |0 [symbol] state and the |1 [symbol] state have opposite signs and amplify the differential light shift.

### Sensitivity to Axial Trap Oscillations

In typical Rydberg excitation timescales with optical tweezers, the axial trap oscillation frequencies of several kHz are inconsequential. Here with circuits running as long as 1.2 ms, with Rydberg pulses throughout, the axial trap oscillations can have important effects. In particular, the axial oscillations cause the atoms to make oscillations in/out of the Rydberg beams: at estimated axial temperature of ~25 μK and axial oscillation frequency of 6 kHz, an axial spread [symbol] ≈1.3 μm is estimated. For 20-micron-waist beams, the effect of this positional spread is relatively small on the pulse parameters of the CZ gate, but can be significant on the sensitive 420-induced phase that should be canceled by echoing out the phase induced by CZ gates separated by ~200 μs. When using 20-micron-waist beams, and a 2.5-GHz blue detuning of the 420-nm laser, the dephasing due to the axial trap oscillations is significant. To remedy this deleterious effect, the beam waist of the 420-nm laser is increased to 35 microns (while maintaining constant intensity) and the laser frequency is changed to be 2-GHz red-detuned, together resulting in a significant reduction in the dephasing associated with improper echoing of the 420-nm pulse.

### Rydberg Beam Shaping and Homogeneity

The Rydberg beams are shaped into tophats of variable size through wavefront control using the phase profile on a spatial light modulator (SLM). This ability allows matching the height of the beam profile to the experiment zone size of any given experiment, thereby maximizing the 1013-nm light intensity and CZ gate fidelities. The Rydberg beam homogeneity is optimized until peak-to-peak inhomogeneities are below <1%. To this end, all aberrations are corrected up to the window of the vacuum chamber, which yields an inhomogeneity on the atoms of several percent that is attributed to imperfections of the final window. To further optimize the homogeneity, aberration corrections are tuned on the tophat through Zernike polynomial corrections to the phase profile in the SLM plane (Fourier plane). With this procedure peak-to-peak inhomogeneities are reduced to <1% over a range of 40-50 μm in the atom plane.

### Coherent Mapping Protocol

A coherent mapping protocol is provided to transfer a generic many-body state in the {|1 [symbol] , |r [symbol] }basis to the long-lived and non-interacting {|0 [symbol] , |1 [symbol] }basis. To achieve this mapping, immediately following the Rydberg dynamics, a Raman π pulse is applied to map |1 [symbol] →|0 [symbol] , and then a subsequent Rydberg π-pulse to map |r [symbol] →|1 [symbol] .

Even for perfect Raman and Rydberg π pulses (on isolated atoms), there are three key sources of infidelity associated with this mapping process:
(1) Any population in blockade-violating states (i.e., two adjacent atoms both in |r [symbol] will be strongly shifted off-resonance for the final Rydberg π pulse. As such, this [symbol] atomic population will be left in the Rydberg state and lost.
(2) Long-range interactions, e.g., from next-nearest-neighbors, will detune the final Rydberg π pulse from resonance and thus reduce pulse fidelity. Since the long-range interactions are not the same for all many-body microstates, this effect cannot be mitigated by a simple shift of the detuning.
(3) Dephasing of the state occurs throughout the duration of the Raman π pulse, predominantly from Doppler shifts between the ground states |0 [symbol] , |1 [symbol] and the Rydberg state |r [symbol] . Although these random on-site detunings are also present during the many-body dynamics, turning the Rydberg drive Ω off allows the system to freely accumulate phase and makes us particularly sensitive to dephasing errors.

The above error mechanisms are mitigated as follows. To minimize errors from (1), many-body dynamics are performed with

$$\frac{{Ω}^{2}}{2 {V}_{0}^{2}} \approx 0.01 .$$

This minimizes the probability of an atom to violate blockade to be of order 1%. To help minimize errors from (2), the amplitude of the 420-nm laser is increased for the final π pulse by a factor of 2×, such that

$${( \frac{{V}_{NNN}}{Ω} )}^{2} = 0.005$$

(where V_{NNN} are the interactions with next-nearest neighbors), reducing pulse errors from long-range interactions to order 1%. Finally, to reduce errors from (3), a fast Raman π pulse is performed, leaving only 150 ns between ending the many-body Rydberg dynamics and beginning the Rydberg π pulse. The 150-ns gap is comparably short relative to the

$${T}_{2}^{*} \approx 3 - 4 μs of the \{ \vert g 〉 , \vert r 〉 \}$$

basis, leading to a random phase accumulation of order ~0.02×2π rad per particle, but is further compounded by having entangled states of N particles in one copy accumulating a random phase relative to entangled states of N particles in the second copy.

The global Raman beam induces a light-shift-induced phase shift of ≈π on |0 [symbol] , |1 [symbol] relative to |r [symbol] during the Raman π pulse. Similarly, the global 420-nm laser also induces a [symbol] light-shift-induced phase shift of ≈π between |0 [symbol] and |1 [symbol] during the Rydberg m pulse. While the measurements performed here are interferometric (in other words, the singlet state measured is invariant under global rotations) and thus not affected by these global phase shifts, these phase shifts can be measured and accounted for where relevant.

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on top of the SLM tweezer array.

### Exemplary Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p~0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p~0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

Referring to FIG. 11, a schematic view is provided of an apparatus 1100 for quantum computation according to embodiments of the present disclosure. As shown in FIG. 11, using a beam generated by a light source 1102 (for example, a coherent light source, in some example embodiments—a monochromatic light source), SLM 1104 forms an array of trapping beams (i.e., a tweezer array) which is imaged onto trapping plane 1108 in vacuum chamber 1110 by an optical train that, in the example embodiment shown in FIG. 11, comprises elements 1106a, 1106c, 1106d, and a high numerical aperture (NA) objective 1106e. Other suitable optical trains can be employed, as would be easily recognized by a person of ordinary skill in the art. Using a beam generated by light source 1112 (for example, a coherent light source; in some example embodiments—a monochromatic light source), a pair of AODs 1114 and 1116, having non-parallel directions of acoustic wave propagation (for example, orthogonal directions) creates dynamically movable sorting beams. By using the optical train, such as the one depicted in FIG. 11 (elements 1117, 1106b, 1106c, 1106d, and 1106e), the sorting beams are overlapped with the trapping beams. It is understood that other optical train can be used to achieve the same result. For example, source 1102 and 1112 can be a single source, and the trapping beam and the sorting beam are generated by a beam splitter.

The dynamic movement of the steering beams is accomplished by employing two non-parallel AODs 1114, 1116, arranged in series. In the example embodiment depicted in FIG. 11, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 1120, which is generated in real-time by a computer 1122 which processes the feedback routine after analyzing the image of where atoms are loaded. If each AOD is driven with a single frequency component, then a single steering beam (“AOD trap”) is created in the same plane 1108 as the SLM trap array. The frequency of the X AOD drive determines the horizontal position of the AOD trap, and the frequency of the Y AOD drive determines the vertical position; in this way, a single AOD trap can be steered to overlap with any SLM trap.

In FIG. 11, laser 1102 projects a beam of light onto SLM 1104. SLM 1104 can be controlled by computer 1122 in order to generate a pattern of beams (“trapping beams” or “tweezer array”). The pattern of beams is focused by lens 1106a, passes through mirror 1106b, and is collimates by lens 1106c on mirror 1106d. The reflected light passes through objective 1106e to focus an optical tweezer array in vacuum chamber 1110 on trapping plane 1108. The laser light of the optical tweezer array continues through objective 1124a, and passes through dichroic mirror 1124b to be detected by charge-coupled device (CCD) camera 1124c.

Vacuum chamber 1110 may be illuminated by an additional light source (not pictured). Fluorescence from atoms trapped on the trapping plane also passes through objective 1124a, but is reflected by dichroic mirror 1124b to electron-multiplying CCD (EMCCD) camera 1124d. In this example, laser 1112 directs a beam of light to AODs 1114, 1116. AODs 1114, 1116 are driven by arbitrary wave generator (AWG) 1120, which is in turn controlled by computer 1122. Crossed AODs 1114, 1116 emit one or more beams as set forth above, which are directed to focusing lens 1117. The beams then enter the same optical train 1106b . . . 1106e as described above with regard to the optical tweezer array, focusing on trapping plane 1108.

It will be appreciated that alternative optical trains may be employed to produce an optical tweezer array suitable for use as set out herein.

### Exemplary Logical Processor Based on Atom Arrays

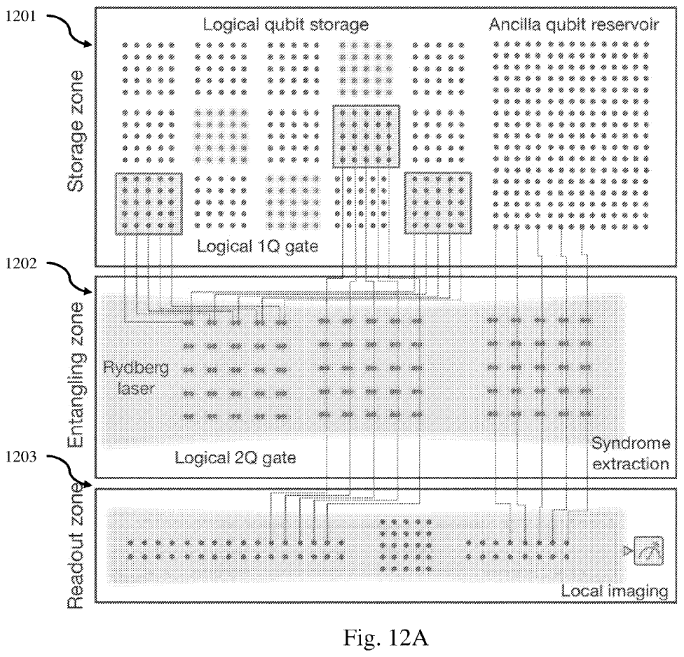

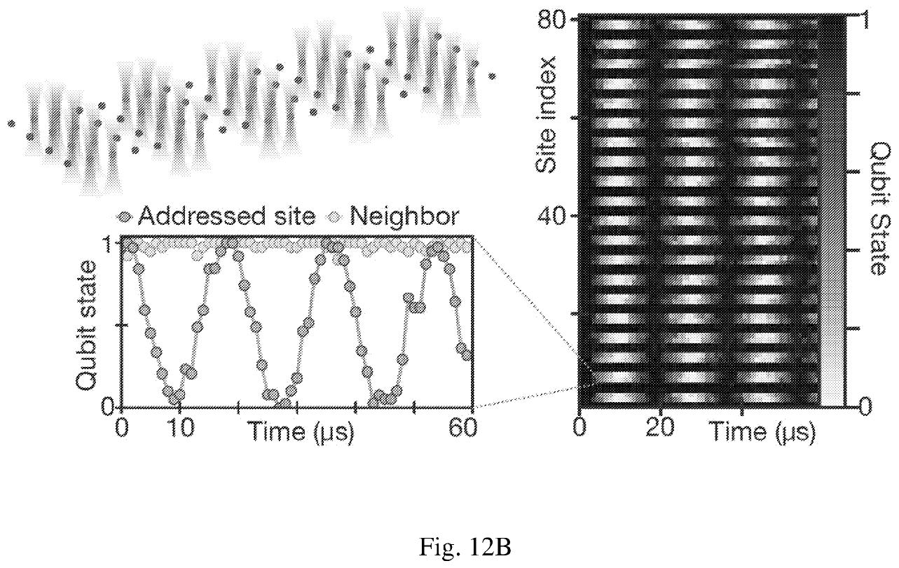

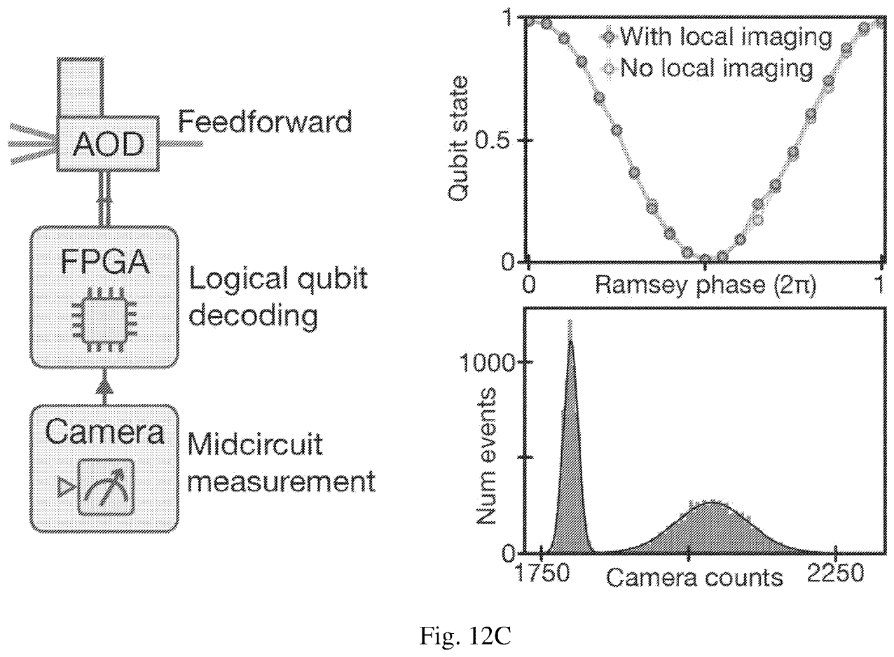

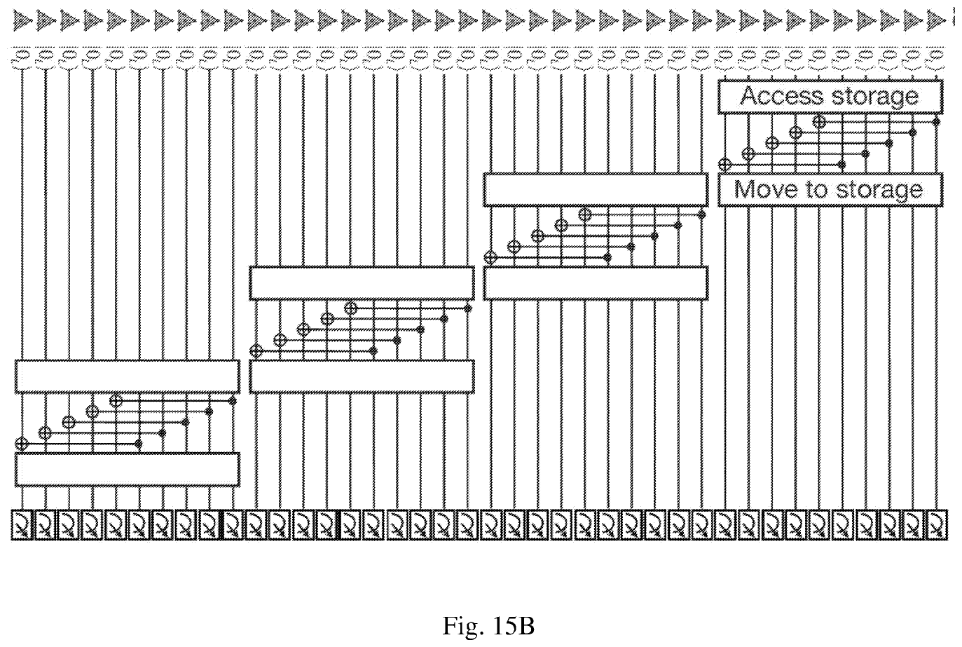

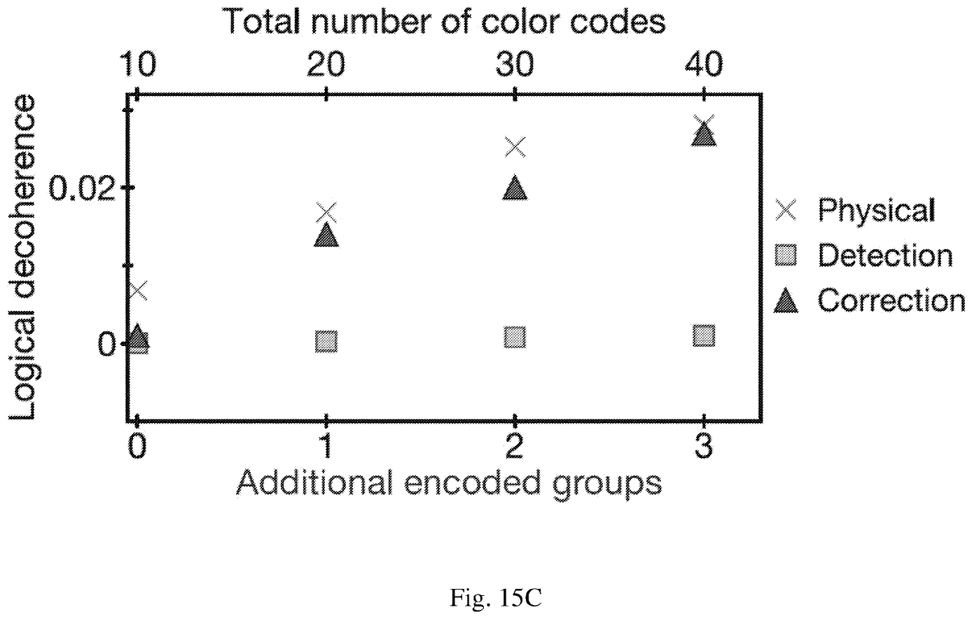

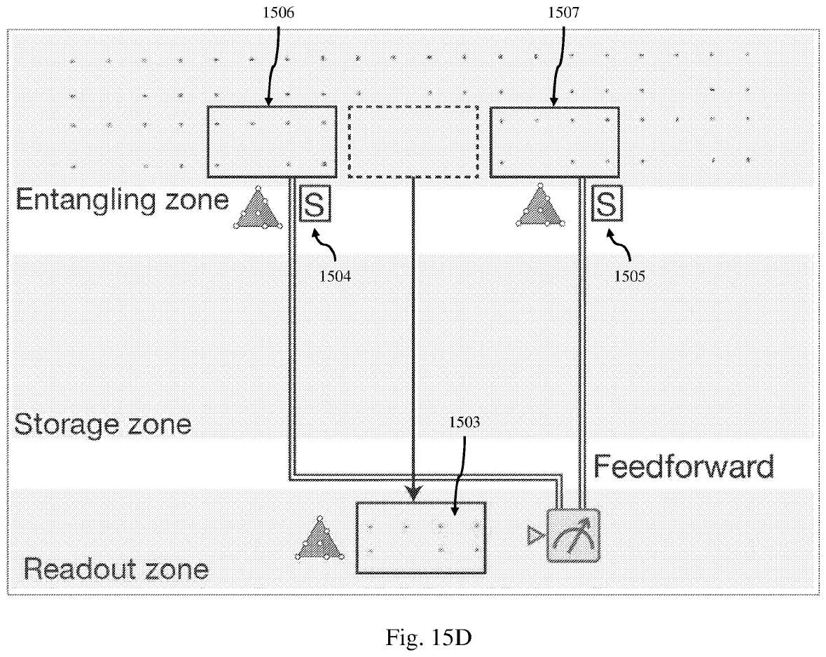

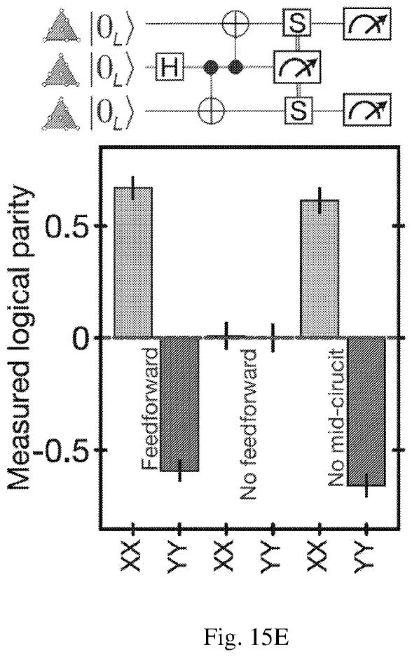

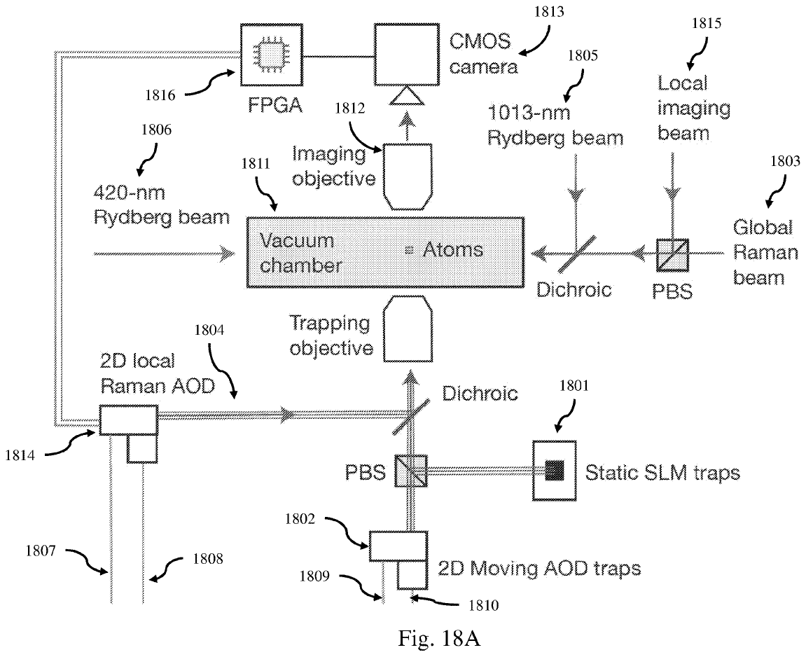

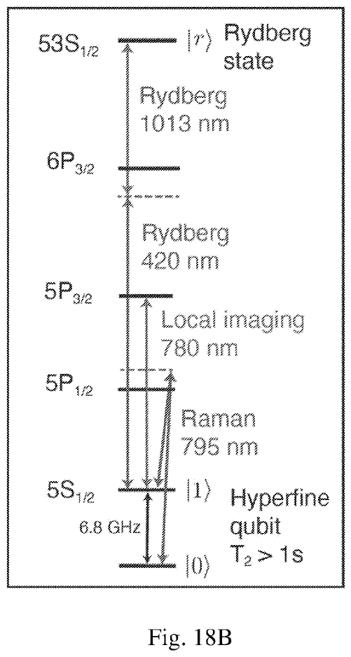

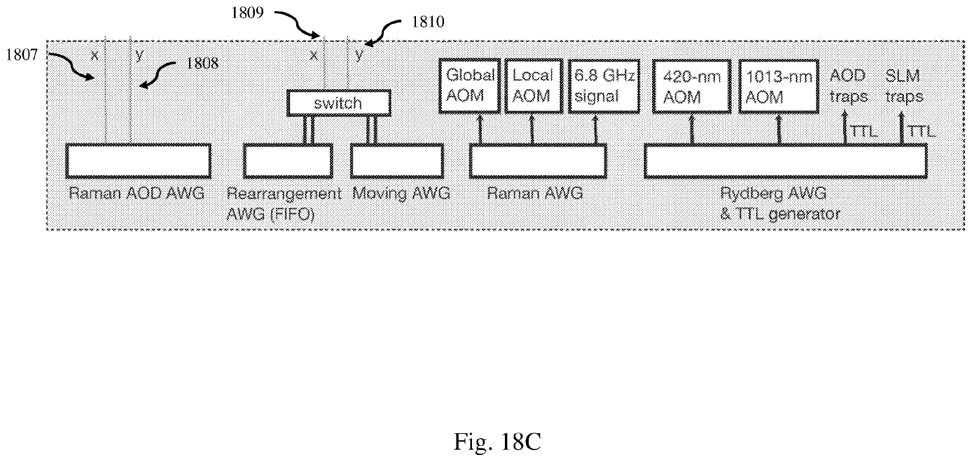

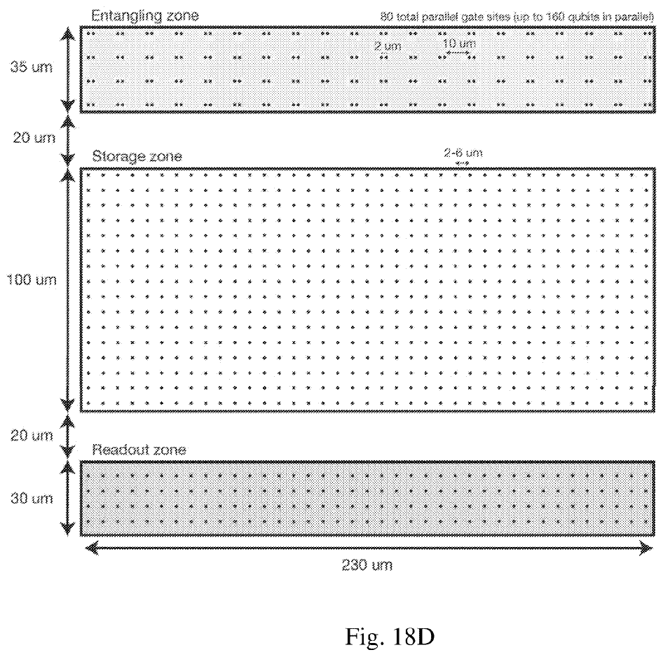

FIG. 12 illustrates a programmable logical processor based on reconfigurable atom arrays. FIG. 12A is a schematic of the logical processor, segmented into three zones: storage, entangling, and readout (see FIG. 18 for detailed layout). Logical single-qubit and two-qubit operations are realized transversally with efficient, parallel operations. Transversal CNOTs are realized by interlacing two logical qubit grids and performing a single global entangling pulse that excites atoms to Rydberg states. Physical qubits are encoded in hyperfine ground states of ⁸⁷Rb atoms trapped in optical tweezers. FIG. 12B shows fully programmable single-qubit rotations implemented using Raman excitation through a 2D AOD. Parallel grid illumination delivers the same instruction to multiple atomic qubits. FIG. 12C depicts mid-circuit readout and feedforward. The imaging histogram shows high-fidelity state discrimination (500 μs imaging time, readout fidelity≈99.8%), and the Ramsey fringe shows that qubit coherence is unaffected by measuring other qubits in the readout zone (error probability p~10⁻³). The FPGA performs real-time image processing, state decoding, and feedforward (as discussed further with regard to FIG. 15).

The logical processor architecture, illustrated in FIG. 12A, is segmented into three zones 1201, 1202, 1203 (as further described in FIG. 4). The storage zone 1201 is used for dense qubit storage, free from entangling gate errors and featuring long coherence times. The entangling zone 1202 is used for parallel logical qubit encoding, stabilizer measurements, and logical gate operations. Finally, the readout zone 1203 enables mid-circuit readout of desired logical or physical qubits, without disturbing the coherence of the computation qubits still in operation. This architecture is implemented using arrays of individual ⁸⁷Rb atoms trapped in optical tweezers, which can be dynamically reconfigured in the middle of the computation while preserving qubit coherence.

Physical qubits are encoded in clock states within the ground-state hyperfine manifold (T₂>1 s), and stored in optical tweezer arrays created by a spatial light modulator (SLM). In an exemplary embodiment a system of 280 atomic qubits is provided, combining high-fidelity two-qubit gates, enabled by fast excitation into atomic Rydberg states interacting through robust Rydberg blockade, with arbitrary connectivity enabled by atom transport via 2D acousto-optic deflectors (AODs). AODs use frequency multiplexing to take in just two voltage waveforms (one for each axis) to create large, dynamically programmable grids of light. Fully programmable local single-qubit rotations are realized via qubit-specific, parallel Raman excitation through an additional 2D AOD (FIG. 12B). Mid-circuit readout is enabled by moving selected qubits~100 μm away to a readout zone 1203 and illuminating with a focused imaging beam, resulting in high-fidelity imaging as well as negligible decoherence on stored qubits (FIG. 12C). The mid-circuit image is collected with a CMOS camera and sent to an FPGA for real-time decoding and feedforward.

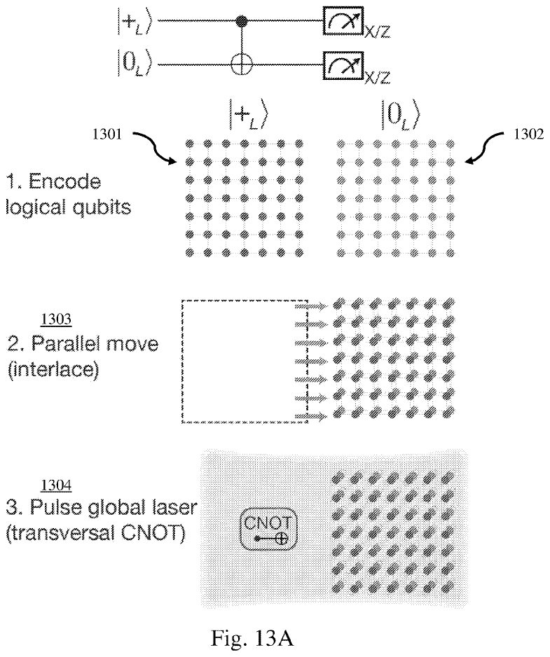

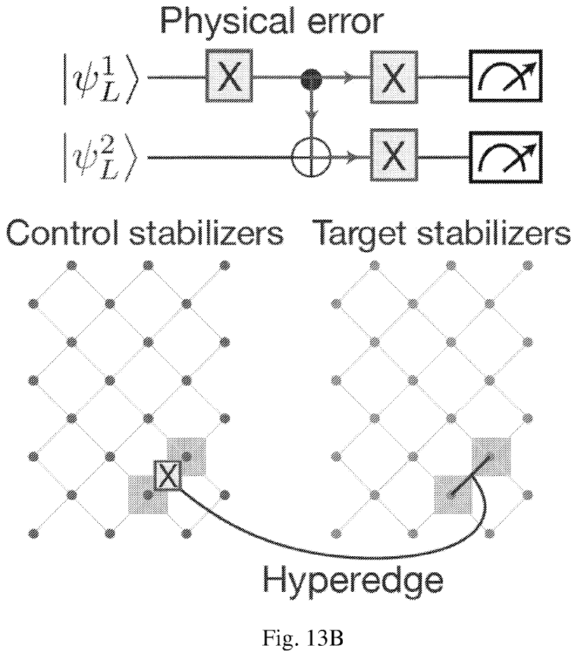

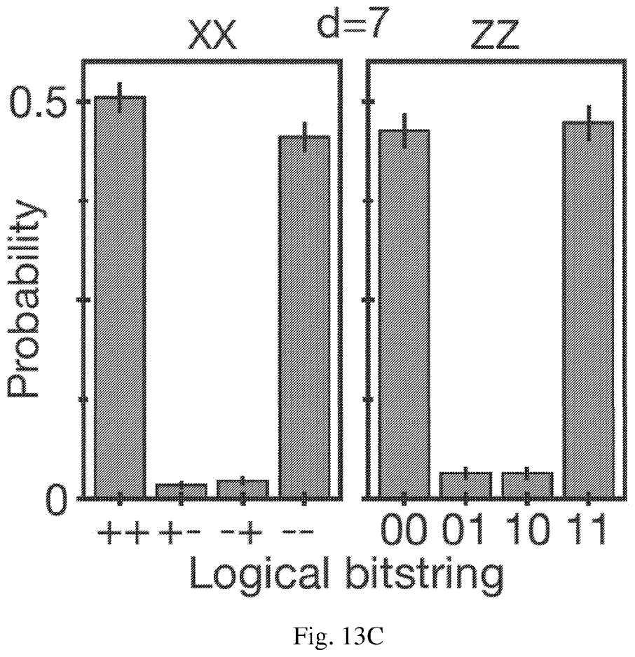

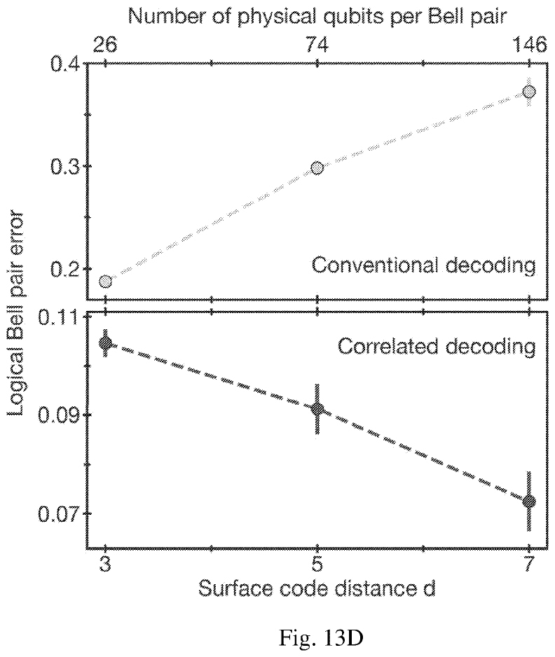

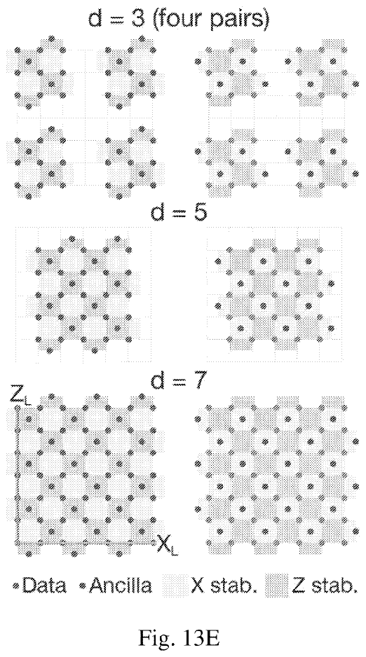

The logical processor enables control of individual logical qubits as the fundamental units, instead of individual physical qubits. During a vast majority of error-corrected operations, the physical qubits of a logical block are supposed to realize the same operation, and this instruction can be delivered in parallel with only a few control lines. This approach naturally multiplexes with optical techniques. For example, to realize a logical single-qubit gate, the Raman 2D AOD (FIG. 12B) may be used to create a grid of light beams and simultaneously illuminate the physical qubits of the logical block with the same instruction. Such a gate is transversal, meaning that operations act on physical qubits of the code block independently. This transversal property further implies the gate is inherently fault-tolerant, meaning that errors cannot spread within the code block, thereby preventing a physical error from spreading into a logical fault. A similar approach can realize logical entangling gates. Specifically, the grids generated by a moving 2D AOD can be used to pick up two logical qubits, interlace them in the entangling zone, and then pulse a single global Rydberg excitation laser to realize a physical entangling gate on each twin pair of the blocks (FIGS. 12A, 13A). This process realizes a high-fidelity, fault-tolerant transversal CNOT in a single parallel step.

Improving Entangling Gates with Code Distance

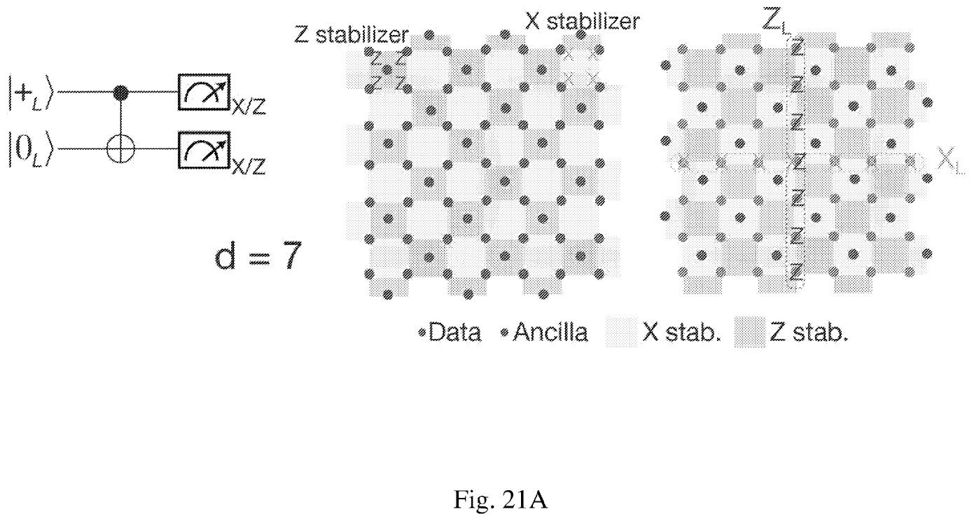

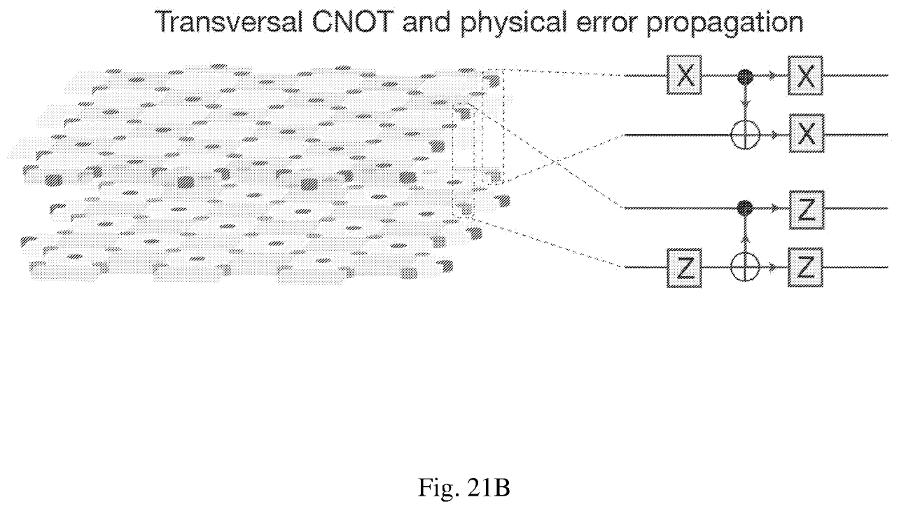

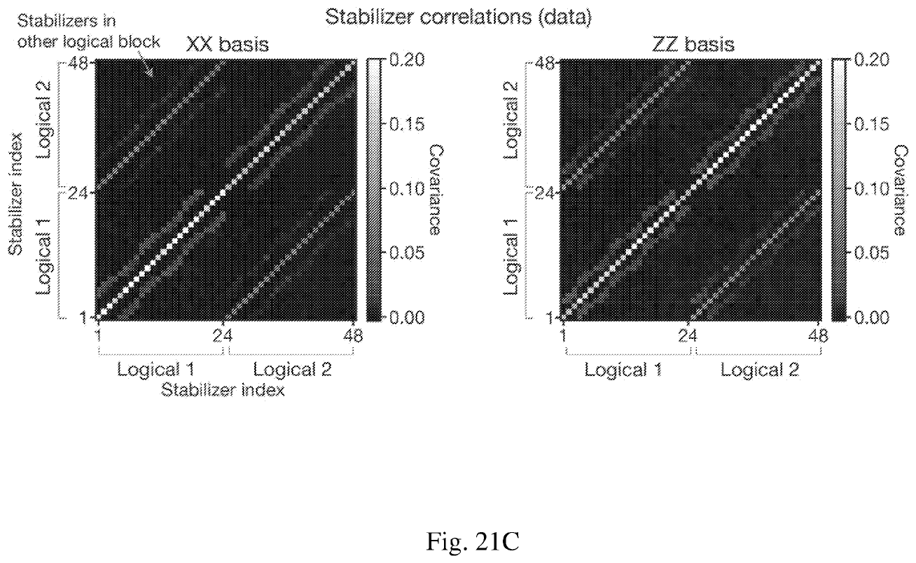

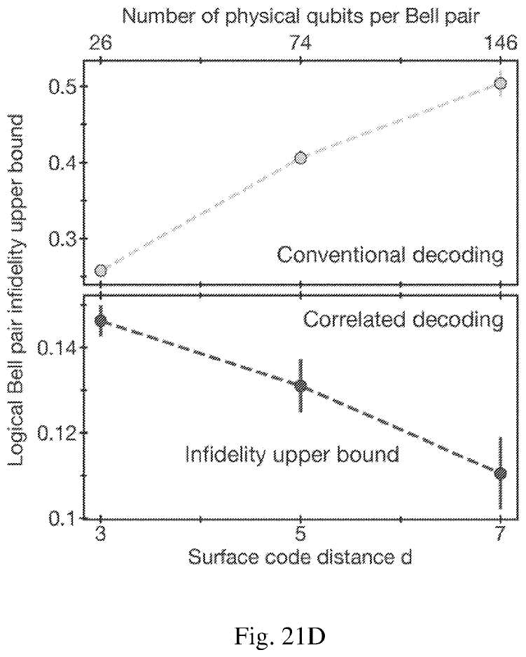

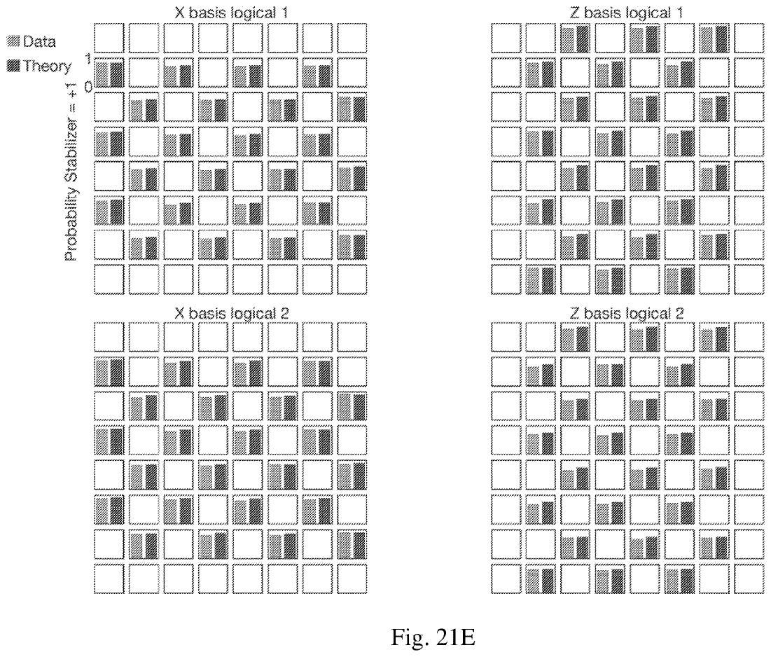

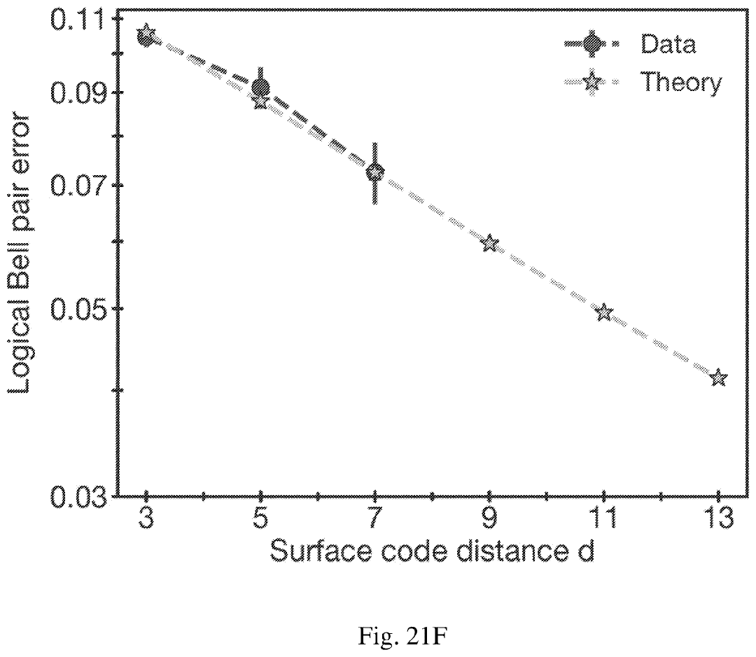

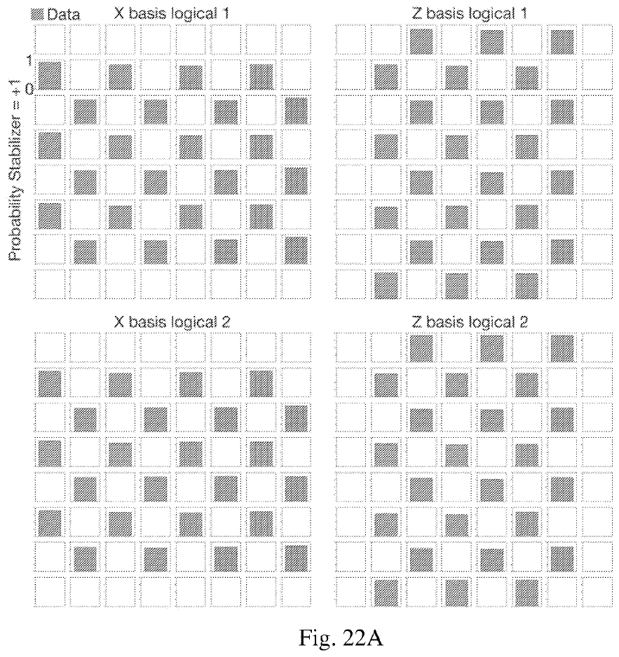

FIG. 13 illustrates transversal entangling gates between two surface codes. FIG. 13A is an illustration of transversal CNOT between two d=7 surface codes based on parallel atom transport. FIG. 13B depicts the concept of correlated decoding. Physical errors propagate between physical qubit pairs during transversal CNOT gates, creating correlations that can be utilized for improved decoding. These correlations, arising from deterministic error propagation (as opposed to correlated error events), are accounted for by adding edges and hyperedges that connect the decoding graphs of the two logical qubits. FIG. 13C depicts populations of entangled d=7 surface codes measured in the XX and ZZ basis. FIG. 13D depicts measured Bell pair error as a function of code distance, for both conventional (top) and correlated (bottom) decoding. Bell error is estimated with the average of the ZZ populations and the XX parities. To reduce code distance, selected atoms in the grid are removed from the grid, as shown in FIG. 13E, ensuring unchanged experimental conditions (for d=3, four logical Bell pairs are generated in parallel). Error bars represent standard error of the mean. See FIGS. 21,22 for additional surface code data.

A key property of QEC codes is that, for error rates below some threshold, the performance should improve with system size, associated with a so-called code distance. This property can be experimentally verified by reducing idling errors of a code. Neutral atom qubits can be idly stored for long times with low errors, and the central challenge is to improve entangling operations with code distance. To address this need, the present disclosure enables a transversal CNOT gate using logical qubits encoded in two surface codes (FIG. 13). Surface codes have stabilizers that are used for detecting and correcting errors without disrupting the logical state. The stabilizers form a 2D lattice of 4-body plaquettes of X and Z operators, which commute with the X_{L} (Z_{L}) logical operators that run horizontally (vertically) along the lattice (FIG. 13E). By measuring stabilizers one can detect the presence of physical qubit errors, decode (infer what error occurred), and correct the error simply by applying a software

$$\frac{{Z}_{L}}{{X}_{L}}$$

correction. Such a code can detect and correct a certain number of errors determined by the linear dimension of the system (the code distance d).

To test the performance of these logical entangling gate, the logical qubits are initialized by preparing physical qubits of two blocks 1301, 1302 in |+ [symbol] and |0 [symbol] states, respectively, and performing a single round of stabilizer measurements with parallel operations. While this state preparation is non-fault-tolerant (nFT) beyond d=3, error suppression of the transversal CNOT may still be probed. Specifically, the two logicals are prepared in state |+_{L} [symbol] and |0_{L} [symbol] . A parallel move 1303 is performed, and a global laser is pulsed 1304 to perform the transversal CNOT. Projective measurement is then performed to evaluate the logical Bell state stabilizers

$${X}_{L}^{1} {X}_{L}^{2} and {Z}_{L}^{1} {Z}_{L}^{2}$$

### (FIG. 13C).

For decoding and correcting the logical state, strong correlations are observed between the stabilizers of the two blocks (FIG. 21) due to propagation of physical errors between the codes during the transversal CNOT (FIG. 13B). These correlations are used to improve performance by decoding the logical qubits jointly, realized by a joint decoding graph that includes edges and hyperedges connecting the stabilizers of the two logical qubits (FIG. 13B). Using this correlated decoding procedure, ≈0.95 populations are measured in the X_{L}X_{L} and Z_{L}Z_{L} bases (FIG. 13C), showing entanglement between the d=7 logical qubits.

Studying the performance as a function of code size (FIG. 13D) reveals that the logical Bell pair improves with larger code distance, demonstrating improvement of the entangling operation. In contrast, when conventional decoding, i.e. independent minimum-weight perfect matching within both codes, is used, the fidelity decreases with code distance. This is in part due to the nFT state preparation, whose effect is partially mitigated by the correlated decoding.

### Fault-Tolerant Logical Algorithms

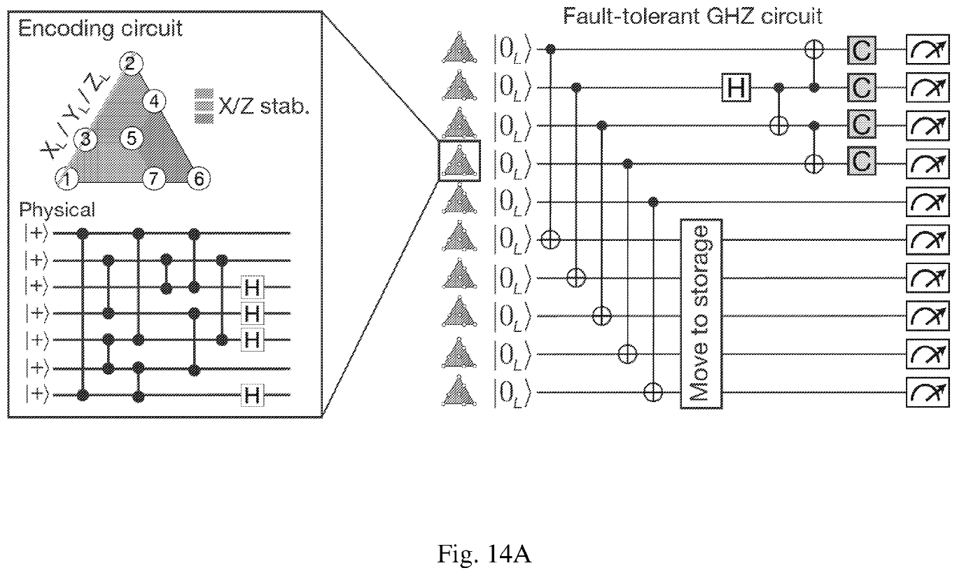

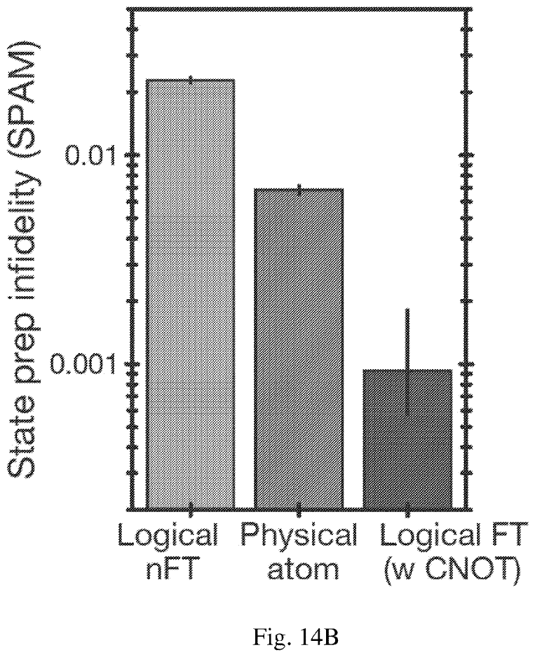

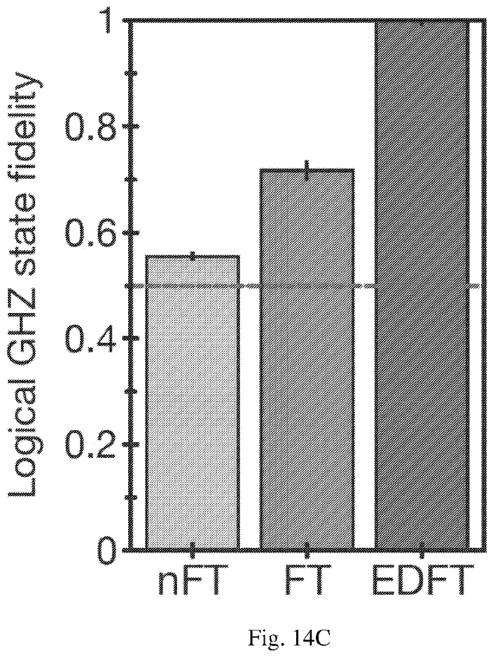

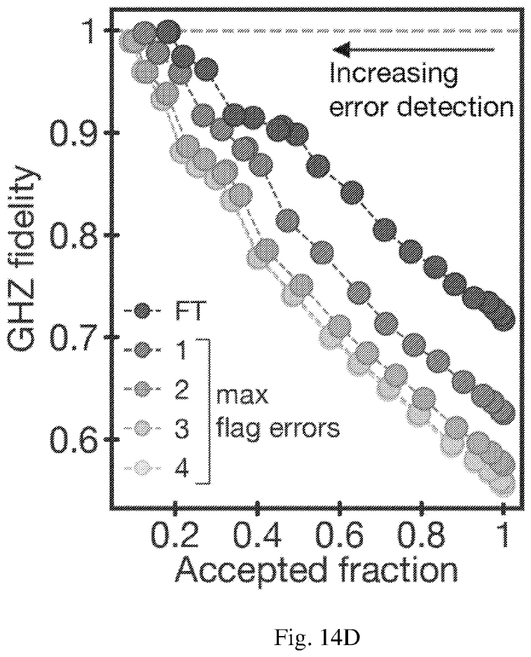

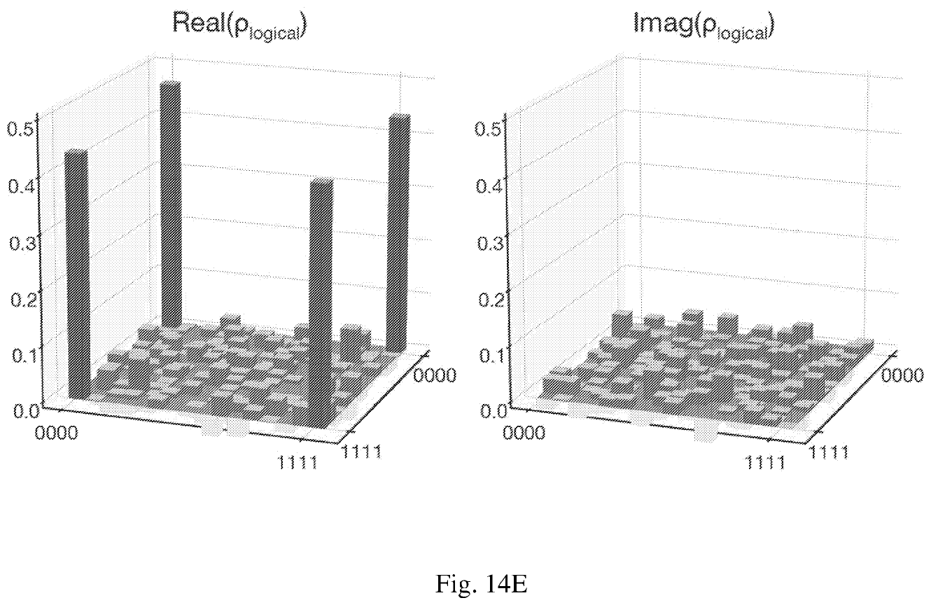

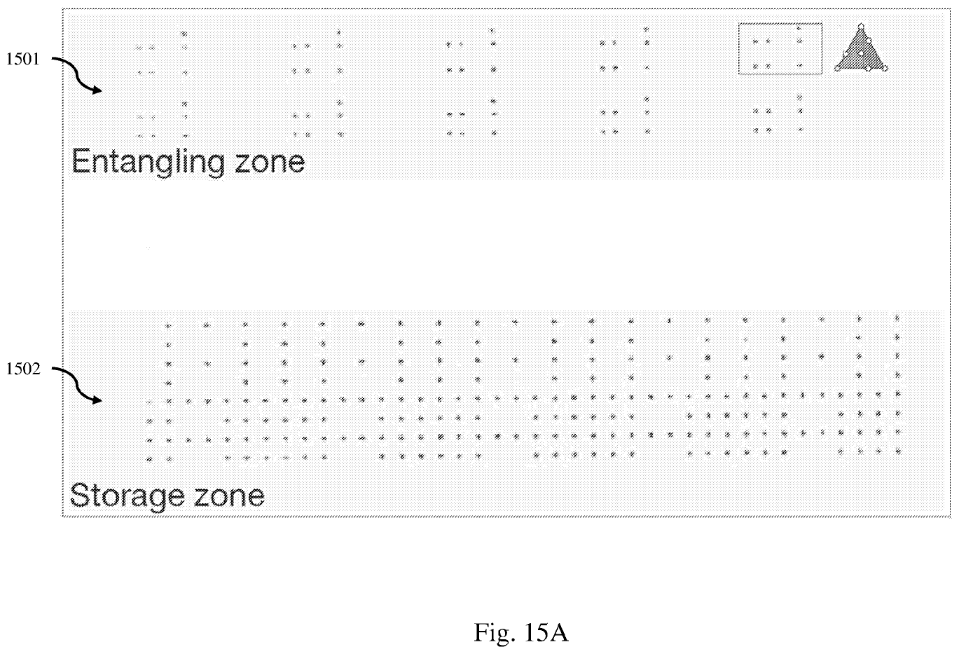

FIG. 14 illustrates fault-tolerant logical algorithms according to embodiments of the present disclosure. FIG. 14A depicts a circuit for preparation of logical GHZ state. Ten color codes are encoded non-fault-tolerantly (nFT), and then parallel transversal CNOTs between computation and ancilla logical qubits perform FT initialization. The ancilla logical qubits are moved to storage, and a 4-logical-qubit GHZ state is created between the computation qubits. Logical Clifford operations are applied before readout to probe the GHZ state. FIG. 14B depicts state-preparation-and-measurement (SPAM) infidelity of the logical qubits without (nFT) and with (FT) the transversal-CNOT-based flagged preparation, compared to physical qubit SPAM. FIG. 14C depicts logical GHZ fidelity without postselecting on flags (nFT), postselecting on flags (FT), and postselecting on flags and stabilizers of the computation logical qubits, corresponding to error detection (EDFT). FIG. 14D depicts GHZ fidelity as a function of sliding-scale error detection threshold (converted into the probability of accepted repetitions) and of number of successful flags in the circuit. FIG. 14E depicts a density matrix of the 4-logical-qubit GHZ state (with at most 3 flag errors) measured via full state tomography involving all 256 logical Pauli strings.

FIG. 15 illustrates a zoned logical processor with scaling and mid-circuit feedforward according to embodiments of the present disclosure. FIG. 15A depicts atoms in storage zone 1501 and entangling zone 1502, and an approach for creating and entangling 40 color codes with 280 physical qubits. FIGS. 15B,C depict 40 color codes prepared with an nFT circuit. Twenty transversal CNOTs are used to fault-tolerantly prepare 20 of the 40 codes, whose fidelity is plotted. Logical decoherence is smaller than the physical idling decoherence experienced during the encoding steps. FIG. 15D depicts mid-circuit measurement and feedforward for logical entanglement teleportation. The middle 1503 of three logical qubits is measured in the X-basis, and by applying a mid-circuit conditional, locally pulsed logical S rotation 1504, 1505 on the other two logical qubits 1506, 1507, the state |0_{L}0_{L} [symbol] +|1_{L}1_{L} [symbol] is prepared. FIG. 15E depicts measured logical qubit parity with and without feedforward, showing that feedforward recovers the intended state with Bell fidelity of 77(2)% (ZZ parities of 83(4)% not plotted). No mid-circuit refers to turning off the mid-circuit readout, and postselecting on the middle logical being in state |+_{L} [symbol] in the final readout. By postselecting on perfect stabilizers of only the two computation logicals (error detection in the final measurement) the feedforward Bell fidelity is 92(2)% (not plotted). In FIG. 15D, three of the additional blocks are flag qubits and the other four are prepared but unused for this circuit.

Exemplary logical algorithms described herein are built from transversal gates which are intrinsically fault-tolerant. Fault-tolerant state preparation is used below to provide programmable logical algorithms.

In one example, two-dimensional d=3 color codes are used, which are topological codes akin to the surface code, but with the useful capability of transversal operations of the full Clifford group: Hadamard (H),

$$\frac{π}{2}$$

phase (S) gate, and CNOT. This transversal gate set can realize any Clifford circuit fault-tolerantly. As a test case, a logical GHZ state is prepared. FIG. 14A shows the implementation of a 10-logical-qubit algorithm, in which all ten qubits are first encoded by a nFT encoding circuit. Then, five of the codes are used as ancilla logicals, performing parallel transversal CNOTs in order to fault-tolerantly detect errors on the computation logicals, and are then moved into the storage zone where they are safely kept. Subsequently four computation logicals are used to prepare the GHZ state, and logical Clifford rotations are used at the end of the circuit for direct fidelity estimation and full logical state tomography.

State initialization is benchmarked (FIG. 14B). Averaged over the five computation logicals, it is shown that by using the fault-tolerant initialization (postselecting on the ancilla logical flag not detecting errors) the |0_{L} [symbol] initialization fidelity is

$$99.9 {1}_{- 0.09}^{+ 0.04} \% ,$$

exceeding both the physical qubit |0 [symbol] initialization fidelity (99.32(4)%) and physical two-qubit gate fidelity (99.5%). Then, FIG. 14C shows the resulting GHZ state fidelity obtained using the fault-tolerant algorithm is 72(2)% (again using correlated decoding), demonstrating genuine multipartite entanglement. Additionally, one can postselect on all stabilizers of the computation logicals being correct; using this error detection approach, the GHZ fidelity increases to

$$99.8 {5}_{- 1.}^{+ 0.1} \%$$

at the cost of postselection overhead.

Since not all nontrivial syndromes are equally likely to cause algorithmic failure, one can perform a partial postselection where syndrome events most likely to have caused algorithmic failure are discarded, given by the weight of the correlated matching in the whole algorithm. FIG. 14D shows the measured GHZ fidelity as a function of this sliding threshold converted into a fraction of accepted experimental repetitions, continuously tuning the tradeoff between the success probability of the algorithm and its fidelity; e.g., discarding just 50% of the data improves GHZ fidelity to ≈90%. As discussed below, for certain applications purifying samples can be advantageous in improving algorithmic performance.

To fault-tolerantly measure all 256 logical Pauli strings, full GHZ state tomography is performed (FIG. 14E).

The use of the zoned architecture directly allows scaling circuits to larger numbers, without increasing the number of controls, by encoding and operating on logical qubits, moving them to storage, and then accessing storage as appropriate. This process is illustrated in FIGS. 15A,B, where ten color codes are made and operated on with parallel transversal CNOTs, moved to storage, and then more qubits are accessed from storage. Repeating this process four times, 40 color codes are created with 280 physical qubits, at the cost of slow idling errors of ~1% logical decoherence per additional encoding step (FIG. 15C). These storage idling errors primarily originate from global Raman π pulses applied for dynamical decoupling of atoms in the entangling zone, which can be significantly reduced with zone-specific Raman controls.

Since mid-circuit readout is an important component of logical algorithms, the present disclosure demonstrates a fault-tolerant entanglement teleportation circuit. A three-logical-qubit GHZ state |0_{L}0_{L}0_{L} [symbol] +|1_{L}1_{L}1_{L} [symbol] (FIGS. 15D,E) is created from fault-tolerantly prepared color codes. Mid-circuit X-basis measurement of the middle logical creates |0_{L}0_{L} [symbol] +|1_{L}1_{L} [symbol] if measured as |+_{L} [symbol] , and |0_{L}0_{L} [symbol] −|1_{L}1_{L} [symbol] if measured as |−_{L} [symbol] . One recovers |0_{L}0_{L} [symbol] +|1_{L}1_{L} [symbol] by applying a logical S gate to the first and third logicals conditioned real-time on the state of the middle logical, akin to the magic state teleportation circuit. Measurements in FIG. 15E indicate that while [symbol] X_{L}X_{L} [symbol] and [symbol] Y_{L}Y_{L} [symbol] indeed vanish without the feedforward step, applying the feedforward correction recovers a Bell state fidelity of 77(2)%, limited by imperfections in the original underlying GHZ state. By repeating this experiment without mid-circuit readout and instead post-selecting on the middle logical being in |+_{L} [symbol] , a similar Bell fidelity of 75(2)% is found, indicating high-fidelity performance of the readout and feedforward operations.

### Complex Logical Circuits Using 3D Codes

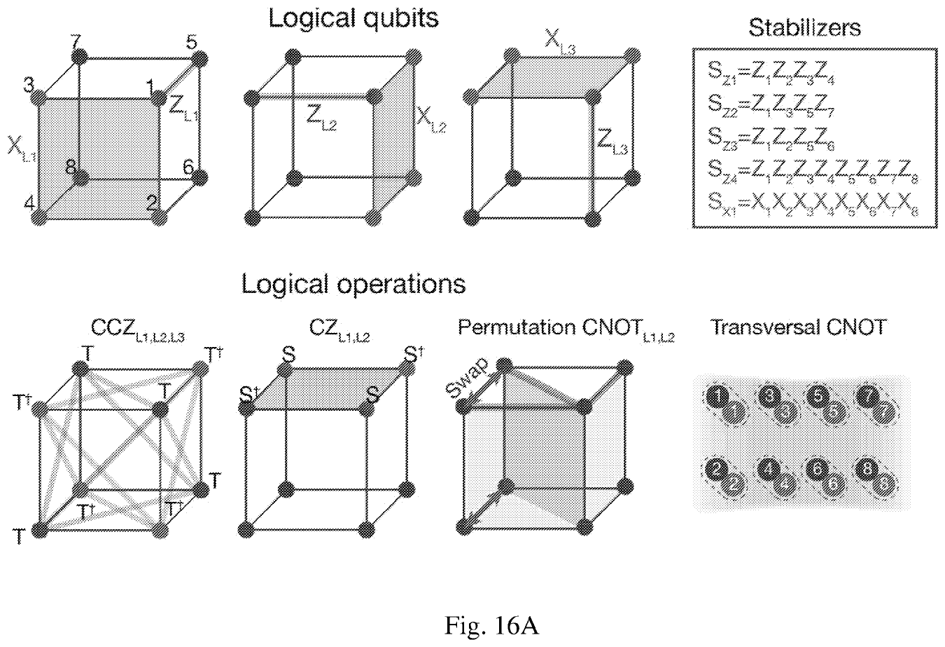

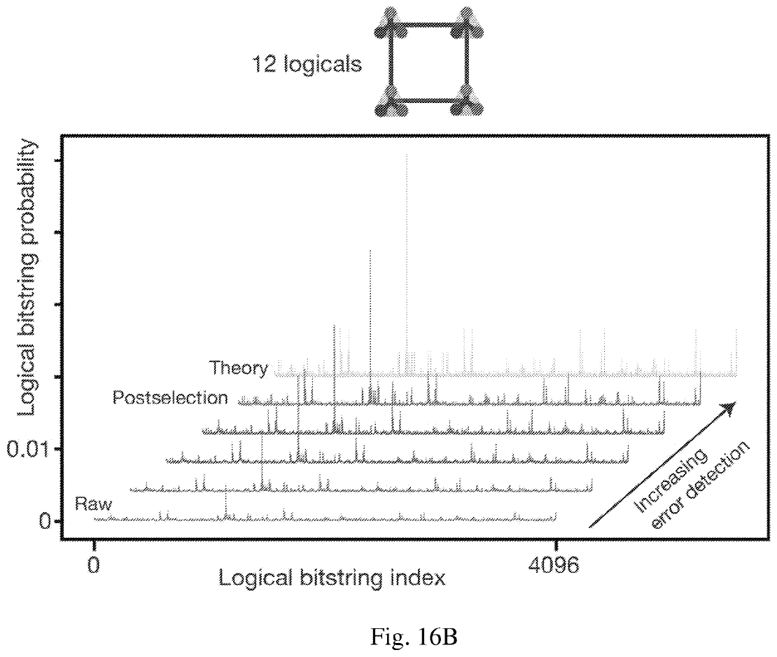

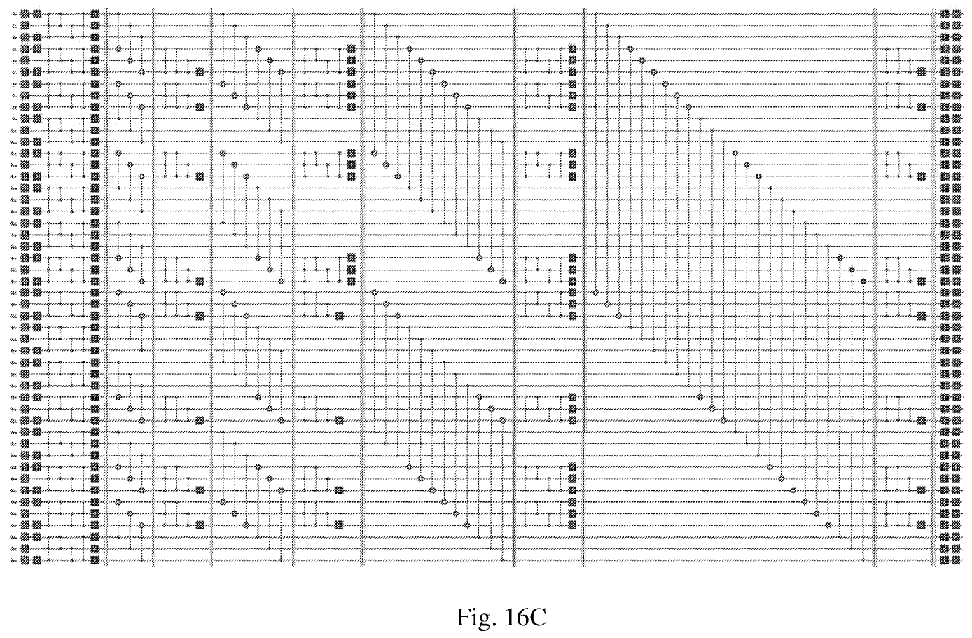

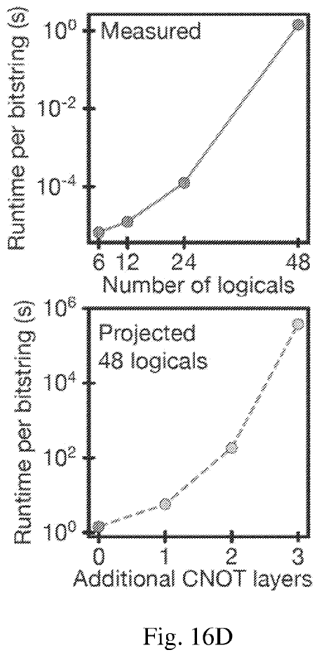

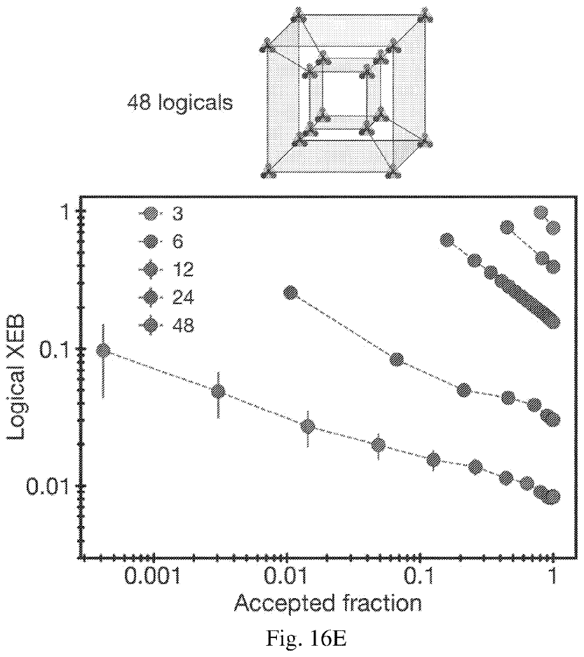

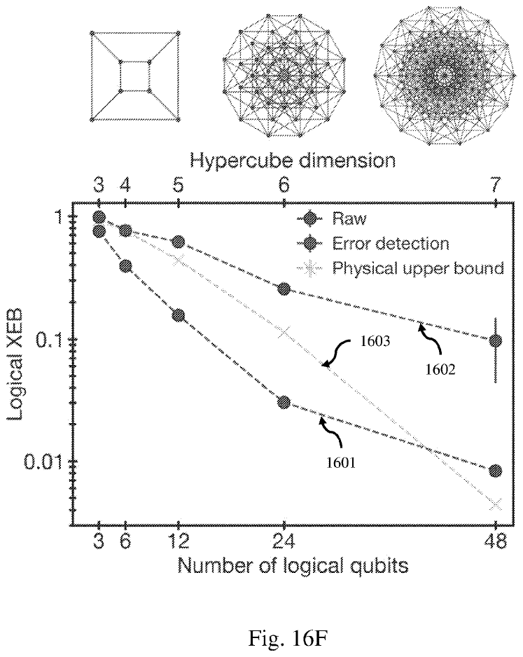

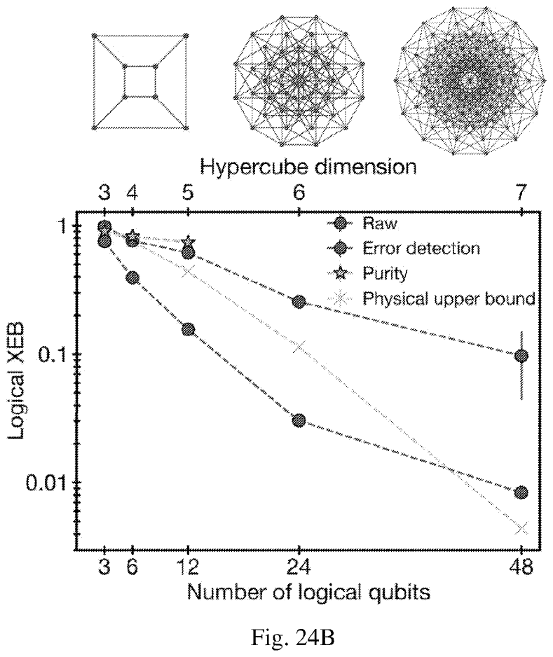

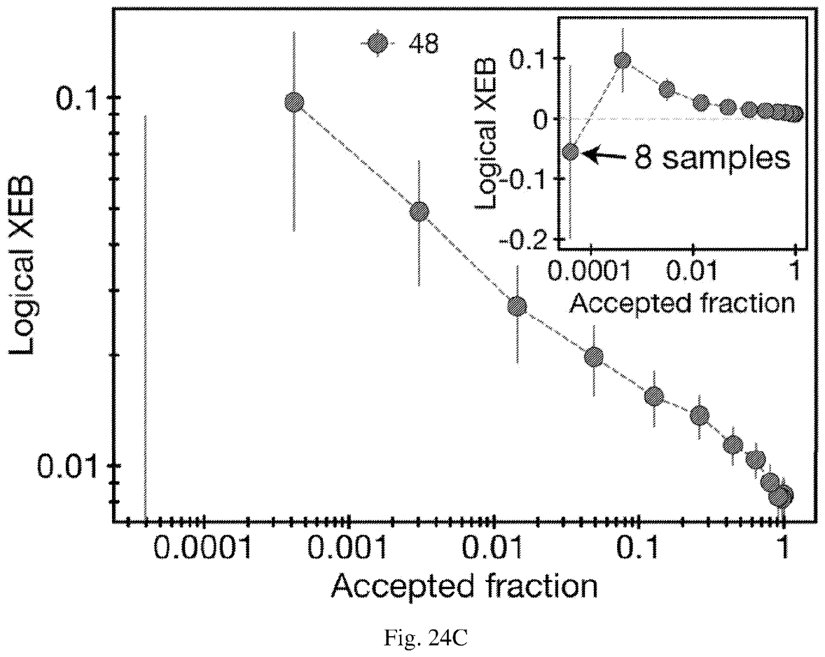

FIG. 16 illustrates complex logical circuits using 3D codes according to embodiments of the present disclosure. FIG. 16A depicts [[8,3,2]] block codes that can transversally realize {CCZ, CZ, Z, CNOT} gates within each block, and transversal CNOTs between blocks. By preparing logical qubits in |+_{L} [symbol] , performing layers of {CCZ, CZ, Z} alternated with interblock CNOTs, and measuring in the X-basis, classically hard sampling circuits are realized with logical qubits. FIG. 16B depicts measured sampling outcomes for a circuit with 12 logical qubits, 8 logical CZs, 12 logical CNOTs, and 8 logical CCZs. By increasing error detection, the measured distribution converges toward the ideal distribution. FIG. 16C depicts a circuit involving 48 logical qubits with 228 logical CZ/CNOT gates and 48 logical CCZs. FIG. 16D depicts a classical simulation runtime for calculating an individual bitstring probability; bottom plot is estimated based on matrix multiplication complexity. FIG. 16E depicts measured normalized XEB as a function of sliding-scale error-detection for 3, 6, 12, 24, and 48 logical qubits. For all sizes a finite XEB score is realized, which improves with increased error detection. The diagram shows 48-logical connectivity, with logical triplets entangled on a 4D hypercube. FIG. 16F depicts scaling of raw (1601) and fully error-detected (1602) XEB from FIG. 16E. Physical upper-bound fidelity (1603) is calculated using best measured physical gate fidelities (see below and FIG. 24 for scaling discussion). [[8,3,2]] cubes are entangled on 4D hypercubes, realizing physical connectivity of 7D hypercubes.

When using 2D codes such as the surface code, non-Clifford operations cannot be easily performed, and relatively expensive techniques are required for non-trivial computation as Clifford circuits can be easily simulated. In contrast, 3D codes can transversally realize non-Clifford operations, but lose the transversal H. However, these constraints do not imply that classically hard or useful quantum circuits cannot be realized transversally or efficiently. To address these constraints, the present disclosure provides efficient realization of classically hard algorithms that are co-designed with a particular error-correcting code. Specifically, fast scrambling circuits are provided using small 3D codes, which are used for native non-Clifford operations (CCZ).

Exemplary embodiments employ small 3-dimensional [[8,3,2]] codes (FIG. 16A), which have various appealing features. They encode three logicals per block, feature d=2 (d=4) in the Z basis (X basis), implying error detection (correction) capabilities for Z (X) errors, and can realize a transversal CNOT between blocks. By using physical {T, S} rotations

$$( T is \frac{π}{4} phase gate )$$

one can realize transversal {CCZ, CZ, Z}gates on the logical qubits encoded within each block, as well as intrablock CNOTs by physical permutation. This gate set allows transversal realization of the circuits illustrated in FIGS. 16A,C, alternating between layers of {CCZ, CZ, Z}within blocks and layers of CNOTs between blocks. Although transversal H is forbidden, initialization and measurement in either the X or Z basis effectively allows H at the beginning and end of the circuit.

These transversal operations allow realization of logical algorithms that are difficult to simulate classically. More specifically, these circuits can be mapped to Instantaneous Quantum Polynomial (IQP) circuits. Sampling from the output distribution of such circuits is known to be classically hard in certain instances, implying a quantum device can be exponentially faster than a classical computer for this task.

FIG. 16B shows an example implementation of a 12-logical-qubit sampling circuit. Here, all logical blocks are prepared in |+_{L} [symbol] , implement a scrambling circuit with 28 logical entangling gates, and then all logicals are measured in the X-basis. FIG. 16B shows the probability of observing each of the 2¹²=4096 possible logical bitstring outcomes, showing that as more error detection (postselection) is applied in postprocessing, the distribution more closely reproduces the ideal theoretical distribution. To characterize the distribution overlap, the cross-entropy benchmark (XEB) is used, which is a weighted sum between the measured probability distribution and the ideal calculated distribution, normalized such that XEB=1 corresponds to perfectly reproducing the ideal distribution, and XEB=0 corresponds to the uniform distribution which occurs when circuits are overwhelmed by noise.

Consistent with FIG. 16B, the 12-logical-qubit circuit XEB increases from 0.156(2) to 0.616(7) upon applying error detection (FIG. 16E). XEB is a good fidelity benchmark for IQP circuits.

Scaling is provided to larger systems and circuit depths. To ensure high complexity of logical circuits, nonlocal connections are used to entangle the logical triplets on up to 4D hypercube graphs, which results in fast scrambling. Exploring entangled systems of 3, 6, 12, 24, and 48 logical qubits, in all cases a finite XEB score is found that improves with increased error detection (FIGS. 16E,F). The finite XEB indicates successful sampling, and the improvement with error detection shows the benefit of using logical qubits. While this improvement comes at the cost of measurement time due to error detection, improving the sample quality cannot be replaced by simply generating more samples. Thus, improving the XEB score yields significant practical gains. An XEB of ≈0.1 is obtained for 48 logical qubits and hundreds of nonlocal logical entangling gates, up to roughly an order of magnitude higher than previous physical qubit implementations of similar complexity, showing the benefits of a logical encoding for this application.

Assuming the best measured physical fidelities, the estimated upper-bound for an optimized physical qubit implementation in this system is also significantly below the measured logical XEB (line 1603 in FIG. 16F). With small physical instances, values well below this upper-bound are measured. In addition to the error-detecting benefits, it appears that the logical circuit is significantly more tolerant to coherent errors, exhibiting an operation that is inherently digital, just with imperfect fidelity (see, e.g., FIG. 24A), consistent with theoretical predictions. For the logical algorithms, performance is optimized by optimizing the stabilizer expectation values (rather than the complex sampling output), providing further advantage for logical implementations.

The exemplary 48-logical circuit, corresponding to a physical qubit connectivity of a 7D hypercube, contains up to 228 logical two-qubit gates and 48 logical CCZ gates. Simulation of such logical circuits is challenging due to the high connectivity (rendering tensor networks inefficient) and large numbers of non-Cliffords. To benchmark the circuits, they are structured to leverage an efficient simulation method that takes ≈2 seconds to calculate the probability of each bitstring (FIG. 16D). Modeling noise in the logical circuits is even more complicated, as they are composed from 128 physical qubits and 384 T gates, thereby making experimentation with logical algorithms necessary to understand and optimize performance.

Quantum Simulations with Logical Qubits

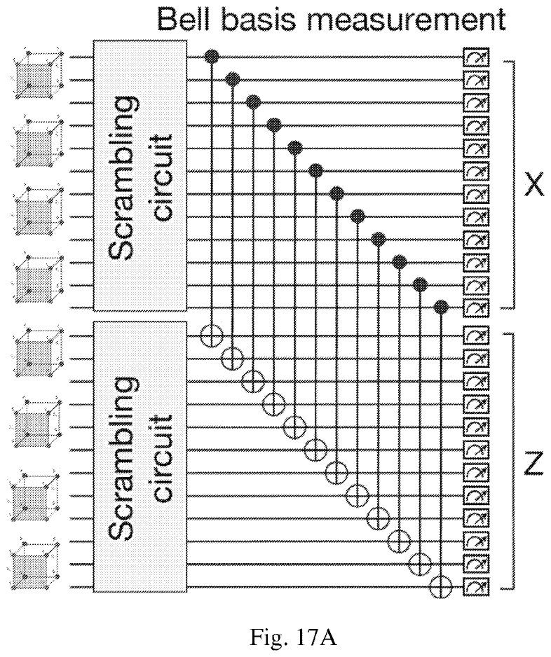

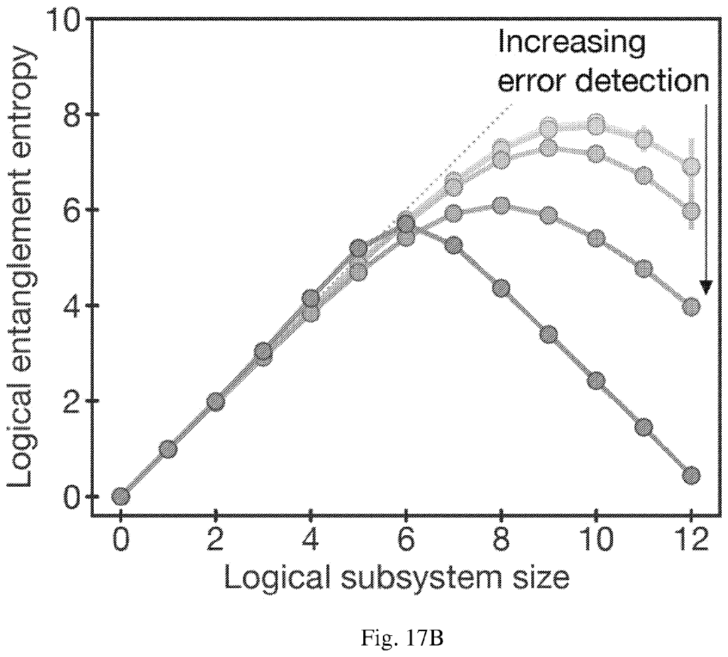

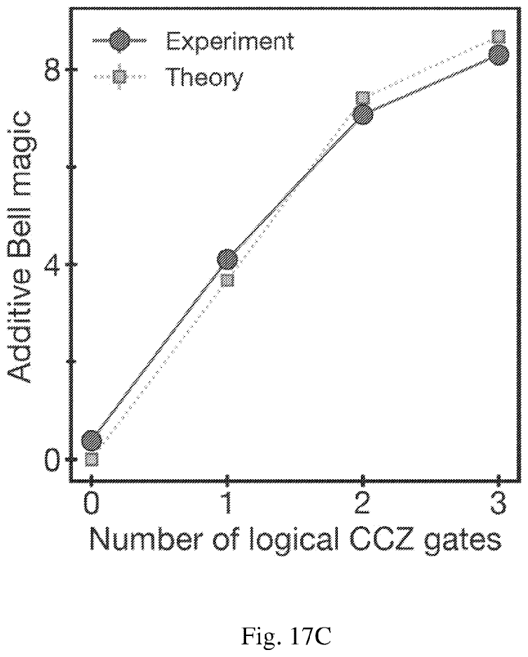

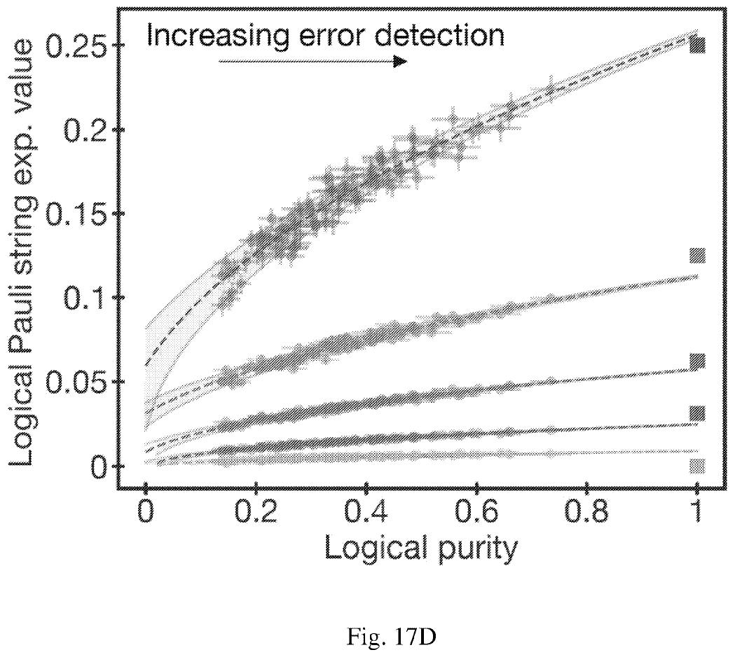

FIG. 17 illustrates logical two-copy measurement according to embodiments of the present disclosure. FIG. 17A depicts identical scrambling circuits performed on two copies of 12 logical qubits, and then measured in the Bell basis to extract information about the state. Z basis measurements are corrected with an [[8,3,2]] decoder (when full error detection is not applied). FIG. 17B depicts measured entanglement entropy as a function of subsystem size, showing expected Page-curve behavior for the highly scrambled state, improving with increased error detection. FIG. 17C depicts measured and simulated Bell magic (associated with non-Clifford operations) as a function of number of CCZ gates applied, performed on two copies of scrambled 6-logical-qubit systems. FIG. 17D depicts Pauli string measurement and zero-noise extrapolation using logical qubits. The plot shows the absolute values of all 4¹² Pauli string expectation values, which only have five discrete values for the digital circuit; Pauli strings with the same theory value are grouped. By analyzing with sliding-scale error detection, improvement is realized towards the theoretical expectation values (squares) while also improving toward a purity of 1. By extrapolating to perfect purity, the expectation values are extrapolated and the ideal values are better-approximated (shaded regions are statistical fit uncertainty).

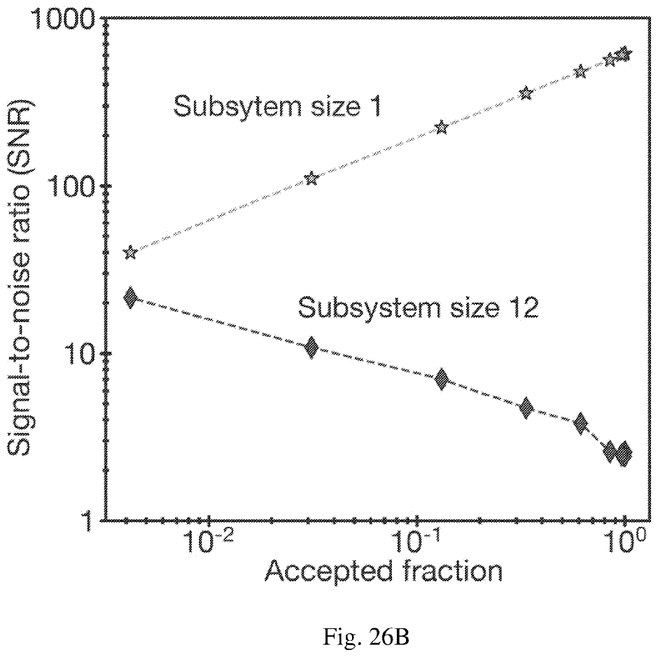

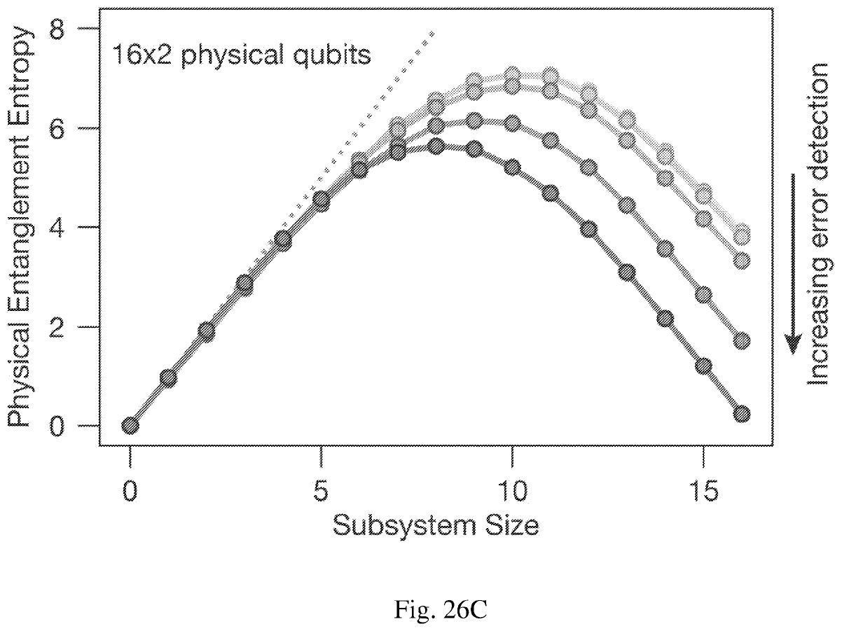

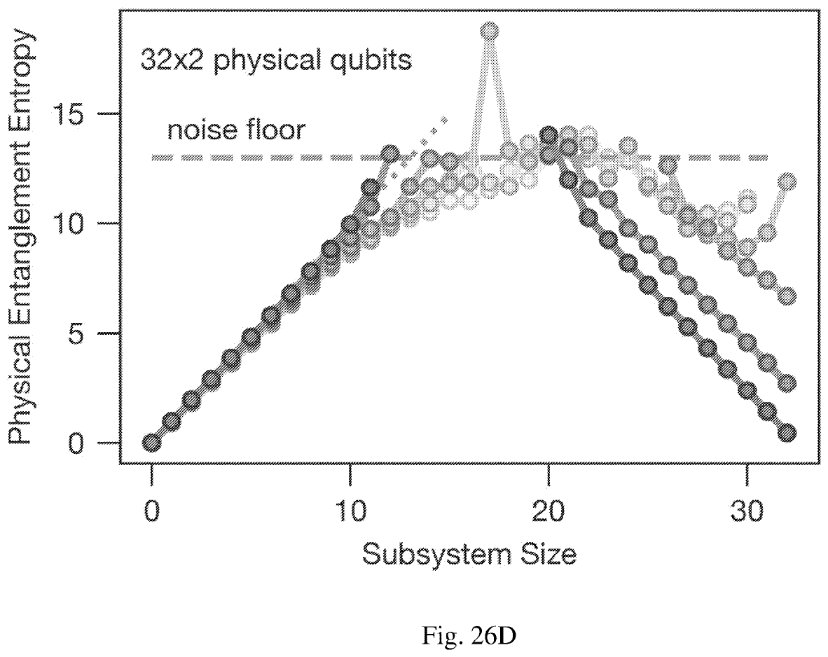

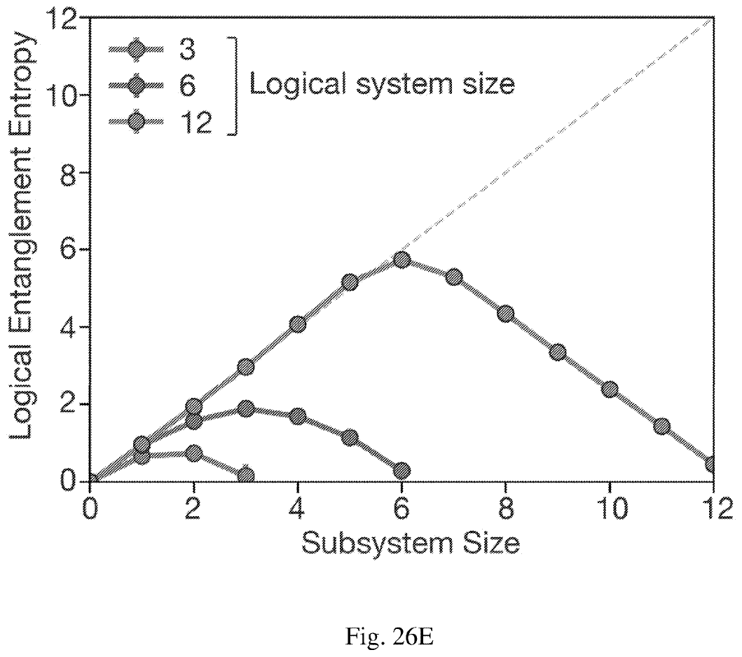

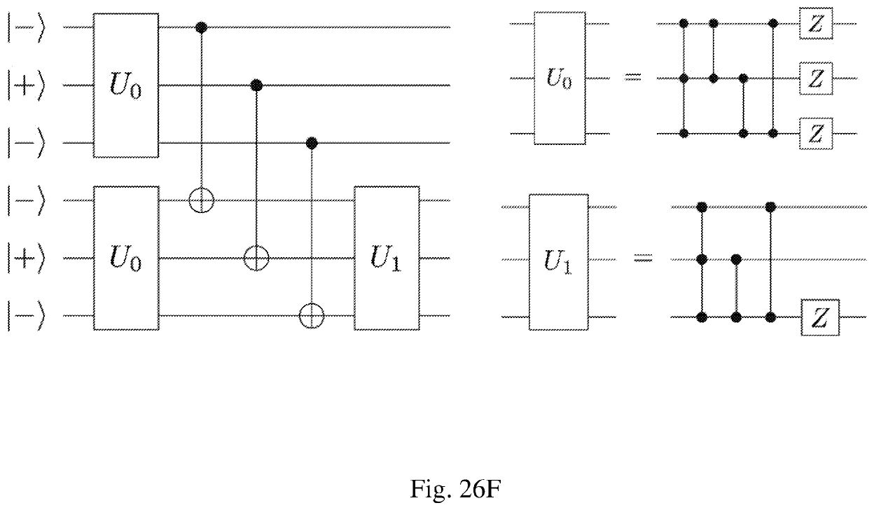

Logical qubits are also used as a tool in quantum simulation. In particular, a Bell-basis measurement made on two copies of the quantum state (FIG. 17A) is provided, which is a powerful tool that can efficiently extract many properties of an unknown state. With this two-copy technique, in FIG. 17B the measured entanglement entropy is plotted in the scrambled system. A characteristic Page curve associated with a maximally entangled, highly scrambled, but globally pure state is observed. These measurements also reveal a final state purity of 0.74(3), compared to the measured XEB of 0.616(7) in FIG. 16F, consistent with XEB being a good proxy for the final state fidelity. Despite postselection overhead, error detection significantly improves signal-to-noise here, as near-zero entropies are exponentially faster to measure (FIG. 26).

Two-copy measurements can also be used to simultaneously extract information about all 4^{N} Pauli strings. Using this property and an analysis technique known as Bell difference sampling, the amount of additive Bell magic in the circuits is experimentally evaluated and directly verified as a function of number of applied logical CCZs (FIG. 17C). This measurement of magic, associated with non-Clifford operations, quantifies the number of T gates (assuming decomposition into T) required to realize the quantum state by observing the probability that sampled Pauli strings commute with each other. Moreover, combining encoded qubits and two-copy measurement allows for additional error mitigation techniques. As an example, FIG. 17D shows the measured absolute expectation values of all 4¹² logical Pauli strings with sliding-scale error detection. In the two-copy measurements the overall system purity for each error detection threshold is measured, allowing extrapolation of the expectation values to the case of unit-purity (zero-noise). This procedure evaluates the averaged Pauli expectation values to ≈10% relative precision of the ideal theoretical values spanning several orders of magnitude.

### Exemplary System Overview

FIG. 18 illustrates a neutral atom quantum computer architecture according to embodiments of the present disclosure. FIG. 18A depicts an experimental layout, featuring optical tools including static SLM traps 1801 and 2D moving AOD traps 1802, global 1803 and local Raman single-qubit laser beams 1804, 420-nm 1805 and 1013-nm 1806 Rydberg beams, and imaging system for both global and local imaging. FIG. 18B depicts the level structure for ⁸⁷Rb atoms, with the relevant atomic transitions employed in this example.

FIG. 18C depicts a control infrastructure used for programming quantum circuits, featuring several arbitrary waveform generators (AWGs). In particular, the moving and Raman 2D AODs are each controlled by two waveforms 1807, 1808 and 1809, 1810 (one for x axis and one for y axis). An additional AWG is used in first-in-first-out (FIFO) mode for rearrangement before the circuit begins, and then the moving AOD control is switched to the Moving AWG. All AWGs (other than rearrangement AWG) are synchronized to <10 ns jitter. During Rydberg gates the traps are briefly pulsed off by a TTL. The FPGA processes images from the camera real-time and in this example sends control signals to the Raman 2D AOD for local single-qubit control.

FIG. 18D depicts an example array layout featuring entangling, storage, and readout zones. Zones can be directly reprogrammed and repositioned for different applications, as well as specific tweezer site locations. Tweezer beams and local Raman control are projected from out-of-plane. The entire objective field-of-view is 400-μm diameter, and consequently there is not substantial tweezer deformation near the edges of the processor. During two-qubit Rydberg gates, atoms are places ≲2 μm apart within a gate site, and gate sites are separated such that atoms in different gate sites are no closer than 10 μm during the gate. At n=53 and two-photon Rabi frequency of 4.6 MHz, the blockade radius is roughly 4.3 μm, such that adjacent atoms are well-within blockade and distant atoms are well-outside blockade.

To carry out the present experiments, several key features enable programmable quantum circuits on both physical and logical qubits. A cloud containing millions of cold ⁸⁷Rb atoms is loaded in a magneto-optical trap inside of a glass vacuum cell 1811, which are then loaded stochastically into programmable, static arrangements of 852-nm traps generated with a spatial light modulator (SLM) 1801, and then rearranged with a set of 850-nm moving traps generated by a pair of crossed acousto-optic deflectors (AODs, DTSX-400, AA Opto-Electronic) 1802 to realize defect-free arrays. Atoms are imaged with a 0.65-NA objective (Special Optics) 1812 onto a CMOS camera (Hamamatsu ORCA-Quest C15550-20UP) 1813, chosen for fast electronic readout times.

The qubit state is encoded in m_{F}=0 hyperfine clock states in the ⁸⁷Rb ground-state manifold, with T₂>1 s, and fast, high-fidelity single-qubit control is executed by two-photon Raman excitation (FIG. 18B). A global Raman path illuminating the entire array is used for global rotations (Rabi frequency ~1 MHz, resulting in ~1 μs rotations with composite pulse techniques) as well as for dynamical decoupling throughout the entire circuit (typically 1 global π pulse per movement). Fully programmable local single-qubit rotations are realized with the same Raman light but redirected through a local path which is focused onto targeted atoms by an additional set of 2D AODs 1814. Entangling gates (270-ns duration) between clock qubits are performed with fast two-photon excitation using 420-nm and 1013-nm Rydberg beams to n=53 Rydberg states, utilizing a time-optimal two-qubit gate pulse. During the computation, atoms are rearranged with the AOD traps to enable arbitrary connectivity. Mid-circuit readout is carried out by illuminating from the side with a locally focused 780-nm imaging beam 1815, with scattered photons collected on the CMOS 1813 and processed real-time by a field-programmable gate array 1816, FPGA (Xilinx ZCU102), with feedforward control signal outputs.

The quantum circuits are programmed with a control infrastructure consisting of five arbitrary waveform generators (AWG) (Spectrum Instrumentation), as illustrated in FIG. 18C, synchronized to <10 ns jitter. The 2-channel Rearrangement AWG is used for rearranging into defect-free arrangements before the circuit, the 1 channel of the Rydberg AWG is used for entangling gate pulses, the 4 channels of the Raman AWG are used for IQ (in-phase and quadrature) control of a 6.8 GHz source (the global phase reference for all qubits) and pulse-shaping of the global and local Raman driving, the 2 channels of the Raman AOD AWG are used for displaying tones that create the programmable light grids for local single-qubit control, and the 2 channels of the Moving AOD AWG are used for controlling the positions of all atoms during the circuit. AODs are central to the methods of efficient control, where the two voltage waveforms (one for X-axis and one for Y-axis) control many physical or logical qubits in parallel: each row and column of the grid simply corresponds to a single frequency tone, and these tones are then superimposed in the waveform delivered to the AOD (amplified by Minicircuits ZHL-5W-1+). The phase relationship between tones is chosen to minimize interference.

### Programming Circuits

Zone parameter choices. For simplicity, the entangling zone is fixed for each example described herein. This conveniently allows to switch between, e.g., surface code and [[8,3,2]] code experiments, without additional calibrations. The entangling zone profile, realized by 420-nm and 1013-nm Rydberg “tophat” beams generated by SLM phase profiles, is chosen to be homogeneous over a 35 μm tall region. As the Rydberg beams propagate longitudinally, the entangling zone is longer than it is tall. The tophats are optimized to be homogeneous over roughly 250 μm horizontal extent. Taller regions are also achievable, with a trade-off with reduced laser intensity and greater challenge in homogenization. The 250 μm width of the zones used here is set by the bandwidth of the AOD deflection efficiency. The readout zone is positioned on the other side of the storage zone to further minimize decoherence on entangling zone atoms.

During two-qubit Rydberg (n=53) gates, atoms are placed ≲2 μm apart within a “gate site”, resulting in ≳450 MHz interaction strength between pairs, significantly larger than the Rabi frequency of 4.6 MHz. Due to the use of the Rydberg blockade, the gate is largely independent of the exact distance between atoms. Hence, precise inter-atom positioning is not required. Gate sites are separated such that atoms in different gate sites are no closer than 10 μm during the gate, resulting in negligible long-range interactions. Throughout this example, 4 gate sites are provided vertically (5 for the surface code experiment) and 20 horizontally, performing gates on as many as 160 qubits simultaneously (see FIG. 18D). Under various conditions, with proper calibration, two-qubit gate fidelities in the range F=99.3%-99.5% are measured. No error is observed on storage-zone atoms when Rydberg gates are executed in the entangling zone. Even though the tail of the tophat Rydberg excitation beams is only suppressed to ~0.1× intensity, the two-photon drive is far off-resonant due to the ~20 MHz 1013 light shift detuning which is present for the entangling zone atoms. Physical CZ gates are natively realized; when implementing CNOTs physical H gates are added. Minimal two-qubit cross-talk is found between gate sites, as probed with long benchmarking sequences. Although there may be some small cross-talk seemingly originating from decay into Rydberg P states, this should be considerably suppressed in practical operations here due to the ~200 μs duration between gates, during which time Rydberg atoms should either fly away or decay back to the ground state.

Shuttling and transfers. In exemplary embodiments, the SLM tweezers can have arbitrary positions, but are static. The AOD tweezers are mobile, but have several constraints. In particular, the AOD array creates rectangular grids (but not all sites need to be filled). During the atom moving operations, they are only used for stretches, compressions, and translations of the AOD trap array: atoms move in rows and columns, and rows and columns never cross. Arbitrary qubit motions and permutations are achieved by shuttling atoms around in AOD tweezers, and then transferring atoms between AOD and SLM tweezers as appropriate. Gates are performed on pairs of atoms in both AOD-AOD traps and AOD-SLM traps, with no observed difference for gate performance, as measured by randomized benchmarking.

Free-space shuttling of atoms (without transfers) in AOD tweezers comes essentially with no fidelity cost (other than time overhead). In various embodiments, a photodiode is used to calibrate and homogenize the 2D deflection efficiency of the 2D AODs to percent-level homogeneity across the used region. Atomic trajectories and echo sequences are engineered to cancel out residual path-dependent inhomogeneities. For example, an atom can be moved 100 μm away to realize a distant entangling gate, and then before returning the atom, a Raman π pulse is performed, so that differential light shifts accumulated during the return trip cancel with the first trip. Motion is realized with a cubic profile, the characteristic free-space movement time between gates is roughly 200 μs, and acoustic lensing effects from the AOD are estimated to be negligible. The 1013 laser is pulsed off during motion to remove loss effects from the large light shifts. Note that the 1013-induced differential light shift on the hyperfine qubit is only kHz-scale, but its effects are echoed out.

Transferring atoms between tweezers presents additional challenges. The infidelity of each transfer, encompassing both dephasing and loss, is measured to be ≲0.1%. To achieve this performance, in the transfer from SLM to AOD, the AOD tones' intensity is ramped up (with a quadratic intensity profile when possible) corresponding to the appropriate sites over a time of 100-200 μs to a trap depth~2× larger than the SLM trap depth, and then the AOD trap is moved 1-2 μm away over a time of 50-100 μs.

During subsequent motion, the AOD trap depth is left at this 2× value. To transfer an atom from an AOD to an SLM the reverse process is performed. During these transfer processes, the differential light shifts on the transferred atoms are dynamically changing, and can result in large unechoed phase shifts. As such, circuits are engineered such that pairs of transfers will echo with appropriately chosen TC pulses. When echoing pairs of transfers is not possible, 1 cycle of XY4 or XY8 dynamical decoupling is performed during the transfer. Low-loss transfer is highly sensitive to alignment of the AOD and SLM grid. Small optical distortions between the AOD and SLM tweezer grids are fixed by fine adjustment of individual SLM grid tweezers, which can be arbitrarily positioned, to overlap with the AOD traps as seen on an image plane reference camera. It is important to adjust the SLM and not the AOD, as small adjustments of individual AOD tones deviating from a frequency comb causes beating and atom loss.

Dynamical decoupling and local gates. In an exemplary circuit design, the echo sequences are engineered in order to cancel out as many deleterious aspects as possible. The dynamical decoupling has an odd number of π pulses between CZ gates (whenever possible), as this echoes out both systematic and spurious contributions to the single-qubit phase. Appropriate X(π) and Z(π) rotations are applied between local addressing with the local Raman to cancel out errors induced by the global

$$\frac{π}{2}$$

pulses, as well as between pulses of the 420-nm laser (when used for entangling zone single-qubit rotations) to echo out small crosstalk experienced in the storage zone by the tail of the 420-nm beam. For global decoupling pulses, both BB1 pulses and “SCROFULOUS” pulses are used. To benchmark and optimize coherence during complex circuits, a Ramsey fringe measurement is performed encompassing the entire movement and single-qubit gate sequence and optimize the observed contrast. Total single-qubit error is consistent with SPAM, an effective coherence time of 1-2 s, and the Raman scattering error of all the Raman pulses. These measured coherence times include the movement within and between zones; although fewer pulses are used (typically 1 per movement) than the XY16-128 sequence used to benchmark 1.5 s coherence, the coherence times here are naturally longer due to further-detuned tweezers used (852 nm rather than 830 nm.

Local single-qubit gates with the Raman AOD are realized in arbitrary positions in space on both AOD and SLM atoms. Targeted logical qubit blocks are addressed by a grid illumination of the logical block. Arbitrary patterns of rotations on the qubit grid (e.g., during color code preparation) are realized with row-by-row serializing, with the targeted x coordinates in each row simultaneously illuminated. The duration of each row is 5-8 μs (several 10 s of μs for an arbitrary pattern of rotations), which can be sped up considerably as discussed in the next section. For simplicity, rotations are calibrated on 80-160 specific sites across the array, and rotations are performed in arbitrary spots utilizing the nearest calibrated values.

With the local single-qubit gates and entangling zone two-qubit gates calibrated, the entire circuit is defined by the appropriate trapping SLM phase profile, and waveforms for the several AWG channels and TTL pulse generator. These several channels then program complex, varied circuits on hundreds of physical qubits.

### Programmable Single-Qubit Gates

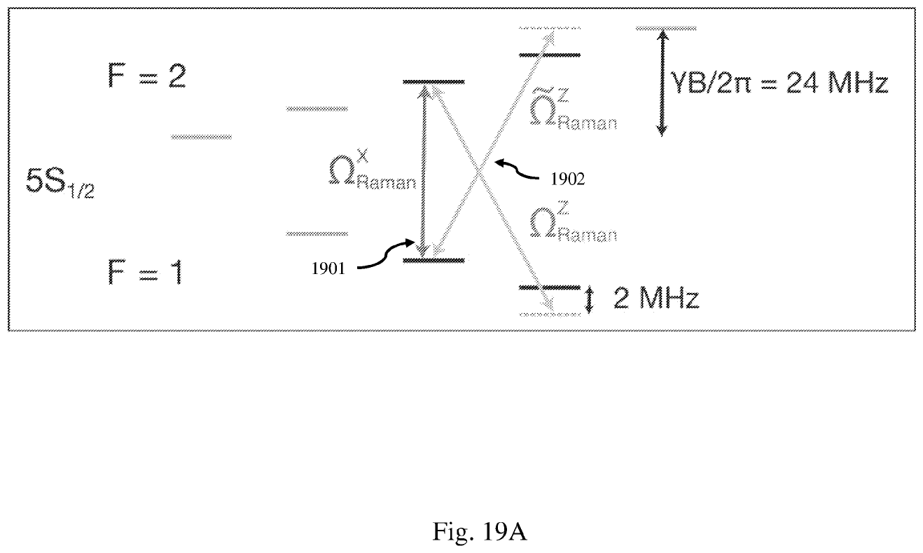

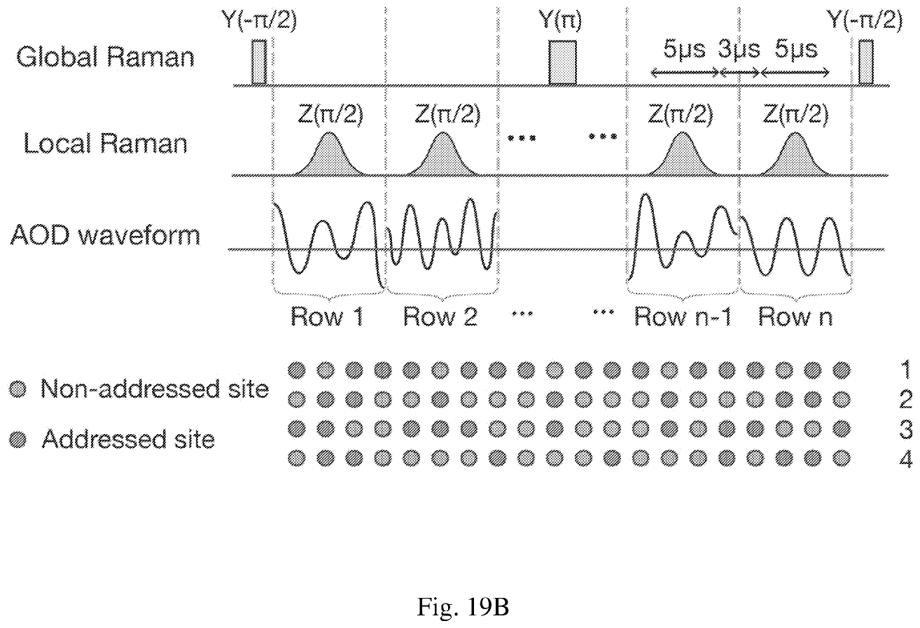

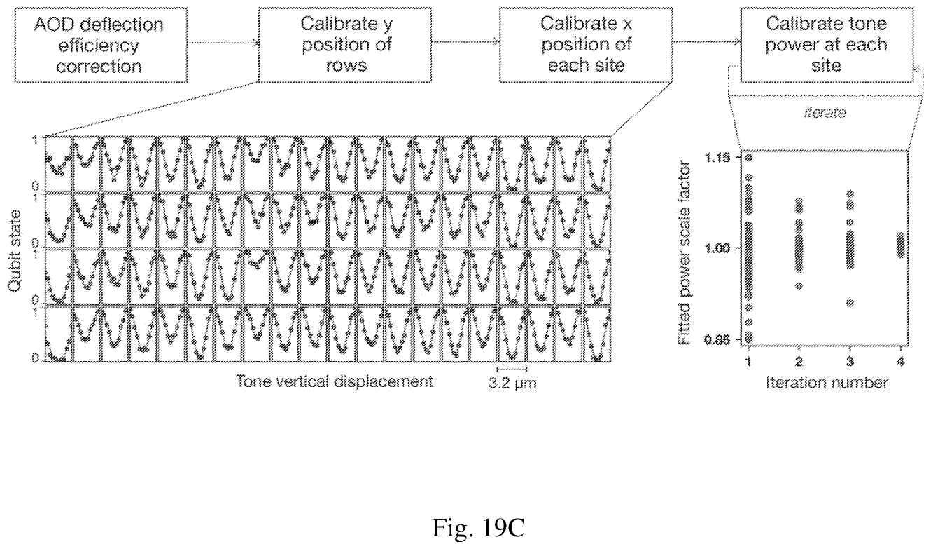

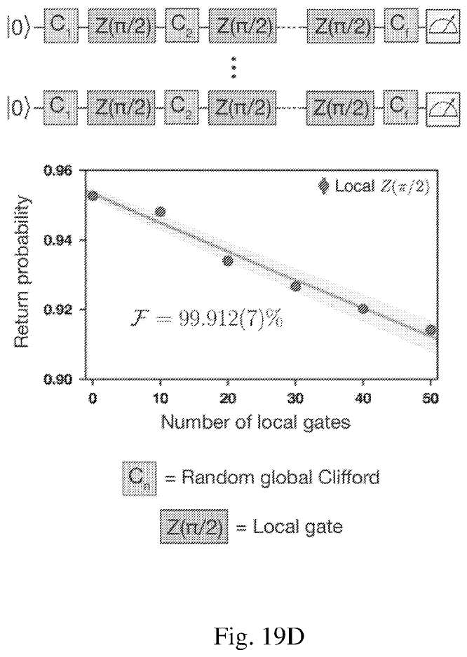

FIG. 19 illustrates single-qubit Raman addressing according to embodiments of the present disclosure. FIG. 19A depicts a

$$5 {S}_{\frac{1}{2}}$$

hyperfine level diagram illustrating the two possible implementations of local single-qubit gates: resonant X(θ) (1901) and off-resonant Z(θ) (1902) rotations with two-photon Rabi frequencies Ω_{Raman}. In this example, the Z rotation scheme is used and rotations are blue-detuned by 2-MHz from the two-photon resonance. Due to Clebsch-Gordan coefficients,

$${\tilde{Ω}}_{R a m a n}^{Z} = - \sqrt{3} {Ω}_{R a m a n}^{Z} .$$

FIG. 19B depicts a schematic showing the conversion of local

$$Z ( \frac{π}{2} )$$

into local

$$X ( \pm \frac{π}{2} )$$

gates, where the pulses before (after) the central Y(π) have positive (negative) sign, while leaving non-addressed qubit states unchanged. The Gaussian-smoothed local pulses have duration 2.5 μs for π/4 pulses and 5 μs for π/2 pulses, and are performed on single rows at a time with a 3 μs gap between subsequent gates to allow the RF tones in the AODs to be changed (including this gap, duration is 5-8 μs per row). In this way, arbitrary patterns of qubits, such as the example drawn, can be addressed.

FIG. 19C depicts a calibration procedure used to homogenize the Rabi frequency over a 220 μm×35 μm array. The position calibration is illustrated for 80 sites: approximate

$$X ( \frac{π}{2} )$$

gates are locally performed and the horizontal/vertical position of all tones is scanned in parallel such that a Gaussian fit returns the optimal alignment. After this, powers are iteratively calibrated until the fitted scale factors for the individual RF tones converge to unity. FIG. 19D depicts a single-qubit randomized benchmarking of local

$$Z ( \frac{π}{2} )$$

gates. The local gates are interleaved with random global single-qubit Clifford gates and the final operation C_{f} is chosen to return to the initial state. Each data point is the average of 100 random sets of Clifford gates, and fitting an exponential decay to the return probability quantifies the fidelity [symbol] per local gate. All 51 global Clifford gates are applied for each data point, such that errors from the global Clifford gates (in addition to SPAM errors) do not contribute to the fitted value.

To enable individual single-qubit gates, the same Raman laser system is used as in the global rotation scheme to illuminate only chosen atoms using a pair of crossed AODs. The focused beam waist in the plane of the atoms is 1.9 μm, which is large enough to be robust to fluctuations in atomic positions, and small enough to prevent cross-talk to neighboring atoms separated by ≳6 μm. For Raman excitation, polarization needs to be carefully considered. Unlike the global path, the local beam propagation direction is perpendicular to the atom quantization axis (set by the external magnetic field). Therefore the fictitious magnetic field \vec{B}_{fict} responsible for driving the transitions, preferentially drives σ^{±} hyperfine transitions rather than the desired π clock transition. There exist two possible approaches to single-qubit gates, as illustrated in FIG. 19A. First, off-resonant σ^{±} dressing generates differential light shifts between qubit states enabling fast local Z(θ) gates. Global

$$\frac{π}{2}$$

rotations convert these to local X(θ) gates. Second, one can directly apply local X(θ) gates with direct π transitions by slightly rotating the quantization axis towards the local beam direction; this could be achieved with an external field but, conveniently, \vec{B}_{fict} has a DC component that naturally rotates the axis. If the local beam is quickly turned on, this same fictitious DC field causes leakage out of the m_{F}=0 subspace, therefore Gaussian-smoothed pulses are used throughout this example.

Although both the π and σ^{±} versions are realized above, in the present example the off-resonant σ^{±} dressing procedure is used due to reduced polarization sensitivity, since the polarization homogeneity was affected by the sharp wavelength edge of a dichroic after the AOD. Furthermore, as for most circuits local rotations are performed row-by-row (only 1 Y tone at a time); this enables arbitrary fine-tuning of X coordinates and powers at each site for homogenizing and calibrating rotations FIG. 19B). Calibration is performed using the procedure in FIG. 19C and these calibrations are stable on month timescales.

To quantify the fidelity, randomized benchmarking is performed using 0, 10, 20, 30, 40, and 50 local

$$Z ( \frac{π}{2} )$$

rotations (per site) on 16 sites, obtaining [symbol] =99.912(7)% as shown in FIG. 19D (the single-qubit gates executed globally have fidelity closer to 99.99%). This approaches the Raman scattering limit for the σ^{±} scheme

$$( error of \text{∼} 7 \times 1 {0}^{- 4} per \frac{π}{2} pulse ) ,$$

but, when not well-calibrated, is limited by inhomogeneity, in particular, associated with distortions of the y position of the rows. The performance can be further improved in some embodiments by using X(θ) gates, which enables robust composite sequences such as BB1, and has an improved Raman scattering contribution, and is faster (~1 μs duration).

### Midcircuit Readout and Feedforward

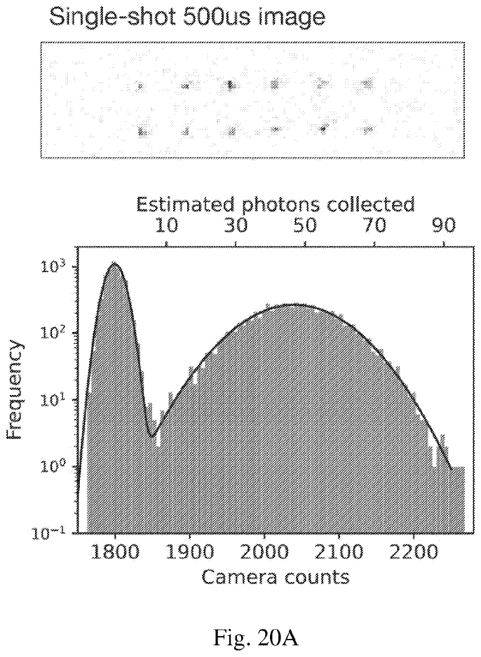

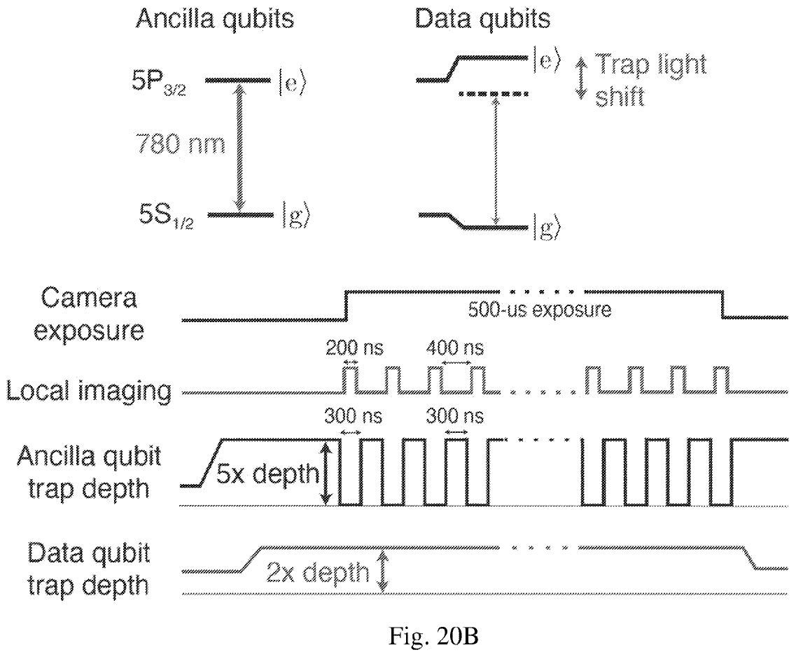

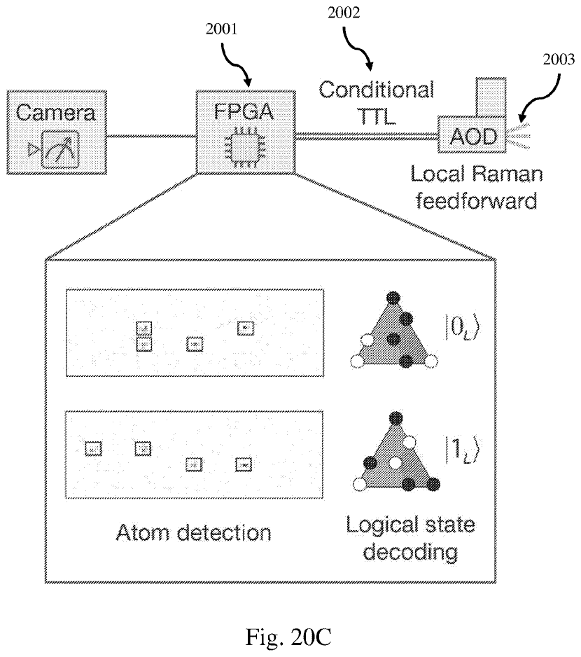

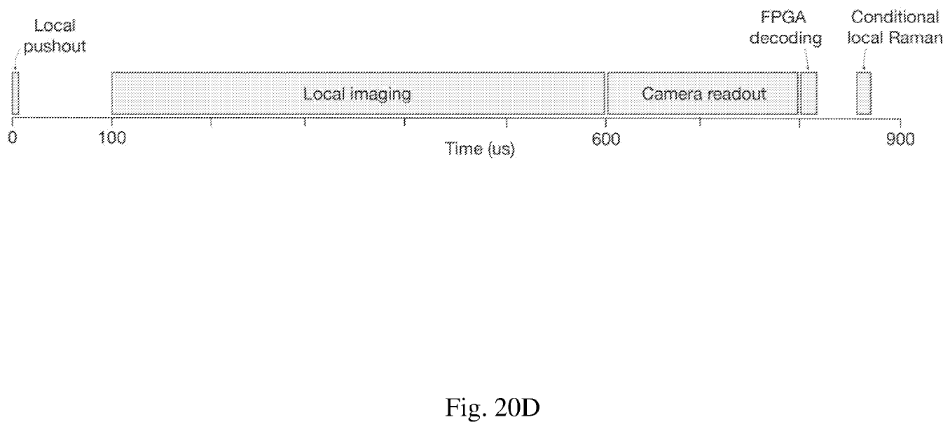

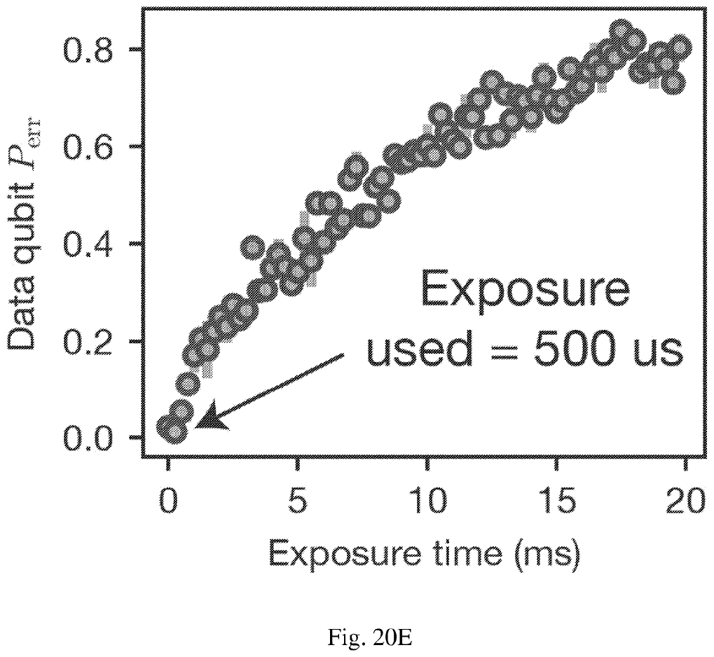

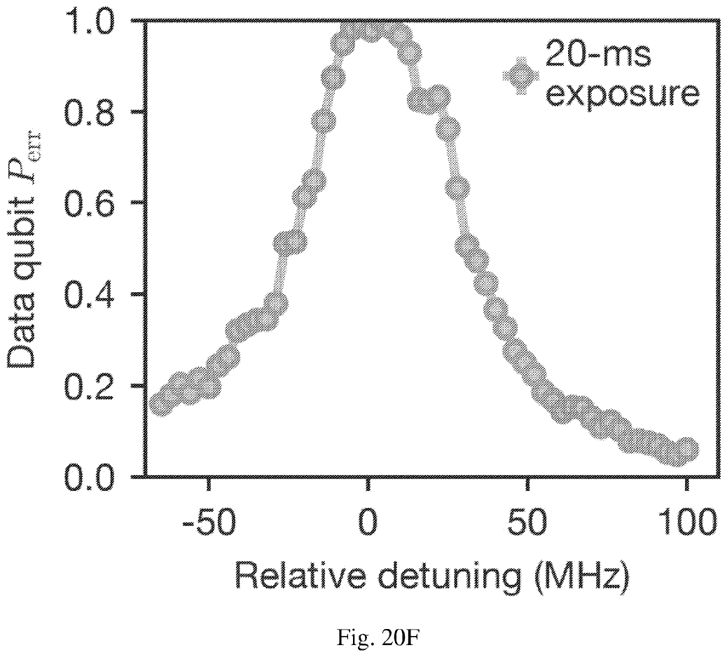

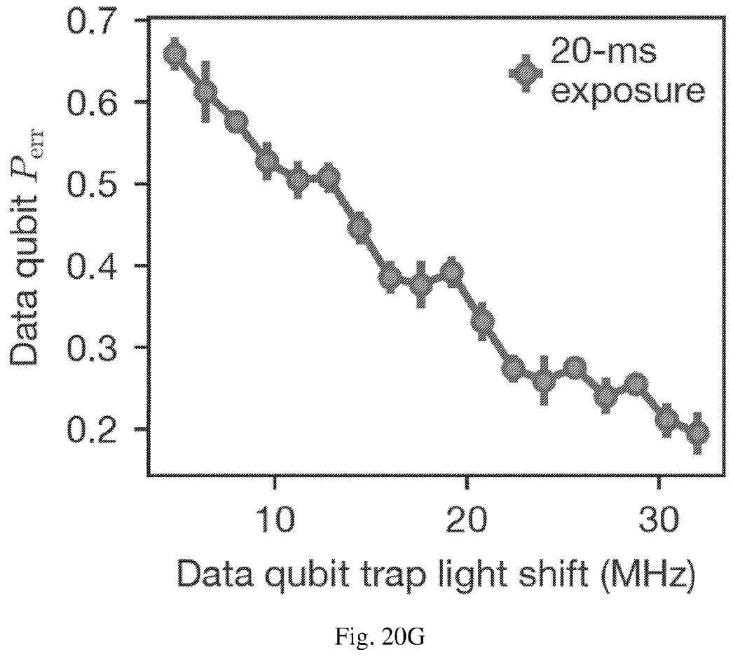

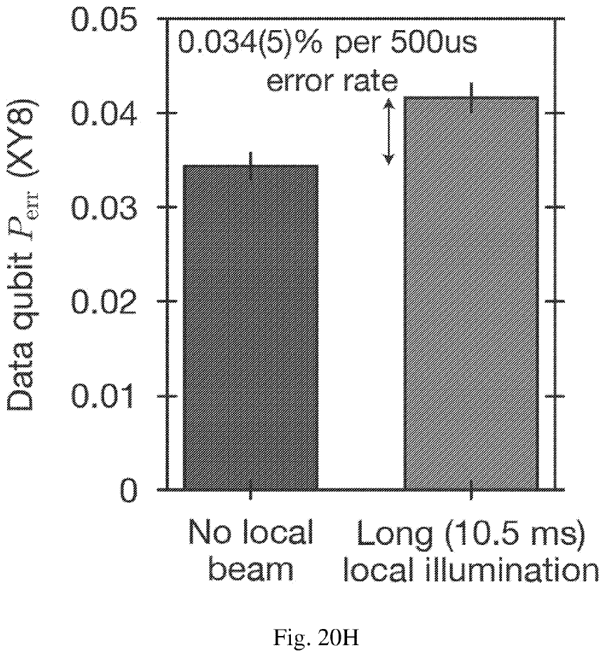

FIG. 20 illustrates midcircuit readout and feedforward according to embodiments of the present disclosure. FIG. 20A depicts single-shot 500 μs local image in the readout zone, where the peak corresponds to roughly 50 photons collected by the CMOS camera. FIG. 20B depicts an atomic transition and pulse sequence used for local imaging of ancilla qubits. The data qubit trap light shift suppresses data qubit errors, in addition to the large spatial separation between entangling and readout zones. Losing the readout zone atoms during local imaging is avoided by using a 5× higher trap depth, and the ancilla qubit traps and local imaging light are pulsed to image directly on resonance while avoiding negative effects of large trap light shifts.

FIG. 20C is a diagram of components involved in midcircuit readout and feedforward steps. Atom detection and logical state decoding occur using the FPGA 2001, which then outputs a conditional TTL 2002 to gate local Raman pulses 2003 performed on logical qubits in the entangling zone. FIG. 20D is a diagram of approximate timings for a midcircuit feedforward cycle. First, F=2 population is pushed out (in 10 μs), and then the remaining F=1 population is imaged locally for 500 μs. The 24 rows of pixels covering the readout zone are read out to the FPGA in 200 μs, after which processing is performed. Finally, a conditional TTL output based on the decoded state gates on or off local Raman pulses. The whole readout and feedforward cycle takes less than 1 ms, and can be sped up by optimizing local imaging and camera readout.

FIGS. 20E-G depict characterization of error probability of data qubits during local imaging. FIG. 20E depicts data qubit error probability (fraction of population depumped from F=2 to F=1) as a function of local imaging duration out to 20 ms to quantify the effect of the local imaging beam on data qubit coherence for very long illumination. FIG. 20F depicts data qubit error probability after 20 ms of local imaging, as a function of detuning of the local imaging beam, showing suppression of error both red- or blue-detuned from the data qubit transition. FIG. 20G shows that, equivalently, increasing the trap depth of the data qubits enables suppression of decoherence due to the local imaging beam. Since qubits in the readout zone are imaged while their traps are pulsed off, any light shift of the data qubit transition from the traps contributes directly to the relative detuning. FIG. 20H shows that for a long 10.5 ms local beam illumination with optimal local imaging parameters, a 0.7(1)% increase in data qubit error is observed during an XY8 dynamical decoupling sequence. This suggests a roughly 0.034(5)% error probability for the data qubits during the 500 μs midcircuit readout image employed in this example.

To perform midcircuit readout of selected qubits without affecting the others, a local imaging beam is focused on the readout zone which is roughly 100 μm spatially separated from the entangling zone. The local imaging beam consists of 780-nm circularly polarized light, with a near-resonant component from F=2 to F′=3 and a small repump component. This beam is sent through the side of the glass vacuum cell, co-propagating with the global Raman and 1013-nm Rydberg beams (FIG. 19A). Cylindrical lenses are used to shape the beam with focused beam waists of 30 μm in the plane of the atom array and 80 μm out of the plane. After moving some of the atoms to this readout zone, local pushout is performed of population in the F=2 ground state manifold (by turning off the repump laser frequency), followed by local imaging of the remaining F=1 population.

As depicted in FIG. 20A, an average of about 50 photons are collected per imaged atom. To avoid losing the atoms too quickly during mid-circuit imaging (which, unlike in the global imaging scheme, does not have multi-axis cooling), deep (roughly 5-mK) traps are used (helping retain the atoms), and they are stroboscopically pulsed on and off out of phase of the local imaging light to avoid deleterious effects of the deep traps such as inhomogeneous light shifts and fluctuating dipole force heating (FIG. 20B). From a double-Gaussian fit to the two distributions in FIG. 14A, an imaging fidelity of over 99.9% is extracted. Because this fit can lead to an overestimate of the imaging fidelity (for example due to atom loss during imaging), the total SPAM error (measured by amplitude of Ramsey fringe) is compared with local imaging versus with global imaging for the same state preparation sequence, extracting 0.14(5)% higher error with local imaging; with these considerations a local imaging fidelity of around 99.8% is estimated.

A number of design considerations facilitate local imaging in the readout zone while preserving coherence of the data qubits in the entangling zone (FIG. 20E-G). The main sources of decoherence are rescattering of photons from the locally imaged atoms as well as beam reflections and tails of the local imaging beam hitting the data qubits. As shown in FIG. 12C, for the 500 μs midcircuit imaging used in this work, unchanged coherence (identical within the errorbars) of the data qubits is achieved with the local imaging light on as without it. To understand these effects more quantitatively, the error probability of the data qubits in the entangling zone is measured while the local imaging beam is on in the readout zone for up to 20 ms and with higher intensities than used for local imaging in this work. Decoherence is suppressed by light shifting the data qubits' 780-nm transition to be different from that of the locally imaged qubits by several 10s of MHz, as studied in FIG. 20F-G. Data qubit decoherence is further suppressed by the large spatial separation between the readout zone and the entangling zone, where intensity from the local imaging beam's Gaussian tail falls off rapidly. Even at large separations, stray beam reflections (e.g., from the glass cell window and other optical elements) can hit the data qubit region. To mitigate this effect, reflections are displaced away from the atom array by angling the local imaging beam as it hits the glass cell window. The estimated effects of re-scattered photons from the imaged atoms, especially with the added relative detuning, is negligible. With all these considerations, data qubit decoherence rates are suppressed to ≲0.1% per 500 μs of local imaging exposure, as illustrated in FIG. 20H.

The full mid-circuit readout and feedforward cycle occurs in slightly less than 1 ms, including local pushout, local imaging, readout of the camera pixels, decoding of the logical qubit state on the FPGA, and a local Raman pulse which is gated on or off by a conditional trigger (FIG. 20D). This approach to midcircuit readout and feedforward can be modified to enable mid-circuit readout close to 100 μs scale. This method can directly be extended to perform many rounds of measurement and feedforward, where groups of ancilla atoms are consecutively brought to the readout zone throughout a deep quantum circuit.

FIG. 21 illustrates additional surface code data. FIG. 21A is a depiction of Bell state circuit and d=7 surface codes. FIG. 21B is a diagram showing the transversal CNOT and physical error propagation rules. FIG. 21C depicts the covariance of the 48 measured stabilizers in both bases. The correlations near the diagonal correspond to adjacent stabilizers within each block. Strong correlations are also observed with the stabilizers of the other block due to the error propagation in the transversal CNOT. FIG. 21D depicts Bell pair infidelity upper bound (as opposed to estimated Bell pair error in FIG. 13D), showing improvement with increasing code distance. FIG. 21E depicts probability of no detected error for each of the 96 measured stabilizers, showing agreement when compared to the theoretical values from empirically chosen error rates (experiment average=77%, theory average=82%). Note that X basis logical 1 and Z basis logical 2 have higher stabilizer error probability due to the error propagation in the transversal CNOT (reducing expectation values relative to if the transversal CNOT is not performed). Using the empirical error rates that correspond to data-theory agreement for the measured stabilizers in FIG. 13E, simulations for improvement in Bell pair error, as a function of code distance, are in good agreement with experiments (as shown in FIG. 13F). The empirical error rates used are consistent with the 99.3% two-qubit gate fidelity, measured for this larger array, as well as the roughly 4% data qubit decoherence error (integrated over the entire circuit and measured by Ramsey method). These dephasing error rates are dominated by a complex moving sequence during preparation of the two surface codes in a serial fashion, and would be significantly smaller for a repetitive error correction experiment.

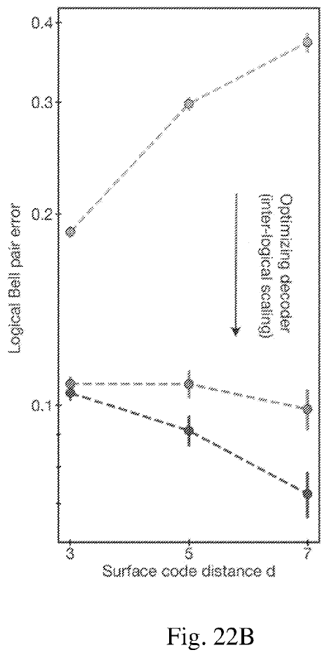

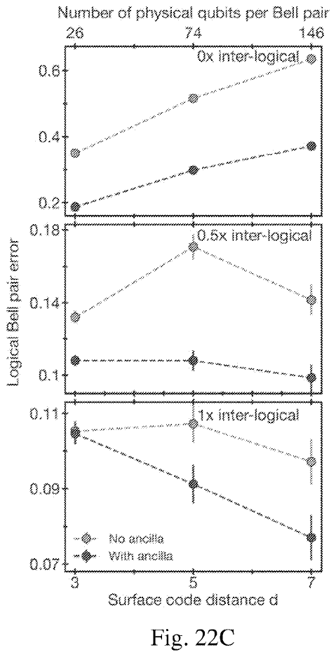

FIG. 22 illustrates surface code preparation and decoding data according to embodiments of the present disclosure. FIG. 22A depicts surface code stabilizers for the two independent d=7 codes following state preparation. The entire movement circuit corresponding to the transversal CNOT is implemented, and the transversal entangling gate pulse is turned off. The mean stabilizer probability of success across the 96 total stabilizers is 83%. The high probability of stabilizer success of the two independent codes in both the X and Z bases shows that topological surface codes were prepared (and FIG. 21 shows that they were preserved during the transversal CNOT). Physical fidelities were slightly lower during this measurement due to calibration drift and so these results slightly underestimate performance relative to the data in FIG. 13 and FIG. 21. FIG. 22B depicts logical Bell pair error while optimizing the decoder by (inversely) scaling the weights of the inter-logical edges and hyperedges that connect the stabilizers of the two logical qubits (higher values correspond to lower pairing weights). More concretely, the probability p of the error mechanism corresponding to the inter-logical edges/hyperedges is scaled and the weights are calculated as

$$log ( \frac{( 1 - p )}{p} ) .$$

Qualitatively, optimizing this scaling value optimizes with respect to the probability that errors are before or after the transversal CNOT, as errors before the CNOT will lead to correlations between the two logical qubits, corresponding to the inter-logical edges. As the decoder is optimized by tuning the inter-logical scaling factor, the performance for all three code distances improves, and the larger code distances improve faster when approaching the optimal decoding configuration. This data is consistent with the decoder being properly optimized for all three code distances, consistent with the fact that the improvement with code size does not originate from suboptimal decoder performance for low distance. The y-axis is log-scale. FIG. 22C depicts logical Bell pair error when using (black) and not using (gray) the ancilla stabilizer measurement values, as a function of the scaling of the inter-logical edges and hyperedges that connect the stabilizers of the two logical qubits. The ancilla measurements contribute to the correction procedure, and contribute more for smaller values of the inter-logical scaling as they correspond to errors that happen before the transversal CNOT. 0× inter-logical scaling corresponds to conventional decoding within the two independent surface codes. For the 1× inter-logical scaling plotted here, the d=7 inter-logical scaling parameter is chosen to be slightly different than in FIG. 13D in order to have consistency across the three code distances (which produces measured values within errorbars).

### [[8,3,2]] Circuit Implementation

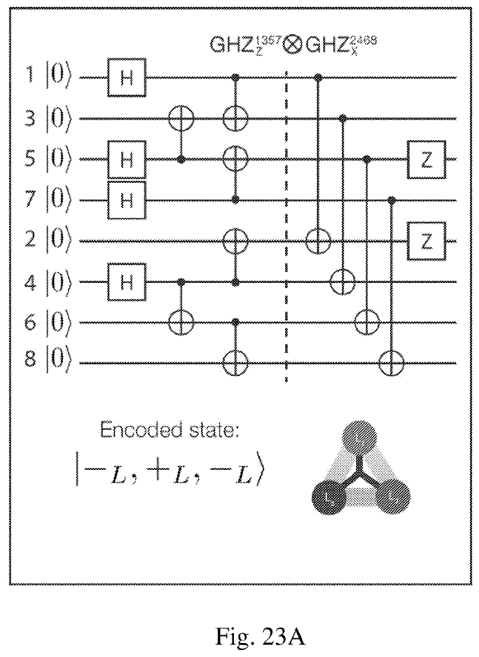

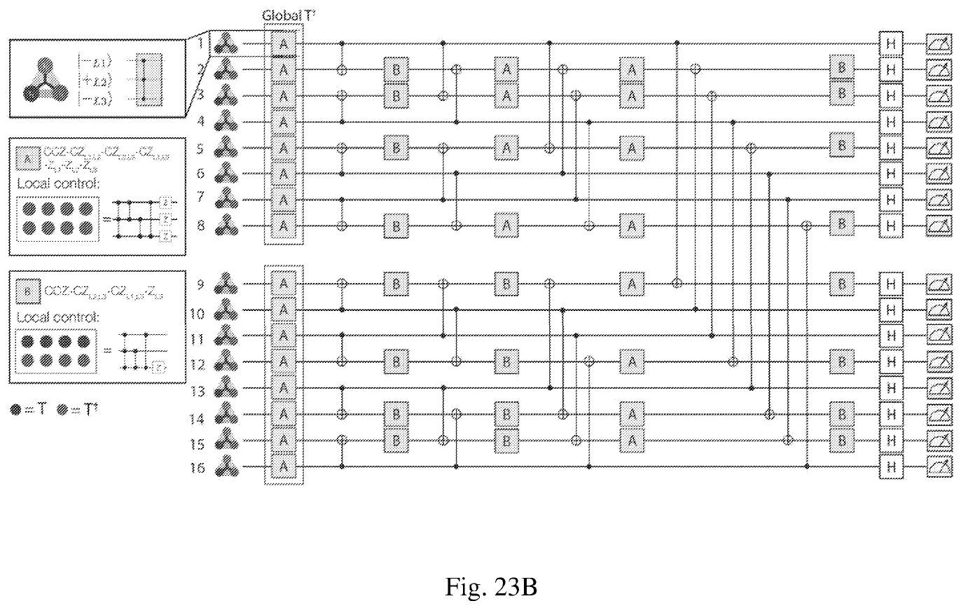

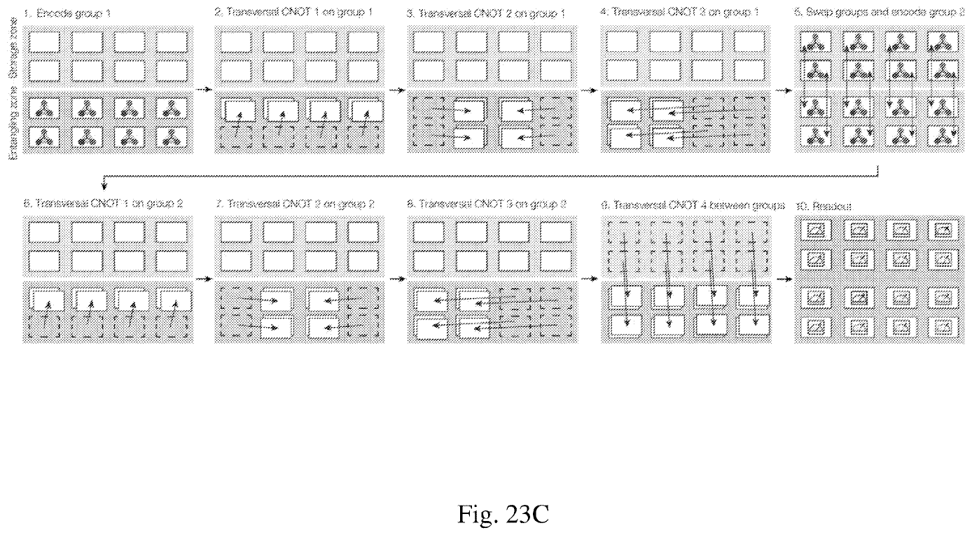

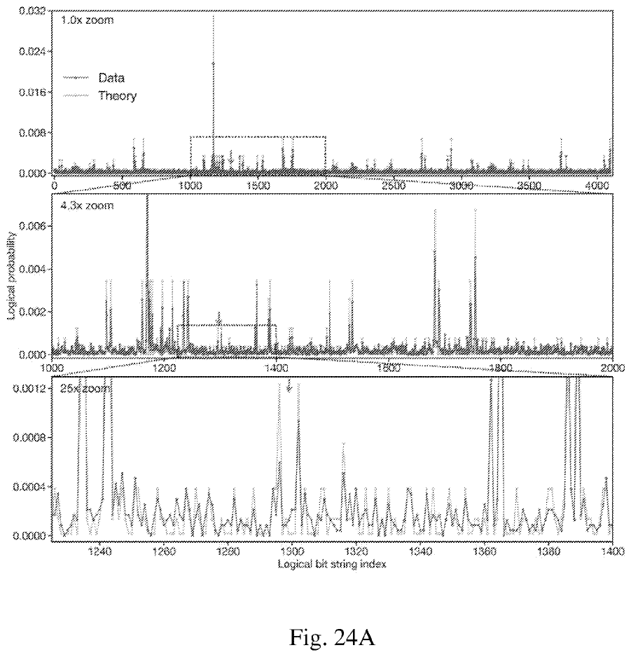

FIG. 23 illustrates [[8,3,2]] and hypercube encoding according to embodiments of the present disclosure. FIG. 23A depicts a state preparation circuit for the [[8,3,2]] code, in which two 4-qubit GHZ states are simultaneously prepared and subsequently entangled. This initializes an [[8,3,2]] code with logical states |−_{L1} [symbol] , +_{L2}, −_{L3}. FIG. 23B depicts a 4D hypercube circuit performed on 48 logical qubits (128 physical qubits). The circuit is drawn on the block-level, where each block consists of 3 logical qubits and 8 physical qubits. The first in-block gate layer is performed with a global T^{†}. The local gate patterns, and the corresponding logical gates they execute within each code block, are illustrated in the inset. FIG. 23C is a diagram illustrating the code block movements and use of the processor's zoned architecture throughout the circuit.

Initially, eight [[8,3,2]] code blocks are prepared in the entangling zone and atoms for later state preparation of eight additional code blocks are loaded in the storage zone. The code blocks in the entangling zone are then picked up and interlaced with adjacent blocks to perform three transversal CNOT layers. The two groups of eight code blocks are then swapped and the same procedure is repeated with the second group of code blocks. The first group of code blocks are then moved back into the entangling zone and interleaved with the atoms of the first group to perform a final parallel transversal CNOT. The layers of CNOT gates connect the code blocks such that a 4D hypercube on 16 blocks of [[8,3,2]] codes is constructed.

The [symbol] 8,3,2 [symbol] code blocks are initialized in the |−_{L}, +_{L}, −_{L} [symbol] state with the circuit in FIG. 23, which can be understood as preparing two 4-qubit GHZ states (corresponding to [symbol] 4,2,2 [symbol] codes), i.e.

$$G H {Z}_{Z}^{1 , 3 , 5 , 7} ⊗ G H {Z}_{X}^{2 , 4 , 6 , 8} ,$$

and subsequently entangling them as illustrated in FIG. 23A (as well as applying Z gates). In this circuit implementation, for system sizes of 3 to 24 logical qubits both for sampling and two-copy measurements, 8 blocks are encoded over 64 physical qubits. For the 48 logical qubit circuit (128 physical qubits total) 8 blocks are encoded and entangled, then dropped into storage. Then, 64 new physical qubits are picked up from storage, encoded into 8 blocks in the entangling zone, and entangled. The original 8 blocks are brought from storage and entangled with the second group of 8 blocks in the entangling zone (FIG. 23).

The transversal gate set of the [[8,3,2]] code is enabled as follows. The transversal CNOT between blocks immediately follows from the fact that the [[8,3,2]] code is a CSS code. In-block CZ gates between two logical qubits Lᵢ and Lⱼ (CZ_{Li,Lj}) can be realized by S, S^{†} gates on the face corresponding to logical qubit Lₖ. For example, consider applying the pattern of S, S^{†} gates to the top face in FIG. 16, i.e.,

$${S}_{1} {S}_{3}^{†} {S}_{5}^{†} {S}_{7} , which transforms {X}_{L 1} = {X}_{1} {X}_{2} {X}_{3} {X}_{4} to {X}_{L 1}^{′} = {Y}_{1} {X}_{2} {Y}_{3} {X}_{4} ,$$

which is equal to

$${X}_{L 1}^{′} = {X}_{L 1} {Z}_{L 2} ,$$

and the same applies to give

$${X}_{L 2}^{′} = {X}_{L 2} {Z}_{L 1} ; i . e . ,$$

a CZ is realized between logical qubits 1 and 2. This procedure can also be used to understand why the pattern of T, T^{†} realizes a CCZ between the three encoded qubits. CCZ gates should map X_{L3} to X_{L3}⊗CZ_{L1,L2}. By applying the pattern of T, T^{†} in FIG. 16A, each X face maps to itself multiplied by a pattern of S, S^{†}, e.g. X_{L3}=X₁X₃X₅X₇ maps to

$${X}_{L 3}^{′} = {X}_{L 3} {S}_{1} {S}_{3}^{†} {S}_{5}^{†} {S}_{7} , or then {X}_{L 3}^{′} = {X}_{L 3} ⊗ C {Z}_{L 2 , L 3} .$$

This happens for all three X_{L} faces, thereby realizing a CCZ gate.

Physically permuting atoms to swap qubits 4↔8 and 3↔7 takes

$${X}_{L 1} = {X}_{1} {X}_{2} {X}_{3} {X}_{4} to {X}_{L 1}^{′} = {X}_{1} {X}_{2} {X}_{7} {X}_{8} or instead {X}_{L 1}^{′} = {X}_{L 1} {X}_{L 2}$$

(also by multiplying the global X stabilizer), and similarly it can be seen by tracking the qubit permutations that

$${Z}_{L 2}^{′} = {Z}_{L 2} {Z}_{L 1} , i . e .$$

realizing a CNOT. Finally, although these 3D codes do not have a transversal H, as they are CSS codes, they can be initialized and measured in either the X or Z basis, effectively allowing H gates at the beginning or end of the circuit.

In-block logical entangling gates are applied block-by-block, and any in-block gate combination can be realized. For conceptual simplicity, only two particular local Raman patterns are applied in layers. The first is the gate combination CCZ_{L1,L2,L3}·CZ_{L1,L2}·CZ_{L1,L3}·CZ_{L2,L3}·Z_{L1}·Z_{L2}·Z_{L3}, given by applying T^{†} on the entire physical qubit block. The second gate combination is CCZ_{L1,L2,L3}·CZ_{L2,L3}·CZ_{L1,L3}·Z_{L3}, given by applying T on the top row and T^{†} on the bottom row. In the circuits, layers of in-block transversal entangling gates and out-block transversal CNOTs are alternated, entangling logical blocks on up to 4D hypercubes (see FIG. 23). The control and target qubits are kept the same throughout the circuit for conceptual simplicity, allowing the local physical H gates on the target qubits to be compiled with the in-block gate layers, but the control-target direction can also be chosen arbitrarily. In-block logical entangling gates are applied such that they do not trivially commute through and cancel with earlier entangling gate applications. For the Clifford states realized in the other parts of this example, stabilizers take on values of either +1 or −1

$$( due to , e . g . , use of physical \frac{π}{2} rotations instead of H ) ,$$

which is then re-defined in software. Since for these [[8,3,2]] circuits non-Cliffords are implemented on the physical level, it is important to ensure all stabilizers are initialized and maintained as +1; e.g., if a Z stabilizer is −1, then the logical CCZ implementation sends the X stabilizer expectation value to 0. This can be understood as a physical X on a single site transforming to a superposition

$$\frac{( X + Y )}{\sqrt{2}}$$

by physical T's, going into an equal superposition of the X stabilizer being +1 and −1.

### Physical Qubit Circuit Implementations

To compare logical qubit algorithms provided herein with analogous circuits on physical qubits, a concrete implementation of the sampling/scrambling circuits on physical qubits is provided using the same physical gate set, Clifford+T, as used in the logical circuit, which are then realized experimentally. Each [[8,3,2]] block is replaced with a 3-physical-qubit block, decomposing the “in-block” CCZ gates into 6 CNOTs and 7 {T, T^{†}} gates, and “transversal” CNOTs are implemented directly between the 3-qubit blocks. The CZ can be compiled into the CCZ implementation, but this has minor effect on the analysis and estimates. These physical circuits are complex: 48 qubits with 48 CCZs and 228 two-qubit gates (as realized with logical qubits) decomposes into an effective 516 two-qubit gates (384 if the CZ gates are compiled into the CCZs). In implementing these circuits in practice, the build-up of coherent errors resulted in a vanishing XEB for the physical circuits. These experiments made it clear the logical circuit equivalent was greatly outperforming the physical circuit, thereby providing direct evidence that the logical algorithm outperforms the physical algorithm for this specific sampling circuit.

More quantitatively, with a concrete physical implementation, an upper-bound is calculated by assuming optimistic performance. Best-measured fidelities are assumed: SPAM of 99.4%, local single-qubit gate fidelity of 99.91% (FIG. 19), two-qubit gate fidelity of 99.55%, and T₂=2 s. The total number of entangling gate pulses is counted for the CZ gates, the total number of compiled local single-qubit gates, and the estimated circuit duration, and this is used to calculate the estimate presented in FIG. 16F. This analysis is confirmed for small-scale circuit implementations. For a short 3-qubit circuit, the XEB is benchmarked for the physical circuit as ≈0.87, below the estimated 3-qubit upper-bound of 0.92. In FIG. 16F estimates of physical qubit fidelity and not XEB are plotted, but XEB and fidelity are expected to be closely related.

Empirically it appears that the logical circuit is significantly more tolerant to coherent errors. Specifically, it appears that the logical circuit realizes inherently digital operation, where the small coherent errors do not significantly shift/distort the bitstring distribution, but just reduce the overall fidelity (see e.g., the agreement in FIG. 24A). This is in contrast to the physical implementation, where coherent errors are seen to dramatically alter the shape of the bitstring distribution, e.g., changing relative amplitudes. The [[8,3,2]] circuits are optimized only by optimizing the stabilizer expectation values and not by optimizing the XEB or two-copy result directly. When running complex circuits, the stabilizers serve as useful intermediate fidelity benchmarks, both for optimizing circuit design and ensuring proper execution, especially in regimes where output distributions or other observables cannot be calculated. These complex circuits appear to perform significantly better with logical qubits than physical qubits.

FIG. 24 illustrates additional [[8,3,2]] circuit sampling data. FIG. 24A depicts overlap of error-detected 12-qubit sampling data with the theoretical distribution (same data as the fully error-detected case in FIG. 16B). Progressive zoom-in's show the agreement between theory and experiment, down to the level of 10⁻⁴ probability per bit string. This error-detected data set is composed of 23,545 shots (raw data set is 138,626 shots). Simultaneously measurement is performed on two groups of 12 logical qubits; plotted here is only one of the two 12-logical groups with an XEB of 0.69(1), while in plots FIGS. 16E,F and FIG. 24B the two logical groups are averaged, which gives a measured XEB of 0.616(7).

FIG. 24B depicts the same data as FIG. 16F but with purity, as measured by two-copy measurement, additionally plotted. The measured XEB is slightly below the measured purity, providing evidence that XEB is a faithful fidelity proxy. Under error detection, the logical XEB for these IQP circuits should be a good fidelity proxy. Interestingly, the behavior can be different for the raw, uncorrected data, as the circuit applied on the physical level is not IQP. Without applying error detection, not all errors are logical errors and therefore the circuit differs from IQP behavior and can lend itself to a different scaling. For systems of 3, 6, and 12 logical qubits, multiple systems are measured in parallel and their results are averaged together. Although the preparation of [[8,3,2]] code states makes these states on a cube, it does not have CNOTs between two pairs of qubits in the first step and, therefore, does not have the full gate connectivity of a cube. Instead, one can interpret these CNOTs as having been included but then compiled away as they commute with the state. This is ignored in plotting the physical qubit connectivity, which is derived from entangling 3D cubes on a 4D hypercube connectivity, realizing a 7D hypercube. FIG. 24C depicts 48-qubit XEB sliding-scale error-detection data. The point with full postselection on all stabilizers being perfect returned only 8 samples, so this point is omitted from the plot in FIG. 16F for clarity.

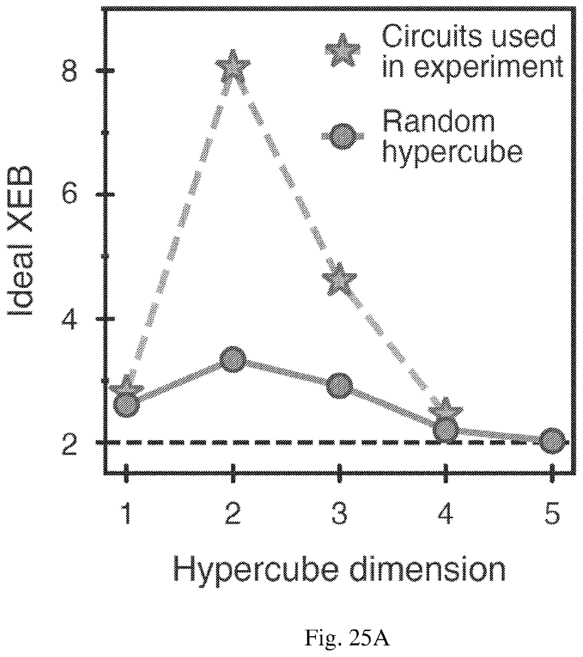

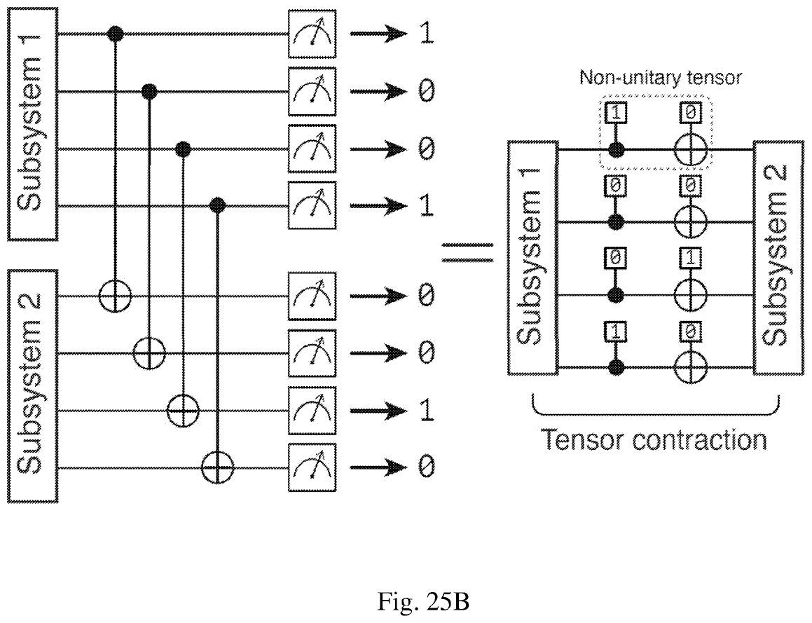

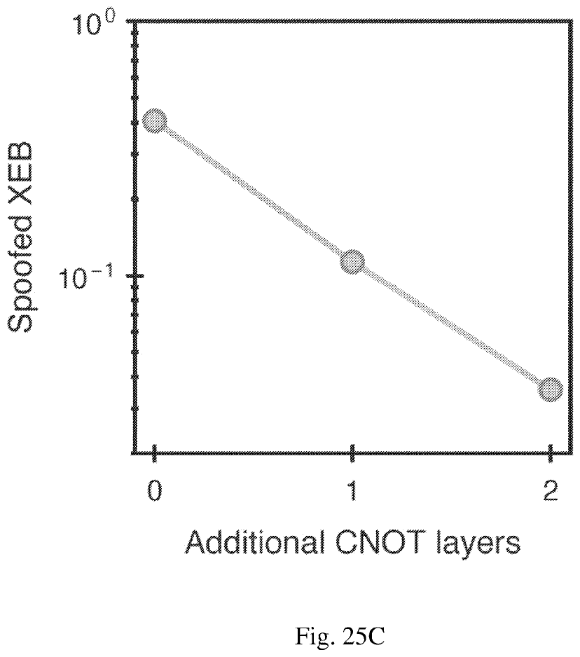

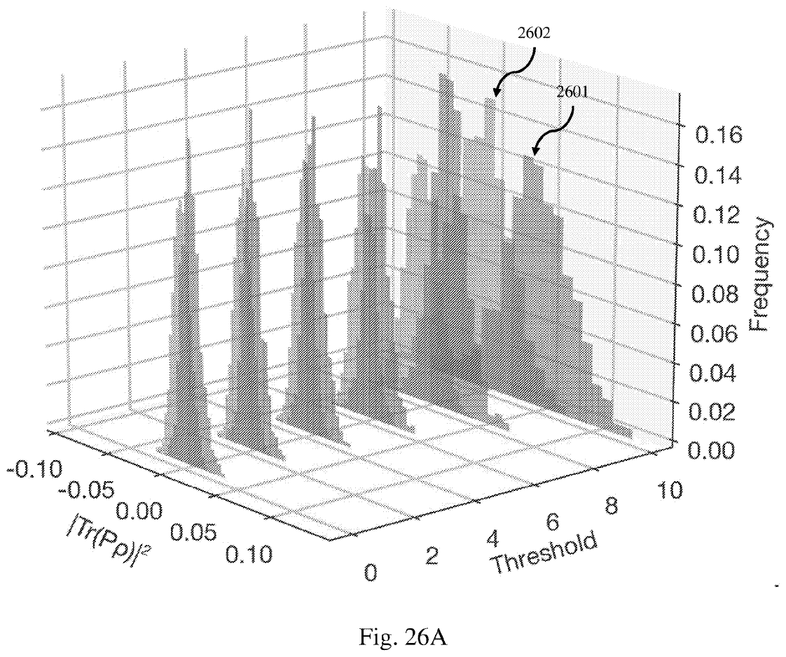

FIG. 25 illustrates theoretical exploration of hypercube IQP circuits. FIG. 25A depicts the anti-concentration property of the circuits. The circuit is said to be anti-concentrated if its output distribution is spread almost uniformly amongst all outcomes, without the probability being concentrated on a subset of bitstrings. This property is crucial for many proofs of classical hardness and, thus, it is desired for the sampling circuits to anti-concentrate. The plot shows that the output distribution of random hypercube circuits (randomized in-block operations and randomized control/target in out-block CNOT layers) anti-concentrates as the dimension of the hypercube is increased and the XEB (which captures the output collision probability) converges to the uniform-IQP value of 2 (here using Clifford circuits—circuits comprised of random CZ and Z only). This suggests that sampling from the ideal output distribution can be classically hard. In general, the hypercube IQP circuit ensemble converges to the uniform IQP ensemble in total variation distance as the depth and hypercube dimension are increased. The specific circuit instances implemented in experiment also anticoncentrate quickly with increasing hypercube dimension.

FIG. 25B depicts a single layer of the hypercube circuit that admits an efficient tensor-network contraction scheme, which allows one to evaluate the ideal and experimental XEB values. The final out-block CNOT layer is immediately followed by the measurement, which can be incorporated into a non-unitary tensor that is contracted between the two halves of the system (controls and targets of the final CNOT layer). This contraction scheme reduces the memory requirements to half the system size, which enables bitstring amplitude evaluation for the 48-qubit experiment. This simulation approach can be made significantly more expensive by applying additional out-block operations within the two subsystems, forcing the blocking of the intra-partition tensors, which increases the memory and runtime requirements (FIG. 16D).

FIG. 25C explores if the circuit families can be “spoofed” with a cheaper, approximate simulation that achieves moderately high XEB scores, studied here for a 24-qubit system with full state-vector simulation. The spoofing algorithm works by independently sampling from the two halves of the system (two groups of 12 qubits), effectively removing the final layer of CNOTs. This further reduces the simulation complexity, as each of the halves can, in principle, be independently simulated with the efficient approach from FIG. 25B. The plot shows that the spoofed XEB for the 24-qubit non-Clifford circuit can be exponentially reduced by extending the circuit with additional gate layers (similarly to the approach used to decrease the performance of the efficient hypercube contraction), for a particular extension of the circuit.

FIG. 26 illustrates additional Bell basis measurement results. FIG. 26A depicts a histogram of |tr(Pρ)|² for all 4⁶ Pauli strings P in the 6 logical qubit circuit, as a function of stabilizer postselection threshold (the number of correct stabilizers across the 6×2 logical qubits). Region 2601 (2602) indicates Pauli strings that are expected to have |tr(Pρ)|²=0.0625 (0). The separation between the histograms improves as more postselection is applied. FIG. 26B depicts signal-to-noise (purity divided by statistical uncertainty of purity) as a function of sliding-scale error detection (converted into accepted fraction), for the 12 logical qubit two-copy measurements, where subsystem size 1 indicates a single logical qubit in one copy, and subsystem size 12 indicates all logical qubits. For subsystem size 1, the signal-to-noise ratio gets worse as data is discarded, since the signal does not change (maximally mixed) but the number of repetitions decreases. In contrast, for the global purity, the signal-to-noise increases as near-unity purities are faster to measure. FIG. 26C,D depict entanglement entropy when analyzing the circuit as a physical Bell basis measurement as opposed to a logical Bell basis measurement. For logical entanglement entropy calculations, an average is taken over all possible subsystems of that given subsystem size, which behaves very similarly to, e.g., contiguous subsystems due to the high-dimensional hypercube connectivity. In the physical qubit entanglement entropy calculations, a random choice is taken from the possible subsystems. FIG. 26C depicts 6 logical (16 physical) qubits per copy; FIG. 26D depicts 12 logical (32 physical) qubits per copy. The finite sampling imposes a noise floor for very high entanglement entropy values. FIG. 26E depicts entanglement entropy measurements, as in FIG. 17B, but as a function of logical subsystem size. FIG. 26F depicts logical circuits used for benchmarking magic. For 1 CCZ, U₁ is included and U₀ is omitted; for 2 CCZ, U₀ is included and U₁ is omitted; for the 3 CCZ, both U₀ and U₁ are included.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A quantum processor, comprising:
a first array of optical traps disposed in an active zone;
a second array of optical traps disposed in a readout zone;
a first laser configured to illuminate the active zone and to drive a transition to a Rydberg state;
a second laser configured to illuminate the active zone and to drive a transition between hyperfine states;
a third laser configured to illuminate the readout zone;
a fourth laser configured to adiabatically move neutral atoms between the optical traps of the active zone and the readout zone; and
a camera configured to capture an image of the readout zone, wherein the quantum processor is configured to:
provide a first plurality of neutral atoms in the active zone, each in a respective optical trap of the first array;
encode a first logical qubit into the first plurality of neutral atoms by the first and second lasers;
illuminate the first plurality of neutral atoms while in the active zone by at least the first or second laser, thereby applying a gate to the first logical qubit;
adiabatically move the first plurality of neutral atoms from the active zone to the readout zone, each to a respective optical trap of the second array;
illuminate the first plurality of neutral atoms while in the readout zone by the third laser; and
capture an image of the first plurality of neutral atoms while in the readout zone, thereby determining the state of the first logical qubit.

2. The quantum processor of claim 1, further comprising
a third array of optical traps disposed in a storage zone, wherein
the fourth laser is further configured to adiabatically move neutral atoms between the optical traps of the active zone and the storage zone, and wherein
the quantum processor is further configured to:
adiabatically move the first plurality of neutral atoms from the active zone to the storage zone by the fourth laser after said encoding, each to a respective optical trap of the third array; and
adiabatically move the first plurality of neutral atoms from the storage zone to the active zone by the fourth laser prior to applying the gate, each to a respective optical trap of the first array.

3. The quantum processor of claim 1 or 2, further configured to:
provide a second plurality of neutral atoms in the active zone;
encode a second logical qubit into the second plurality of neutral atoms by the first and second lasers; and
prior to applying the gate, place the first and second pluralities of neutral atoms in the active zone such that each neutral atom of the first plurality of neutral atoms is within a blockade radius of exactly one corresponding neutral atom of the second plurality of neutral atoms, wherein
the illumination of the first plurality of neutral atoms while in the active zone additionally illuminates the second plurality of neutral atoms, thereby applying the gate to the first and second logical qubits.

4. The quantum processor of claim 3, wherein the gate is a transversal CNOT gate.

5. The quantum processor of claim 4, wherein applying the gate comprises applying a single pulse of the first laser.

6. The quantum processor of any one of claims 1 to 5, wherein adiabatically moving the first plurality of neutral atoms from the active zone to the storage zone, from the storage zone to the active zone, and from the active zone to the readout zone each comprises applying a Raman pulse during said moving.

7. The quantum processor of claim 6, wherein the Raman pulse is applied at a midpoint of said moving.

8. The quantum processor of claim 6 or 7, wherein adiabatically moving the first plurality of neutral atoms from the active zone to the storage zone, from the storage zone to the active zone, and from the active zone to the readout zone each have a constant jerk.

9. The quantum processor of any one of claims 1 to 8, wherein the first, second, and/or third arrays of optical traps are two-dimensional arrays.

10. The quantum processor of any one of claims 1 to 9, further comprising at least one acousto-optic deflector (AOD), wherein the fourth laser is configured to direct a beam of light to the at least one AOD, and wherein adiabatically moving neutral atoms comprises varying a drive frequency of the at least one AOD.

11. The quantum processor of any one of claims 1 to 10, wherein the first, second, and/or third arrays of optical traps is generated by directing a beam of light to a spatial light modulator (SLM).

12. The quantum processor of any one of claims 1 to 11, wherein the first plurality of neutral atoms are moved simultaneously.

13. The quantum processor or any one of claims 2 to 12, wherein the third array has a higher density than the first array.

14. The quantum processor of any one of claims 1 to 13, wherein encoding the first logical qubit comprises applying a CSS code.

15. The quantum processor of claim 14, wherein the CSS code is selected from: a surface code, a color code, a Steane code, and a hypergraph product LDPC code.

16. The quantum processor of any one of claim 1 to Error! Reference source not found., further comprising an FPGA configured to receive the image of the first plurality of neutral atoms and compute the state of the first logical qubit.

17. A method of performing a quantum computation, the method comprising:
providing a first array of optical traps disposed in an active zone of a quantum processor;
providing a second array of optical traps disposed in a readout zone of the quantum processor;
providing a first plurality of neutral atoms in the active zone, each in a respective optical trap of the first array;
encoding a first logical qubit into the first plurality of neutral atoms by first and second lasers, the first laser configured to illuminate the active zone and to drive a transition to a Rydberg state and the second laser configured to illuminate the active zone and to drive a transition between hyperfine states;
illuminating the first plurality of neutral atoms while in the active zone by at least the first or second laser, thereby applying a gate to the first logical qubit;
adiabatically moving the first plurality of neutral atoms from the active zone to the readout zone, each to a respective optical trap of the second array;
illuminating the first plurality of neutral atoms while in the readout zone by a third laser; and
capturing an image of the first plurality of neutral atoms while in the readout zone, thereby determining the state of the first logical qubit.

18. The method of claim 17, further comprising:
adiabatically moving the first plurality of neutral atoms from the active zone to a storage zone of the quantum processor by a fourth laser after said encoding, each to a respective optical trap of a third array; and
adiabatically moving the first plurality of neutral atoms from the storage zone to the active zone by the fourth laser prior to applying the gate, each to a respective optical trap of the first array.

19. The method of claim 17, further comprising:
providing a second plurality of neutral atoms in the active zone;
encoding a second logical qubit into the second plurality of neutral atoms by the first and second lasers; and
prior to applying the gate, placing the first and second pluralities of neutral atoms in the active zone such that each neutral atom of the first plurality of neutral atoms is within a blockade radius of exactly one corresponding neutral atom of the second plurality of neutral atoms, wherein
the illumination of the first plurality of neutral atoms while in the active zone additionally illuminates the second plurality of neutral atoms, thereby applying the gate to the first and second logical qubits.

20. The method of claim 19, wherein the gate is a transversal CNOT gate.

21. The method of claim 20, wherein applying the gate comprises applying a single pulse of the first laser.

22. The method of any one of claims 19 to 21, wherein adiabatically moving the first plurality of neutral atoms from the active zone to the storage zone, from the storage zone to the active zone, and from the active zone to the readout zone each comprises applying a Raman pulse during said moving.

23. The method of claim 22, wherein the Raman pulse is applied at a midpoint of said moving.

24. The method of claim 22 or 23, wherein adiabatically moving the first plurality of neutral atoms from the active zone to the storage zone, from the storage zone to the active zone, and from the active zone to the readout zone each have a constant jerk.

25. The method of any one of claims 17 to 24, wherein the first, second, and/or third arrays of optical traps are two-dimensional arrays.

26. The method of any one of claims 17 to 25, further comprising directing a beam of light from the fourth laser to at least one acousto-optic deflector (AOD), and wherein adiabatically moving neutral atoms comprises varying a drive frequency of the at least one AOD.

27. The method of any one of claims 17 to 26, wherein the first, second, and/or third arrays of optical traps is generated by directing a beam of light to a spatial light modulator (SLM).

28. The method of any one of claims 17 to 27, wherein the first plurality of neutral atoms are moved simultaneously.

29. The method or any one of claims 18 to 28, wherein the third array has a higher density than the first array.

30. The method of any one of claims 17 to 29, wherein encoding the first logical qubit comprises applying a CSS code.

31. The method of claim 30, wherein the CSS code is selected from: a surface code, a color code, a Steane code, and a hypergraph product LDPC code.
